(19) United States
(12) Patent Application Publication
(10) Pub. No.: US 2008/0250379 A1
(43) Pub. Date: Oct. 9, 2008

(54) LOGIC CIRCUIT SYNTHESIS DEVICE

(76) Inventors: Shoji TAKAOKA, Osaka (JP); Atsushi Yamamoto, Hyougo (JP); Tomohiro Tsuda, Osaka (JP); Takashi Hiramatsu, Osaka (JP)

Correspondence Address: MCDERMOTT WILL & EMERY LLP, 600 13TH STREET, NW, WASHINGTON, DC, 20005-3096, US

(21) Appl. No.: 11/947,417

(22) Filed: Nov. 29, 2007

(30) Foreign Application Priority Data
Nov. 30, 2006 (JP) 2006-324897

(51) Int. Cl. G06F 17/50

(52) U.S. Cl. 716/18

(57) ABSTRACT

In a logic circuit synthesis device, a library of cell preliminarily stores a condition concerning a property that should be satisfied by the net having the property. The logic circuit synthesis device selects, from a list of nets, a net that has a predetermined property. the logic circuit synthesis device performs logic synthesis in accordance with the condition stored in the library, for the selected net.

This application is based on an application No. 2006-324897 filed in Japan, the content of which is hereby incorporated by reference.

### BACKGROUND OF THE INVENTION

(1) Field of the Invention

The present invention relates to a technology for synthesizing logic circuit, especially to a technology for optimizing logic circuits.

(2) Description of the Related Art

In recent years, logic circuit synthesis devices for automatically generating a logic circuit are widely used to design a large-scale, high-performance LSI (Large Scale Integration) in a short time period.

The logic circuit synthesis devices develop logic at a gate level based on the RTL (Register Transfer Level) description or the like described in a hardware description language. After the logic development, the logic circuit synthesis devices optimize logic. After the logic optimization, they perform a mapping in which logic gates or flip flops are replaced with macrocells that are prepared for libraries of a desired semiconductor manufacturing technology, for example, libraries of the Liberty (.lib) format.

As a result of such processes, the logic circuit synthesis devices output a net list that includes various information on the nets that indicate connection relationships between cells, and represents a logic circuit.

A conventionally used technology causes a logic circuit synthesis device to perform a logic synthesis under a restriction where connection targets of cells are restricted such that the cells are connected to merely predetermined cells or nets so that the logic circuit synthesis device can synthesize a logic circuit optimized in performance (see Patent Document 1 identified below).

More specifically, the logic circuit synthesis device stores, by making a distinction there between, two types of logic elements: a logic element that causes a through current therein when it receives a high-impedance signal; and a logic element that does not cause a through current therein when it receives a high-impedance signal. One example of such a logic element that causes a through current therein when it receives a high-impedance signal is an inverter logic element.

When a through current is caused in a circuit, power consumption of the circuit increases. For this reason, the logic circuit synthesis device synthesizes a logic circuit by, for example, replacing a target logic circuit with another logic circuit that has a different structure and an equivalent logical expression, so that a bus, through which a high-impedance signal passes, is not connected with an input pin of an inverter logic element. Such an arrangement makes it possible to synthesize a logic circuit that does not cause a through current therein.

[Patent Document 1] Japanese Patent Application Publication No. 10-84270

Meanwhile, as the demand for large-scale, high-performance LSIs has increased, the lines connecting cells have become smaller in width to increase the density of the circuit. When the lines become smaller in width, adverse effects that the lines receive from other lines or cells become greater. In the actuality, adverse effects caused by errors due to the net structure involving the length of the wired lines, the arrangement position of the cells connected to the nets have increased to such an extent that they cannot be neglected. Such errors include, for example, a signal electro migration error that occurs when long lines wired, and a crosstalk delay that a line receives from another line that is wired in parallel with the line.

To cope with the adverse effects, circuit designers of conventional technologies analyze a synthesized logic circuit by a simulation or the like to identify a net has an error such as a delay. The circuit designers then re-synthesize a logic circuit after adjusting the net structure to solve the error. The circuit designers repeat these processes. This has increased an amount of work for a designer to remove such errors, and has caused a problem that designing a circuit takes a long time.

### SUMMARY OF THE INVENTION

The object of the present invention is therefore to provide a logic circuit synthesis device for synthesizing a logic circuit by automatically removing adverse effects induced by the net structure, thereby reducing the time period taken to design a logic circuit and increasing the efficiency of designing an LSI.

The above-described object is fulfilled by a logic circuit synthesis device comprising: a storage unit storing structure condition information in correspondence with a predetermined property of a net, the structure condition information specifying a condition which should be satisfied by a net structure of the net having the property; an obtaining unit operable to obtain original net structure information that indicates structures of a plurality of nets; a selecting unit operable to select a net having the predetermined property, among the plurality of nets whose structures are indicated by the obtained original net structure information; and a generating unit operable to generate, for the selected net, new net structure information that satisfies the condition specified by the structure condition information stored in the storage unit.

The logic circuit synthesis device having the above-stated structure stores the structure condition information that indicates a condition concerning a property that should be satisfied by the net having the property. Here, the net having the property is, for example, a net in which a delay or an error has occurred. Also, the logic circuit synthesis device generates the new net structure information that satisfies the condition specified by the structure condition information, with respect to one or more nets having a certain property among the nets indicated by the original net structure information.

With the stated structure, the logic circuit synthesis device can optimize the net structure in correspondence with the net property, and can generate, with respect to the net having the property, the new net structure information that satisfies the condition corresponding to the property, by adjusting the net structure, without requiring a work by the circuit designer.

One example of such errors induced by the net structure is an error due to the net wiring length. For example, as described above, when the net wiring length is too large, a signal electro migration error or the like occurs.

Accordingly, in the above-stated logic circuit synthesis device, the structure condition information stored in the storage unit may indicate a condition concerning a wiring length of the net having the property, and the new net structure information generated by the generating unit ma satisfy the condition concerning the wiring length.

With the stated structure, it is possible to adjust the net wiring length appropriately.

More specific net properties include, for example, a net that passes over a block boundary. When a net at a block boundary has a long wiring, a signal electro migration error or a slew error occurs.

Accordingly, in the above-stated logic circuit synthesis device, the net having the property may be a boundary net that extends over a boundary between blocks, the structure condition information stored in the storage unit indicates a restriction on a maximum wiring length of the boundary net, the net selected by the selecting unit is the boundary net, and the new net structure information generated by the generating unit satisfies the restriction on the maximum wiring length of the selected boundary net.

With the stated structure, it is possible to prevent an occurrence of a signal electro migration error or a slew error.

Also, an extremely small net wiring length might cause a problem. For example, when a congestion of nets exceeds a predetermined level, it is difficult to arrange cells. In such cases, it is possible to prevent a wiring congestion by keeping such types of cells, that are apt to be congested due to a large number of pins, away from the congested net.

Accordingly, in the above-stated logic circuit synthesis device, the net having the property may be a congested net whose wiring density is higher than a predetermined value, the structure condition information stored in the storage unit indicates a restriction on a maximum wiring length of the congested net, the net selected by the selecting unit is the congested net, and the new net structure information generated by the generating unit satisfies the restriction on the maximum wiring length of the selected congested net.

With the stated structure, it is possible to prevent the wiring congestion.

Also, when there is a high toggle net being a net having at least a predetermined toggle rate, a local heating is easy to occur since the voltage changes frequently.

Accordingly, in the above-stated logic circuit synthesis device, the net having the property may be a high toggle net being a net having at least a predetermined toggle rate, the structure condition information stored in the storage unit indicates a restriction on a minimum wiring length of the high toggle net, the net selected by the selecting unit is the high toggle net, and the new net structure information generated by the generating unit satisfies the restriction on the minimum wiring length of the selected high toggle net.

With the stated structure, for example, a cell having a large power consumption can be kept away from a net so that the wiring length is the minimum wiring length or more, thereby preventing a local heating from occurring.

Further, the net wiring direction might cause a problem, as well as the net wiring length as described above.

For example, when cells are concentrated in the horizontal direction in a circuit, it is difficult to arrange some types of cells that have a small number of wiring resource in the vertical direction.

Accordingly, in the above-stated logic circuit synthesis device, the structure condition information stored in the storage unit may indicate a condition concerning a wiring direction of the net having the property in a circuit, and the new net structure information generated by the generating unit satisfies the condition concerning the wiring direction.

The stated structure makes it possible to appropriately arrange some types of cells having a small number of wiring resource in the horizontal direction or in the vertical direction.

More specifically, in the above-stated logic circuit synthesis device, the net having the property may be a congested net whose wiring density is higher than a predetermined value, the structure condition information stored in the storage unit indicates a restriction on a wiring direction of the congested net, the net selected by the selecting unit is the congested net, and the new net structure information generated by the generating unit satisfies the restriction on the wiring direction of the selected congested net.

With the stated structure, it is possible to appropriately arrange some types of cells to be kept away from a congested net, depending on the wiring resources, and to prevent a congested wiring.

Also, the net wiring length or wiring direction aside, an inappropriate number of cells between certain cells might cause a problem.

For example, a hold error might happen when a signal output from an output pin of a flip flop reaches an input pin of another flip flop earlier than usual.

Accordingly, in the above-stated logic circuit synthesis device, the structure condition information stored in the storage unit may indicate a step number restriction being a restriction on a predetermined number of cells that should be arranged between cells constituting the net having the property, and the new net structure information generated by the generating unit satisfies the step number restriction.

With the stated structure, it is possible to avoid an occurrence of a delay or a synchronization error by restricting the number of cells to be arranged between certain cells.

More specifically, in the above-stated logic circuit synthesis device, the net having the property may be a glitch occurrence net in which a glitch with at least a predetermined height has occurred, the structure condition information stored in the storage unit indicates a step number restriction being a restriction on a predetermined number of cells that should be arranged between cells constituting the glitch occurrence net, the net selected by the selecting unit is the glitch occurrence net, and the new net structure information generated by the generating unit satisfies the step number restriction being the restriction on the predetermined number of cells that should be arranged between cells constituting the selected glitch occurrence net.

With the stated structure, it is possible to solve the glitch error since the glitch error can be solved by inserting buffer into the glitch occurrence net.

Further, in the above-stated logic circuit synthesis device, the net having the property may be an FF direct connection net in which flip flops are directly connected, the structure condition information stored in the storage unit indicates a restriction on a delay time between flip flops in the FF direct connection net, the net selected by the selecting unit is the FF direct connection net, and the new net structure information generated by the generating unit satisfies the restriction on the delay time between flip flops in the selected FF direct connection net, wherein the generating unit controls a number of buffers to be inserted between the flip flops so that the new net structure information satisfies the restriction on the delay time between the flip flops.

In a net in which flip flops are directly connected, the hold error may happen if a signal reaches earlier than usual. With the above-stated structure, however, it is possible to solve the hold error by inserting buffers.

Also, what is called pulse reject may happen when a pulse that passes through a net has a high frequency. In the pulse reject, a pulse with a high frequency enters a cell with a large delay or the like, and the pulse is erased.

Accordingly, in the above-stated logic circuit synthesis device, the net having the property may be a high frequency net through which a high frequency signal passes, the structure condition information stored in the storage unit is maximum frequency information that indicates a restriction on a maximum frequency of a net to which a predetermined cell can be connected, the net selected by the selecting unit is the high frequency net, and the new net structure information generated by the generating unit satisfies the restriction on the maximum frequency of the selected high frequency net to which the predetermined cell can be connected, wherein the generating unit controls the predetermined cell connected to the high frequency net so that the new net structure information satisfies the restriction on the maximum frequency of the selected high frequency net.

With the stated structure, it is possible to prevent an occurrence of a pulse reject, by restricting cells from connecting to the high frequency net.

Also, there is a case where it is possible to optimize a logic circuit by connecting a certain cell to a net of a certain property. More specifically, when a reflection wave is caused in a bus, it is possible to optimize the logic circuit by connecting a terminating resistor to the bus to match the impedance.

Accordingly, in the above-stated logic circuit synthesis device, the structure condition information stored in the storage unit may indicate a restriction on a number of connections by a predetermined cell to the net having the property, and the new net structure information generated by the generating unit satisfies the restriction on the number of connections by the predetermined cell to the net having the property. More specifically, in the above-stated logic circuit synthesis device, the net having the property may be a bus signal net through which a bus signal passes, the structure condition information stored in the storage unit indicates a restriction on a number of connections by a terminating resistor to the bus signal net, the net selected by the selecting unit is the bus signal net, and the new net structure information generated by the generating unit satisfies the restriction on the number of connections by the terminating resistor to the selected bus signal net.

With the stated structure, it is possible to match the impedance by connecting a terminating resistor to the bus.

Also, there is a case where it is preferable to connect a cell to a net at an appropriate position. For example, an observation target net may be provided to detect a defect, error or the like. To detect such an error or the like, a flip flop is connected to the net. However, an error on the net may not be detected sufficiently depending on the position at which flip flop is connected. For example, when a flip flop is connected to the input side of the net, an error in a vicinity of the center of the net cannot be detected.

Accordingly, in the above-stated logic circuit synthesis device, the structure condition information stored in the storage unit may indicate a restriction on a position at which a predetermined cell connects to the net having the property, and the new net structure information generated by the generating unit satisfies the restriction on the position at which the predetermined cell connects to the net having the property. More specifically, in the above-stated logic circuit synthesis device, the net having the property may be an observation target net which is specified as a target of net observation, the structure condition information stored in the storage unit indicates a restriction on a position at which a flip flop connects to the observation target net, the net selected by the selecting unit is the observation target net, and the new net structure information generated by the generating unit satisfies the restriction on the position at which the flip flop connects to the selected observation target net.

With the stated structure, it is possible to connect the cell to the net at an appropriate position.

Meanwhile, when a cell is connected to a high toggle net, an IR drop may happen depending on the position at which the cell is arranged, due to a relatively large change of the voltage there.

More specifically, a cell receives a power supply via a pair of supply lines: a line that supplies plus voltage to the cell; and a line that supplies minus voltage to the cell. when a plurality of cells receive supply of power via a predetermined pair of plus voltage line and minus voltage line, it is said that the plurality of cells are on the same row.

Here, when a plurality of cells with large power consumption are arranged in a same row, and when the cells are connected to a high toggle net, enough power may not be supplied and an IR drop may happen.

Also, there are strap lines that are lines for connecting one another the supply lines through which the power is supplied to the rows. The strap lines are wired to pass over the rows. An IR drop may also happen when the power is supplied to a cell having a large power consumption via a certain strap line in a concentrated manner.

Accordingly, in the above-stated logic circuit synthesis device, the net having the property is a high toggle net being a net having a predetermined toggle rate, the structure condition information stored in the storage unit may indicate a restriction on an arrangement of a first cell and a second cell, the first cell being connected to the high toggle net, the second cell being different from the first cell, the net selected by the selecting unit is the high toggle net, and the new net structure information generated by the generating unit satisfies the restriction on the arrangement of the first cell and the second cell with respect to the selected high toggle net. More specifically, in the above-stated logic circuit synthesis device, the structure condition information stored in the storage unit may indicate a restriction that the first cell and the second cell should be arranged with a predetermined number of rows there between, and the new net structure information generated by the generating unit satisfies the restriction that the first cell and the second cell should be arranged with a predetermined number of rows there between. Also, in the above-stated logic circuit synthesis device, the structure condition information stored in the storage unit may indicate a restriction that the first cell and the second cell should be arranged with a predetermined number of strap lines there between, and the new net structure information generated by the generating unit satisfies the restriction that the first cell and the second cell should be arranged with the predetermined number of strap lines there between.

The stated structure can prevent the occurrence of the IR drop.

Also, a crosstalk may happen when a line receives an adverse effect from another line that is arranged in parallel with the line, and a delay may occur in a net.

Accordingly, in the above-stated logic circuit synthesis device, the net having the property may be a crosstalk occurrence net in which a crosstalk with a predetermined height has occurred, the structure condition information stored in the storage unit indicates a restriction on a parallel wiring length being a length of a wiring of the crosstalk occurrence net that is arranged in parallel with another wiring, the net selected by the selecting unit is the crosstalk occurrence net, and the new net structure information generated by the generating unit satisfies the restriction on the parallel wiring length being the length of the wiring of the selected crosstalk occurrence net that is arranged in parallel with another wiring.

With the stated structure in which a net is structured by taking into the account the restriction on the parallel wiring length, an occurrence of a crosstalk is prevented.

The above-described of object of the present invention is also achieved by a logic circuit synthesis method for causing a logic circuit synthesis device to perform a logic synthesis, the logic circuit synthesis device including a storage unit storing structure condition information in correspondence with a predetermined property of a net, the structure condition information specifying a condition which should be satisfied by a net structure of the net having the property, the logic circuit synthesis method comprising the steps of: obtaining original net structure information that indicates structures of a plurality of nets; selecting a net having the predetermined property, among the plurality of nets whose structures are indicated by the obtained original net structure information; and generating, for the selected net, new net structure information that satisfies the condition specified by the structure condition information stored in the storage unit.

The above-described of object of the present invention is further achieved by a control program for controlling a process for causing a logic circuit synthesis device to perform a logic synthesis, the logic circuit synthesis device including a storage unit storing structure condition information in correspondence with a predetermined property of a net, the structure condition information specifying a condition which should be satisfied by a net structure of the net having the property, the control program comprising the steps of: obtaining original net structure information that indicates structures of a plurality of nets; selecting a net having the predetermined property, among the plurality of nets whose structures are indicated by the obtained original net structure information; and generating, for the selected net, new net structure information that satisfies the condition specified by the structure condition information stored in the storage unit.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a functional block diagram of the logic circuit synthesis device 1;

FIG. 2 is a flowchart showing the operation of the logic circuit synthesis device 1;

FIG. 3 shows the data structure of a cell contained in the library 107;

FIG. 4 shows the data structure of one net in the net list. The net list indicates nets and instances of the nets;

FIG. 5 is a flowchart showing the details of the process in which the net list generating unit 109 generates the net list satisfying the condition specified by the structure condition information;

FIG. 6 shows a transition of the net structure;

FIG. 7 shows the net list update process;

FIG. 8 shows the data structure of one cell contained in the library 207;

FIG. 9 shows the data structure of one net in the net list of Embodiment 2;

FIG. 10 is a flowchart showing the details of the process of step S205 in Embodiment 2;

FIG. 11 shows a transition of the net structure;

FIG. 12 shows the net list update process;

FIG. 13 shows the data structure of one cell contained in the library 207-1;

FIG. 14 shows the data structure of one net in the net list of Modification to Embodiment 2;

FIG. 15 is a flowchart showing the details of the process of step S205 in Modification to Embodiment 2;

FIG. 16 shows a transition of the net structure;

FIG. 17 shows the net list update process;

FIG. 18 shows the data structure of one cell contained in the library 307;

FIG. 19 shows the data structure of one net in the net list of Embodiment 3;

FIG. 20 is a flowchart showing the details of the process of step S205 in Embodiment 3;

FIG. 21 shows a transition of the net structure;

FIG. 22 shows the net list update process;

FIG. 23 shows the data structure of one cell contained in the library 407;

FIG. 24 shows the data structure of one net in the net list of Embodiment 4;

FIG. 25 is a flowchart showing the details of the process of step S205 in Embodiment 4;

FIG. 26 shows a transition of the net structure;

FIG. 27 shows the net list update process;

FIG. 28 shows the data structure of one cell contained in the library 507;

FIG. 29 shows the data structure of one net in the net list of Embodiment 5;

FIG. 30 is a flowchart showing the details of the process of step S205 in Embodiment 5;

FIG. 31 shows a transition of the net structure;

FIG. 32 shows the net list update process;

FIG. 33 shows the data structure of one cell contained in the library 607;

FIG. 34 shows the data structure of one net in the net list of Embodiment 6;

FIG. 35 is a flowchart showing the details of the process of step S205 in Embodiment 6;

FIG. 36 shows a transition of the net structure;

FIG. 37 shows the net list update process;

FIG. 38 shows the data structure of one cell contained in the library 607-1;

FIG. 39 shows the data structure of one net in the net list of Modification 1 to Embodiment 6;

FIG. 40 is a flowchart showing the details of the process of step S205 in Modification 1 to Embodiment 6;

FIG. 41 shows a transition of the net structure;

FIG. 42 shows the net list update process;

FIG. 43 shows the data structure of one cell contained in the library 607-2;

FIG. 44 shows the data structure of one net in the net list of Modification 2 to Embodiment 6;

FIG. 45 is a flowchart showing the details of the process of step S205 in Modification 2 to Embodiment 6;

FIG. 46 shows a transition of the net structure;

FIG. 47 shows the net list update process;

FIG. 48 shows the data structure of one cell contained in the library 707;

FIG. 49 shows the data structure of one net in the net list of Embodiment 7;

FIG. 50 is a flowchart showing the details of the process of step S205 in Embodiment 7;

FIG. 51 shows a transition of the net structure;

FIG. 52 shows the net list update process;

FIG. 53 shows the data structure of one cell contained in the library 807;

FIG. 54 shows the data structure of one net in the net list of Embodiment 8;

FIG. 55 is a flowchart showing the details of the process of step S205 in Embodiment 8;

FIG. 56 shows a transition of the net structure;

FIG. 57 shows the net list update process;

FIG. 58 shows the data structure of one cell contained in the library 907;

FIG. 59 shows the data structure of one net in the net list of Embodiment 9;

FIG. 60 is a flowchart showing the details of the process of step S205 in Embodiment 9;

FIG. 61 shows a transition of the net structure;

FIG. 62 shows the net list update process;

FIG. 63 shows the data structure of one cell contained in the library 1007;

FIG. 64 shows the data structure of one net in the net list of Embodiment 10;

FIG. 65 is a flowchart showing the details of the process of step S205 in Embodiment 10;

FIG. 66 shows a transition of the net structure; and

FIG. 67 shows the net list update process.

### DESCRIPTION OF THE PREFERRED EMBODIMENT

In the present specification, ten embodiments are described.

First, a common part of the ten embodiments will be described.

### Common Part of Embodiments

1.1 Outline

A part of a logic circuit synthesis device 1 that is common to the embodiments of the present invention will be described with reference to the attached drawings.

1.1.1 Outline of Common Part of Embodiments

An outline of the common part of the embodiments is as follows.

The logic circuit synthesis device 1 stores a library that is referred to when a logic gate or flip flop is replaced with a cell that is a basic circuit depending on a predetermined semiconductor technology. The library stores information regarding the cell structure, such as input and output pins of a plurality of cells.

What shows relationship among cells is called a net. This library prestores information regarding restriction that is made onto the net when the cell connects to the net having a predetermined property, namely, structure condition information that specifies a condition which should be satisfied by the net structure. The structure condition information corresponds to each cell.

It should be noted here that the “net having a predetermined property” is, for example, a net at a boundary between blocks being physical units of division in the circuit, or a net in which an error is occurring.

Also, the condition specified by the structure condition information corresponds to the net property. For example, when a net at a block boundary is a long wire, an SignalEM (Signal Electro Migration) error, a Slew error or the like occurs. Therefore, a restriction is made onto the length of the wire so that the wire length of the net at the block boundary is not more than a predetermined length, and the restriction is set as the condition that the net structure should satisfy.

1.1.2 Outline of Operation Common to Embodiments

The following describes the operation common to the embodiments.

The logic circuit synthesis device 1 selects a net having a predetermined property from among the nets shown in a net list that represents a logic circuit by specifying the positions of arranged cells and nets. The logic circuit synthesis device 1 then determines the positions of the cells and paths connecting the cells so that the selected net satisfies the condition specified by the structure condition information in the library.

The logic circuit synthesis device 1 performs the optimization of the logic circuit in the manner described up to now. The logic circuit synthesis device 1 outputs the net list after the optimization.

1.1.3 Outline of Differences among Embodiments

Next, the differences among the embodiments will be outlined.

More specifically, the properties of the nets selected in the embodiments differ from each other. For example, in Embodiment 1, the predetermined property of the net is that the net is at the boundary between blocks. Also, in Embodiment 2, a net where the wiring density is higher than a predetermined level is regarded as a net having the predetermined property.

Further, as described earlier, the structure condition information corresponds to the property of the net. For this reason, the conditions specified by the structure condition information stored in the library differ in each embodiment. Also, in each embodiment, the logic circuit is optimized so that the condition specified by the structure condition information is satisfied. Due to this, the method of achieving the optimization, such as restricting the wiring length of the net, or inserting a buffer, differs in each embodiment. As a result, the data structure of the net list differs in each embodiment.

Up to now, the common and different part in each embodiment have been described. Next, the structure that is common to each embodiment will be described more specifically.

1.1.4 Structure of Logic Circuit Synthesis Device 1

The functional blocks constituting the logic circuit synthesis device 1, common to each embodiment, will be described with reference to the attached drawings.

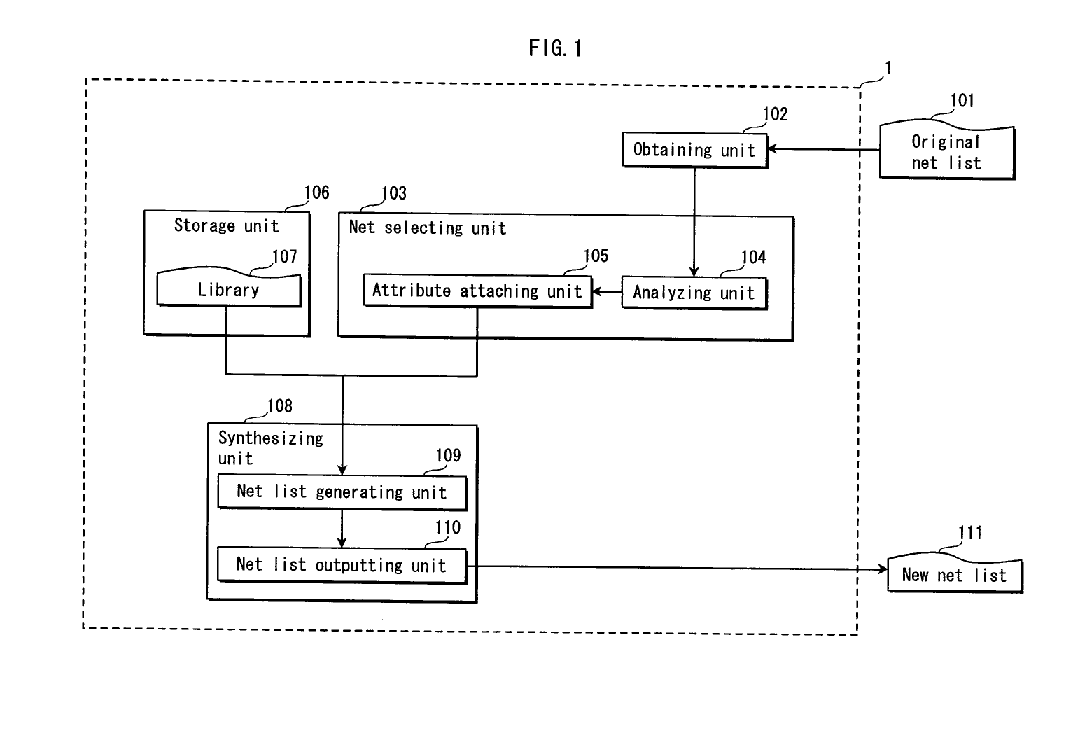

FIG. 1 is a functional block diagram of the logic circuit synthesis device 1.

As shown in FIG. 1, the logic circuit synthesis device 1 includes an obtaining unit 102, a net selecting unit 103, a storage unit 106, and a synthesizing unit 108. Although each embodiment has different library and net list, the following describes only a library 107, an original net list 101, and a new net list 111 of Embodiment 1, for convenience of explanation referring to the drawings.

1.1.4.1 Obtaining Unit 102

The obtaining unit 102 obtains the original net list 101 by reading it from the hard disk or memory, or by receiving data via a network or the like. The obtaining unit 102 outputs the obtained original net list 101 to the net selecting unit 103.

1.1.4.2 Net Selecting Unit 103

The net selecting unit 103 includes an analyzing unit 104 and an attribute attaching unit 105, selects a net having the predetermined property, and attaches a net attribute to the selected net.

The analyzing unit 104 receives the original net list 101 from the obtaining unit 102, and analyzes the original net list 101. More specifically, the analyzing unit 104 executes a property analysis tool that identifies a net in which an error such as a cross talk or SignalEM has occurred due to a simulation or the like. The analyzing unit 104 also detects a net or a bus that is at a boundary between blocks, based on the net list. Based on the analysis results, the analyzing unit 104 selects a net having a predetermined property from among a plurality of nets specified by the original net list 101. It should be noted here that since the property analysis tool is known and has been used conventionally, detailed description thereof is omitted.

The attribute attaching unit 105 attaches a name, which specifies the predetermined property, to the original net list 101 as the net attribute so that the net selected by the analyzing unit 104 has the predetermined property. It should be noted here that the net list indicates that the selected net has been attached with the net attribute. The attribute attaching unit 105 outputs the original net list 101 in which the net attribute has been attached, to the synthesizing unit 108.

1.1.4.3 Storage Unit 106

The storage unit 106 stores the library 107. The storage unit 106 is, for example, achieved as a RAM (Random Access Memory).

The library 107 is a library of cells. The library 107 stores, for each cell in the library, the structure condition information that specifies a condition which should be satisfied by the net structure when the cell connects to the net having a predetermined property.

1.1.4.4 Synthesizing Unit 108

The synthesizing unit 108 includes a net list generating unit 109 and a net list outputting unit 110, and generates and outputs a net list that satisfies the condition specified by the structure condition information.

The net list generating unit 109 generates the new net list 111 that satisfies the condition specified by the structure condition information stored in the library 107, based on the original net list 101 that was output from the attribute attaching unit 105 and has been attached with the net attribute, and based on the library 107 stored in the storage unit 106. The process will be described in detail in “1.3 Operation”.

The net list outputting unit 110 outputs the new net list 111 generated by the net list generating unit 109, to an external device, for example.

1.1.5 Present Invention as Specific Achievement

The above-described logic circuit synthesis device 1 is specifically a computer system that includes a CPU (Central Processing Unit), ROM (Read Only Memory), RAM (Random Access Memory) and the like. Each of the above-described functional blocks of the logic circuit synthesis device 1 is achieved as hardware and a computer program that runs on the hardware. The CPU operates in accordance with the computer program and causes the logic circuit synthesis device 1 to achieve the functions thereof.

As other forms of the achievement, each of the above-described functional blocks of the logic circuit synthesis device 1 may be achieved as hardware, or part of the functional blocks may be achieved as software.

1.1.6 Operation Common to Embodiments

Next, the operation of the logic circuit synthesis device 1 common to the embodiments will be described.

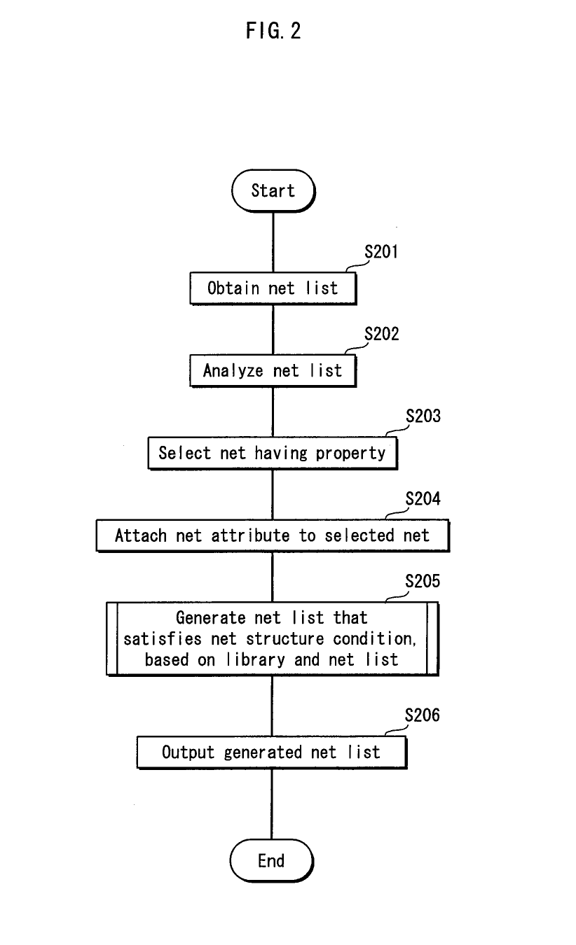

FIG. 2 is a flowchart showing the operation of the logic circuit synthesis device 1.

As shown in FIG. 2, first, the obtaining unit 102 of the logic circuit synthesis device 1 obtains the original net list 101 (step S201).

The analyzing unit 104 then analyzes the obtained original net list 101 (step S202).

Based on the analysis results, the analyzing unit 104 selects a net having a predetermined property from the nets specified by the original net list 101 (step S203).

The attribute attaching unit 105 attaches a net attribute, which corresponds to the property, to the selected net (step S204).

The net list generating unit 109 of the logic circuit synthesis device 1 generates the new net list 111 that satisfies the condition specified by the structure condition information stored in the library 107, based on the original net list 101, in which nets having the predetermined property are attached with the net attribute, and based on the library 107 stored in the storage unit 106 (step S205). It should be noted here that the step S205, which is operated differently in each embodiment, will be described in detail in each embodiment.

The net list outputting unit 110 of the logic circuit synthesis device 1 outputs the generated new net list 111 (step S206).

1.2 Explanation of Each Embodiment

Next, the differences among the embodiments will be described in detail.

As described earlier in “1.1.3 Outline of Differences among Embodiments”, the data structure of the library and the net list differs in each embodiment. Also, the method of achieving the optimization of the logic circuit, more specifically the process of step S205, differs in each embodiment.

In the following description of each embodiment, the difference in the data structure of the library and the net list, and in the process of step S205 will be explained specifically.

1.3 Data Used in Embodiment 1

The following describes the data structure of the library 107 stored in the storage unit 106 and the data structure of the net list.

1.3.1 Library 107

The library stores information regarding each of a plurality of types of cells. In the following description of each embodiment, information regarding one cell in the library will be described.

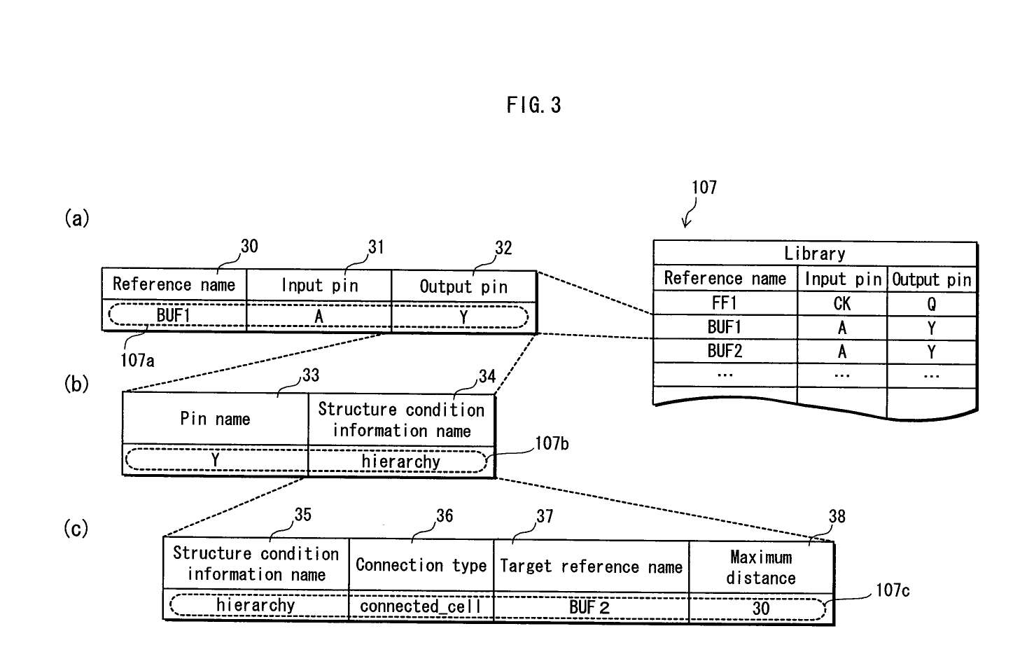

FIG. 3 shows the data structure of a cell contained in the library 107.

1.3.1.1 Data Structure of Library

As shown in (a) of FIG. 3, one piece of record 107a of the library 107 includes a reference name 30, an input pin 31, and an output pin 32.

The reference name 30 is a reference name used for referring to a cell that is a target of the mapping. In FIG. 3, the reference name 30 specifies “BUF1”, which indicates that the cell is a buffer, and that the library corresponds to the buffer “BUF1”.

The input pin 31 is a reference name of a pin for receiving a signal input to the cell. In FIG. 3, the input pin 31 specifies “A” representing the input pin.

The output pin 32 is a reference name of a pin for outputting a signal from the cell. In FIG. 3, the output pin 32 specifies “Y” representing the output pin.

The data type of the reference name 30, the input pin 31, and the output pin 32 is character sequence.

1.3.1.2 Data Structure of Pin

In (b) of FIG. 3, the data structure of pin is shown. One piece of record 107b constituting the data of pin includes a pin name 33 and a structure condition information name 34.

The pin name 33 is a reference name of a pin. In FIG. 3, the pin name 33 specifies “Y”, which corresponds to “Y” specified by the output pin 32.

The structure condition information name 34 is a reference name of a net attribute being a target to which the structure condition information is applied. In FIG. 3, the structure condition information name 34 specifies “hierarchy” indicating that the net is at a boundary between blocks. This indicates that the structure condition information is applied when the pin specified by the pin name 33 is connected to the net to which net attribute “hierarchy” has been attached.

The data type of the pin name 33 and the structure condition information name 34 is character sequence.

1.3.1.3 Data Structure of Structure Condition Information

In (c) of FIG. 3, the data structure of the structure condition information is shown. One piece of record 107c constituting the structure condition information includes a structure condition information name 35, a connection type 36, a target reference name 37, and a maximum distance 38.

The structure condition information name 35 is a reference name of a net attribute being a target to which the structure condition information is applied. In FIG. 3, the structure condition information name 35 specifies “hierarchy”, which corresponds to “hierarchy” specified by the structure condition information name 34.

The connection type 36 specifies whether or not the pin specified by the pin name 33 is directly connected to the reference destination specified by the target reference name 37. When the pin is directly connected to the reference destination, the connection type 36 specifies “connected_cell”, and when the pin is not directly connected to the reference destination, the connection type 36 specifies “all_cell”. In FIG. 3, the connection type 36 specifies “connected_cell” indicating that the pin is directly connected to the reference destination.

The target reference name 37 is a parameter specifying a reference destination that is a target to which the structure condition information is applied when a net is constructed with the pin specified by the pin name 33. In FIG. 3, the target reference name 37 specifies “BUF2” that indicates a buffer. That is to say, the structure condition information is applied to the structure including the buffer specified by the reference name “BUF2” and the pin “Y” of the buffer “BUF1” specified by the reference name 30.

The maximum distance 38 specifies a restriction in the maximum distance between references being targets to which the structure condition information is applied. In FIG. 3, the maximum distance 38 specifies “30” indicating that the distance between reference names “BUF1” and “BUF2” should not be larger than “30”. It should be noted here that any unit may be used for indicating the distance. For example, the distance may be indicated in units of micrometers.

The data type of the structure condition information name 35 and the target reference name 37 is character sequence. The connection type 36 is either “connected_cell” or “all_cell”, and the data type thereof is list. The data type of the maximum distance 38 is numeral.

1.3.2 Data Structure of Net List

Next, the data structure of the net list will be described. The net list includes information regarding a plurality of nets. In the following description of embodiment, the data structure of one net in the net list will be described.

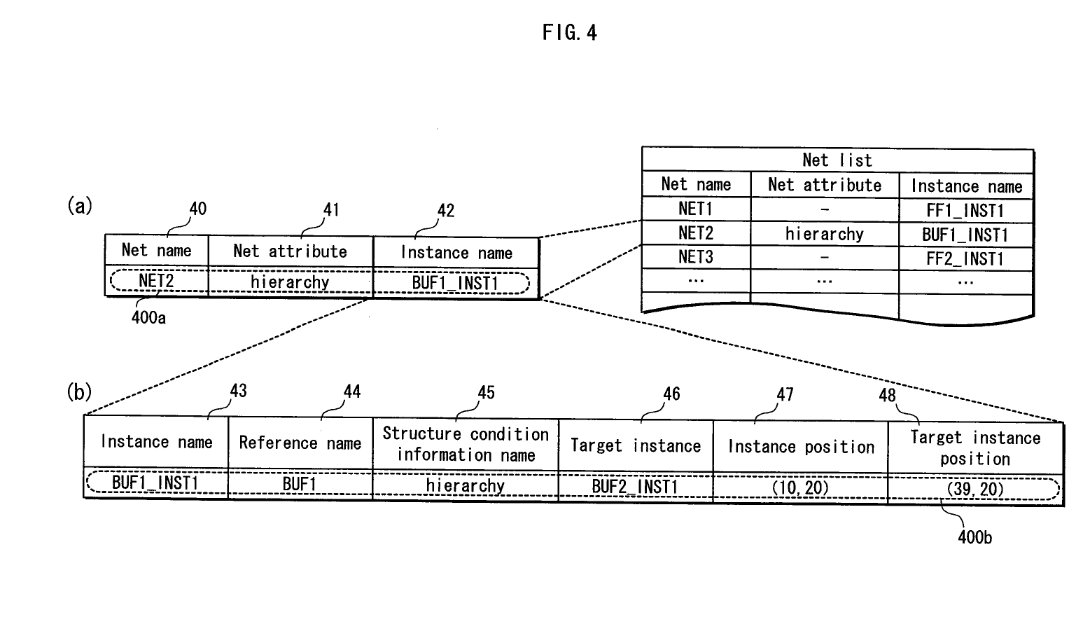

FIG. 4 shows the data structure of one net in the net list. The net list indicates nets and instances of the nets.

1.3.2.1 Data Structure of Net

The (a) of FIG. 4 shows the data structure of one net in the net list.

As shown in (a) of FIG. 4, one piece of record 400a of the net includes a net name 40, a net attribute 41, and an instance name 42. The instance is a lower order circuit contained in the net.

The net name 40 is a reference name of the net.

The net attribute 41 specifies a net attribute attached to the net. In FIG. 4, the net attribute 41 specifies “hierarchy”, which indicates that net attribute “hierarchy” is attached to the net.

The instance name 42 is a reference name of an instance connected to the start of the net.

1.3.2.2 Data Structure of Instance

The (b) of FIG. 4 shows the data structure of an instance of the net.

As shown in (b) of FIG. 4, one piece of record 400b of the instance includes an instance name 43, a reference name 44, a structure condition information name 45, a target instance 46, an instance position 47, and a target instance position 48.

The instance name 43 is a reference name of the instance. As shown in FIG. 4, the instance name 43 corresponds to the reference name of the instance specified by the instance name 42 of the net data structure.

The reference name 44 is a reference name of a cell contained in the instance specified by the instance name 43. In FIG. 4, the reference name 44 specifies “BUF1”, which indicates that the instance “BUF1_INST1” includes cell of “BUF1”.

The structure condition information name 45 specifies a reference name of a net attribute corresponding to the applied structure condition information when the structure condition information in the library 107 is applied to the net. Further, that the data is stored in the structure condition information name 45 indicates that the net is constructed by applying the structure condition information thereto.

The target instance 46 specifies a reference name of an instance being a target of the instance specified by the instance name 43, where the structure condition information corresponding to the net attribute specified by the structure condition information name 45 is applied to the target.

The instance position 47 specifies an arrangement position of the instance specified by the instance name 43. The arrangement position of the instance is specified by (X,Y) representing X- and Y-coordinate values. The position (0,0) may be set to any position on the circuit board, but may be, for example, a corner of the circuit board. In FIG. 4, the instance position 47 is (10,20), which indicates that the instance specified by the reference name “BUF1_INST1” is arranged at a position where the X-coordinate is 10 and the Y-coordinate is 20.

The target instance position 48 specifies an arrangement position of the instance specified by the target instance 46. In FIG. 4, the target instance position 48 is (39,20), which indicates that the instance specified by the reference name “BUF2_INST1” specified by the target instance 46 is arranged at a position where the X-coordinate is 39 and the Y-coordinate is 20.

1.4 Details of Net List Generation Process

Next, the step S205 will be described in detail.

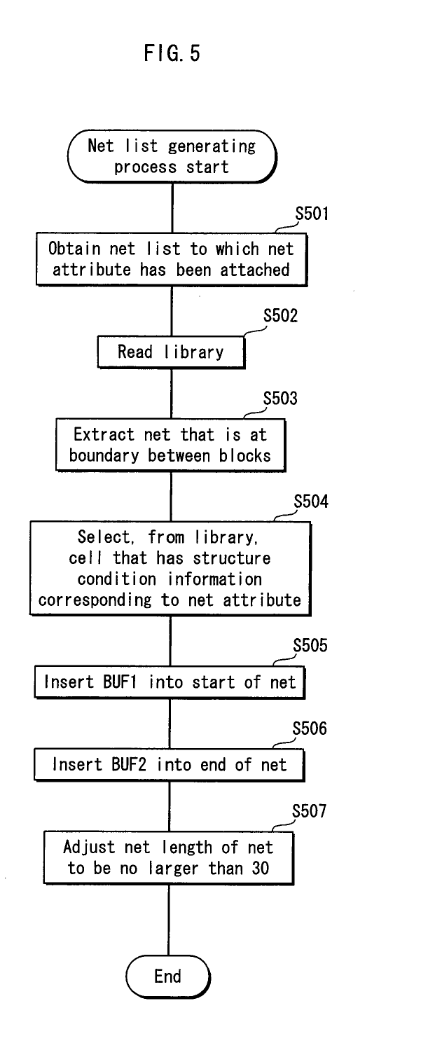

FIG. 5 is a flowchart showing the details of the process in which the net list generating unit 109 generates the net list satisfying the condition specified by the structure condition information. In Embodiment 1, a net having a predetermined property is a net at a boundary between blocks. Therefore, in the following description, a net at a boundary between blocks will be centered in explaining the process for generating a net list that satisfies the condition specified by the structure condition information contained in the library 107. It is presumed that, in step S204, the attribute attaching unit 105 attaches “hierarchy”, which indicates that the net is at a boundary between blocks, as a net attribute.

As shown in FIG. 5, the net list generating unit 109 of the synthesizing unit 108 obtains the original net list 101 which was output from the attribute attaching unit 105 and to which the net attribute has been attached (step S501).

The net list generating unit 109 then reads the library 107 from the storage unit 106 (step S502).

The net list generating unit 109 extracts, from the original net list 101, a net in which net attribute “hierarchy” has been attached to the net attribute 41 (step S503).

The net list generating unit 109 then selects, from the library 107, a cell that has the structure condition information corresponding to net attribute “hierarchy” (step S504). In the present embodiment, the structure condition information corresponding to net attribute “hierarchy” is stored in a buffer with reference name “BUF1”, as shown in FIG. 2. The net list generating unit 109 thus selects buffer “BUF1” from the library 107.

After selecting “BUF1” being a cell in which the structure condition information corresponding to net attribute “hierarchy” is stored, by referring to the library 107, the net list generating unit 109 reads the connection type 36, the target reference name 37, and the maximum distance 38 regarding the “BUF1”. In the present embodiment, the structure condition information specifies conditions that reference name “BUF2” is directly connected, and that the maximum distance is no larger than 30. The net list generating unit 109 reads such conditions, and generates a net list such that the net structure satisfies the conditions.

More specifically, first, the net list generating unit 109 inserts the cell selected in step S504, namely, a buffer with reference name “BUF1”, into the start of the net having net attribute “hierarchy” (step S505). Next, the net list generating unit 109 inserts a cell having a reference name specified by the target reference name 37 in the library of the cell selected in step S504, namely, a buffer with reference name “BUF2”, into the end of the net having net attribute “hierarchy” (step S506). The net list generating unit 109 then adjusts the net length of the net having net attribute “hierarchy” to be no larger than the distance specified by the maximum distance 38, namely, no larger than 30 (step S507).

In this way, the net list generating unit 109 generates the new net list 111 in which the adjustment has been completed.

1.5 Transition of Net Structure

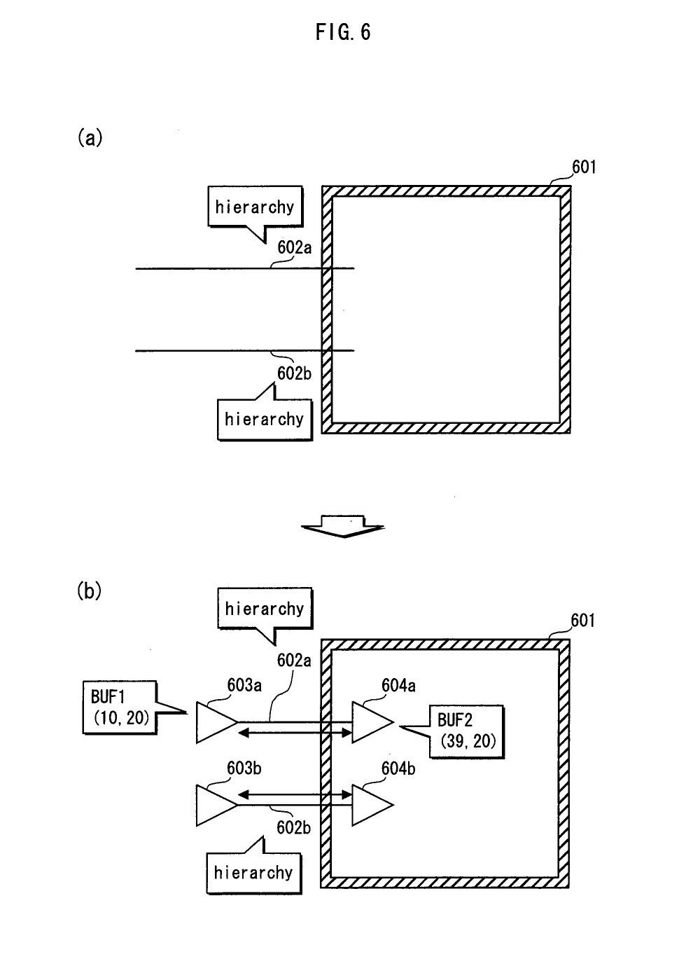

Up to now, the process in which the net list generating unit 109 of the synthesizing unit 108 generates the new net list 111. Here will be described how the net structure shown in the original net list 101 undergoes a transition by the process performed by the net list generating unit 109, with reference to FIG. 6.

FIG. 6 shows a transition of the net structure.

The (a) of FIG. 6 shows the structure of part of nets in the original net list 101.

The (a) of FIG. 6 shows, as the structure of the nets in the original net list 101, a block 601 and a net 602 (602a, 602b) that is at a boundary between blocks.

The logic circuit synthesis device 1 performs the processes of steps S202, S203 and S204 to attach the net attribute “hierarchy” to the net 602 (602a, 602b) at a boundary between blocks, among the nets specified by the original net list 101. And the logic circuit synthesis device 1 generates the new net list 111 by performing step S205, which is detailed as steps S501 through S507.

The (b) of FIG. 6 shows the structure of part of nets in the new net list 111.

The (b) of FIG. 6 shows, as the structure of the nets in the new net list 111, the block 601, the net 602 (602a, 602b) that is at a boundary between blocks, a buffer 603 (603a, 603b) being “BUF1”, and a buffer 604 (604a, 604b) being “BUF2”.

The arrangement position of “BUF1” is, for example, (10,20), and the arrangement position of “BUF2” is, for example, (39,20). That is to say, the distance between “BUF1” and “BUF2” is not larger than 30. Accordingly, the structure of the net satisfies the condition specified by the maximum distance 38 in the library 107.

1.6 Update of Net List

Here will be described how the data held by the net list is updated, while the logic circuit synthesis device 1 performs a process.

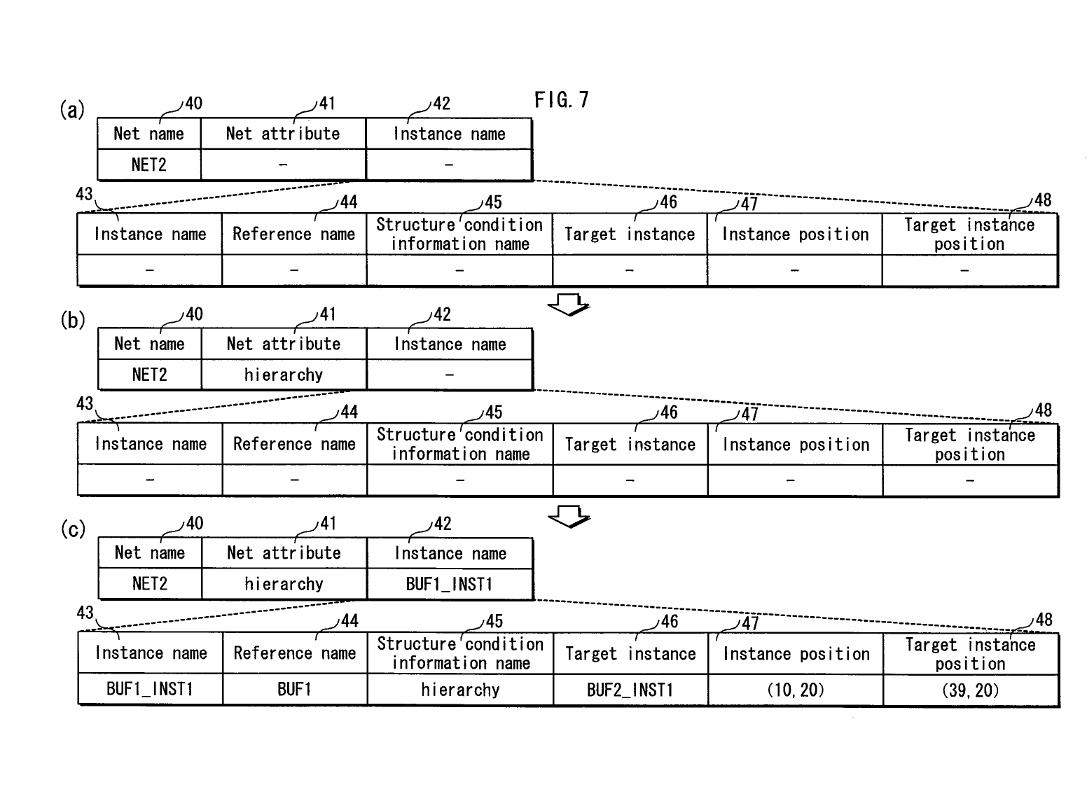

FIG. 7 shows the net list update process.

The (a) of FIG. 7 shows the original net list 101 in the state immediately after it is obtained by the obtaining unit 102 in step S201. In the original net list 101 in this state, the net name is indicated in the net name 40, but the net attribute has not been attached yet.

The (b) of FIG. 7 shows the original net list 101 in the state immediately after step S204 in which the attribute attaching unit 105 attaches the net attribute “hierarchy” to the net, and the original net list 101 in this state is to be input to the net list generating unit 109 in step S205. The net attribute “hierarchy” has been attached to the net attribute 41.

The (c) of FIG. 7 shows the new net list 111 generated by the net list generating unit 109. In the data structure of instance, the structure of the net is indicated in the instance position 47 and in the target instance position 48.

### Embodiment 2

2.1 Outline

In the following, another embodiment of the logic circuit synthesis device of the present invention will be described.

In Embodiment 2, the logic circuit synthesis device 1 selects, as a net having a predetermined property, a congested net whose wiring density is higher than a predetermined value.

When the net is congested, problems such as a difficult cell arrangement occur. Such a problem can be solved by the following, for example. That is to say, with respect to a type of cell that has a lot of pins and is easy to be congested, it is possible to prevent the wiring arrangement from being congested by setting the structure condition information in advance such that the wiring length is extended when it is connected to a congested net. More specifically, a flip flop is arranged to be away from the congested net.

Also, since Embodiment 2 is different from Embodiment 1 in the data structure of the library, a library stored in the storage unit 106 is referred to as a library 207 in Embodiment 2.

Further, since Embodiment 2 is different from Embodiment 1 in the data structure of the net list, a net list obtained by the obtaining unit 102 is referred to as an original net list 201, and a net list generated by the net list generating unit 109 is referred to as a new net list 211.

With respect to the other functional blocks that are common with Embodiment 1, the reference signs used in Embodiment 1 are attached thereto and description thereof is omitted.

<Data>

2.2 Data

In the following, the data structure of the library 207 stored in the storage unit 106 and the data structure of the net list will be described.

2.2.1 Library 207

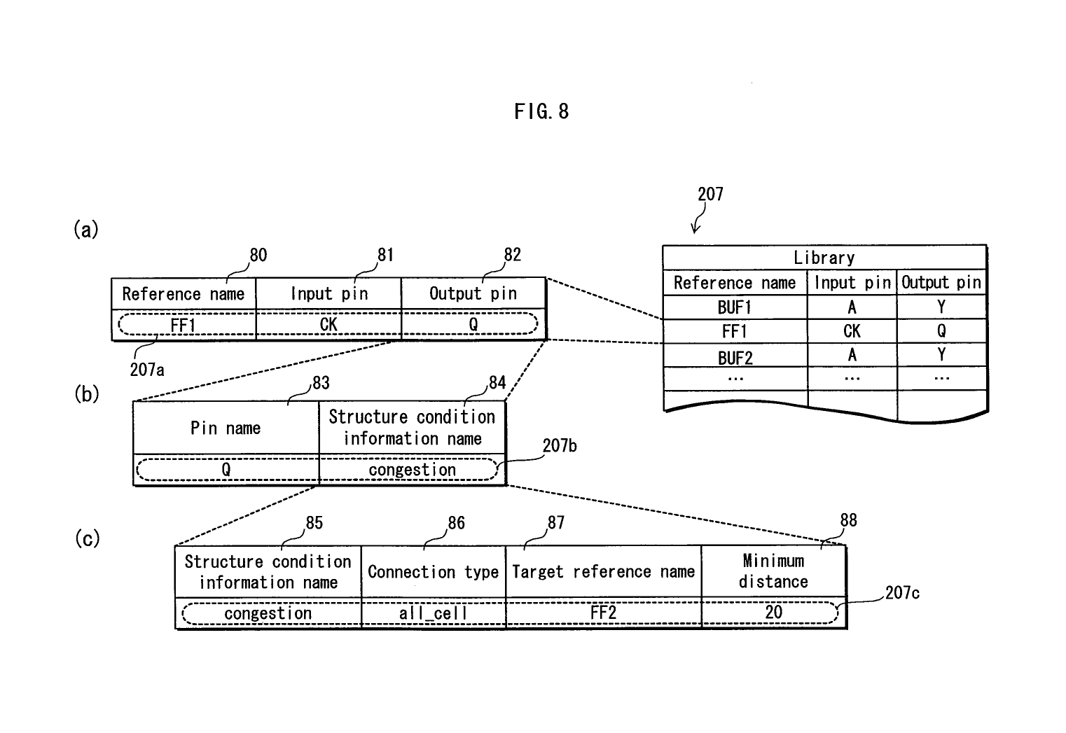

FIG. 8 shows the data structure of one cell contained in the library 207.

2.2.1.1 Data Structure of Library

As shown in (a) of FIG. 8, one piece of record 207a of the library 207 includes a reference name 80, an input pin 81, and an output pin 82. The data actually stored therein is different from the data stored in the corresponding ones in Embodiment 1, but description thereof is omitted here since they indicate a reference name and the like in the same manner as the reference name 30, the input pin 31, and the output pin 32 in Embodiment 1.

The difference in the data stored therein is as follows. As shown in FIG. 8, the reference name 80 of Embodiment 2 stores data “FF1”, which indicates that the cell is flip flop. Also, the input pin 81 specifies “CK” and the output pin 82 specifies

2.2.1.2 Data Structure of Pin

In (b) of FIG. 8, the data structure of pin is shown. One piece of record 207b constituting the data of pin includes a pin name 83 and a structure condition information name 84.

Description of the pin name 83 and structure condition information name 84 is omitted here since they have the same structure as the pin name 33 and the structure condition information name 34 shown in FIG. 3.

In Embodiment 2, the pin name 83 specifies “Q”, which corresponds to “Q” specified by the output pin 82. Also, the structure condition information name 84 specifies “congestion”. The “congestion” is a reference name of a net attribute that specifies a congested net.

2.2.1.3 Data Structure of Structure Condition Information

In (c) of FIG. 8, the data structure of the structure condition information is shown. One piece of record 207c constituting data of the structure condition information includes a structure condition information name 85, a connection type 86, a target reference name 87, and a minimum distance 88. Especially, the structure differs from Embodiment 1 in that it includes the minimum distance 88.

Description of the structure condition information name 85, connection type 86, target reference name 87, and minimum distance 88 is omitted since they are the same as the structure condition information name 35, connection type 36, target reference name 37, and maximum distance 38 shown in FIG. 3, respectively.

In Embodiment 2, the structure condition information name 85 specifies “congestion”, the connection type 86 specifies “all_cell”, and the target reference name 87 specifies “FF2”. The “FF2” specifies the flip flop.

The minimum distance 88 specifies a restriction in the minimum distance between references being targets to which the structure condition information is applied. In (c) of FIG. 8, the minimum distance 88 specifies “20” indicating that the distance between reference names “FF1” and “FF2” should not be smaller than “20”.

The data type of the minimum distance 88 is numeral.

2.2.2 Data Structure of Net List

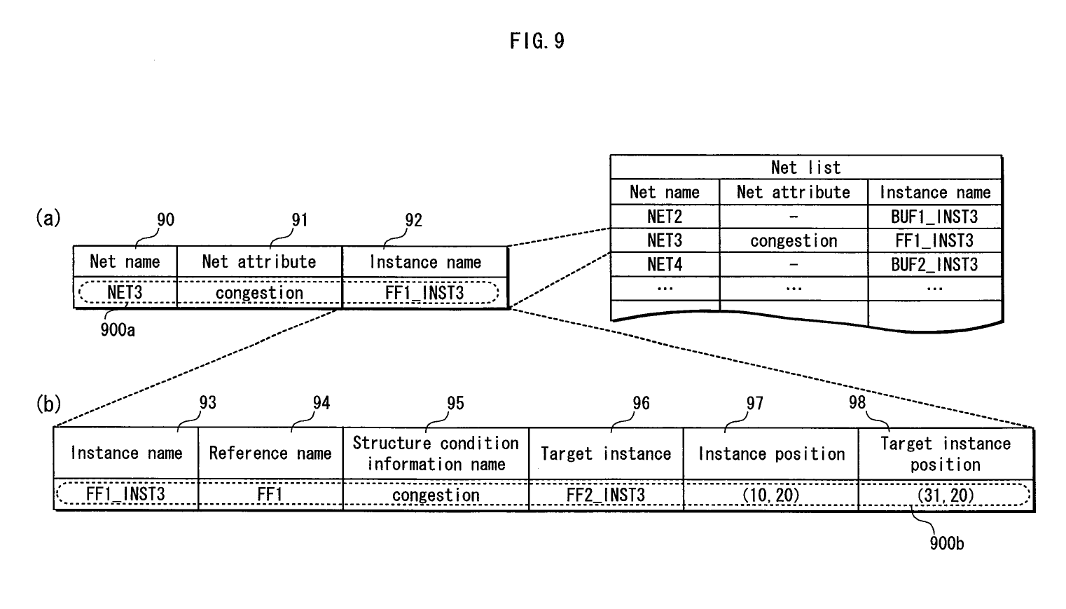

FIG. 9 shows the data structure of one net in the net list of Embodiment 2.

2.2.2.1 Data Structure of Net

The (a) of FIG. 9 shows the data structure of one net in the net list.

As shown in (a) of FIG. 9, one piece of record 900a of the net includes a net name 90, a net attribute 91, and an instance name 92.

Description of the net name 90, net attribute 91, and instance name 92 is omitted since they are the same as the net name 40, net attribute 41, and instance name 42 shown in FIG. 4.

In Embodiment 2, the net attribute 91 specifies “congestion”, which indicates that net attribute “congestion” is attached to the net.

2.2.2.2 Data Structure of Instance

The (b) of FIG. 9 shows the data structure of an instance of the net.

As shown in (b) of FIG. 9, one piece of record 900b of the instance includes an instance name 93, a reference name 94, a structure condition information name 95, a target instance 96, an instance position 97, and a target instance position 98. Description of the instance name 93, reference name 94, structure condition information name 95, target instance 96, instance position 97, and target instance position 98 is omitted since they are the same as the structure condition information name 45, target instance 46, instance position 47, and target instance position 48 shown in (b) of FIG. 4.

2.3 Details of Net List Generation Process

Next, the step S205 in Embodiment 2 will be described in detail.

In Embodiment 2, the net having a predetermined property is a congested net. Also, in step S202 shown in FIG. 2, the analyzing unit 104 checks on the congestion status of the net based on the layout information that specifies the wiring path of the logic circuit, and in step S203, selects a net whose wiring density is larger than a predetermined value. Further, in Embodiment 2, the attribute attaching unit 105 attaches net attribute “congestion” to the selected net.

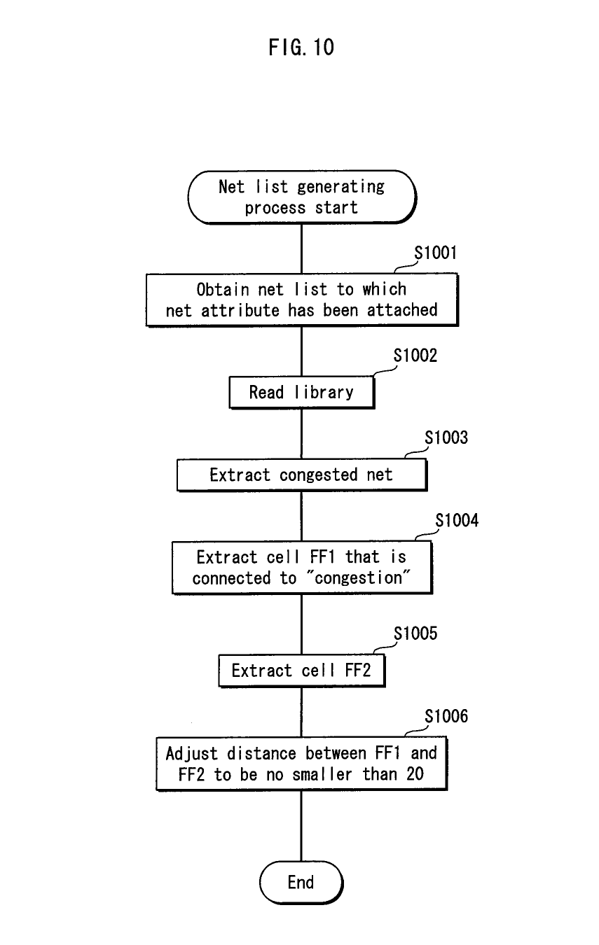

FIG. 10 is a flowchart showing the details of the process of step S205 in Embodiment 2.

As shown in FIG. 10, the net list generating unit 109 obtains the original net list 201 which was output from the attribute attaching unit 105 and to which the net attribute has been attached (step S1001).

The net list generating unit 109 then reads the library 207 from the storage unit 106. In this process, the net list generating unit 109 extracts a cell that is indicated as “congestion” in the structure condition information name 84. In the example of the present embodiment, the net list generating unit 109 extracts buffer “FF1” (step S1002).

The net list generating unit 109 extracts, from the original net list 201, a net in which net attribute “congestion” has been attached to the net attribute 91 (step S1003).

Next, the net list generating unit 109 extracts a cell that is connected to the net having the net attribute “congestion” and has a reference name “FF1” (step S1004).

Also, the net list generating unit 109 extracts a cell that is connected to the net having the net attribute “congestion” and is specified by the target reference name 87 as a target of the library of “FF1”, namely, in the present embodiment, a cell having reference name “FF2” (step S1005).

After extracting cells “FF1” and “FF2”, the net list generating unit 109 adjusts the distance between “FF1” and “FF2” to be no smaller than the value specified by the minimum distance 88 of the library of “FF1”, namely, no smaller than 20 (step S1006).

2.4 Transition of Net Structure

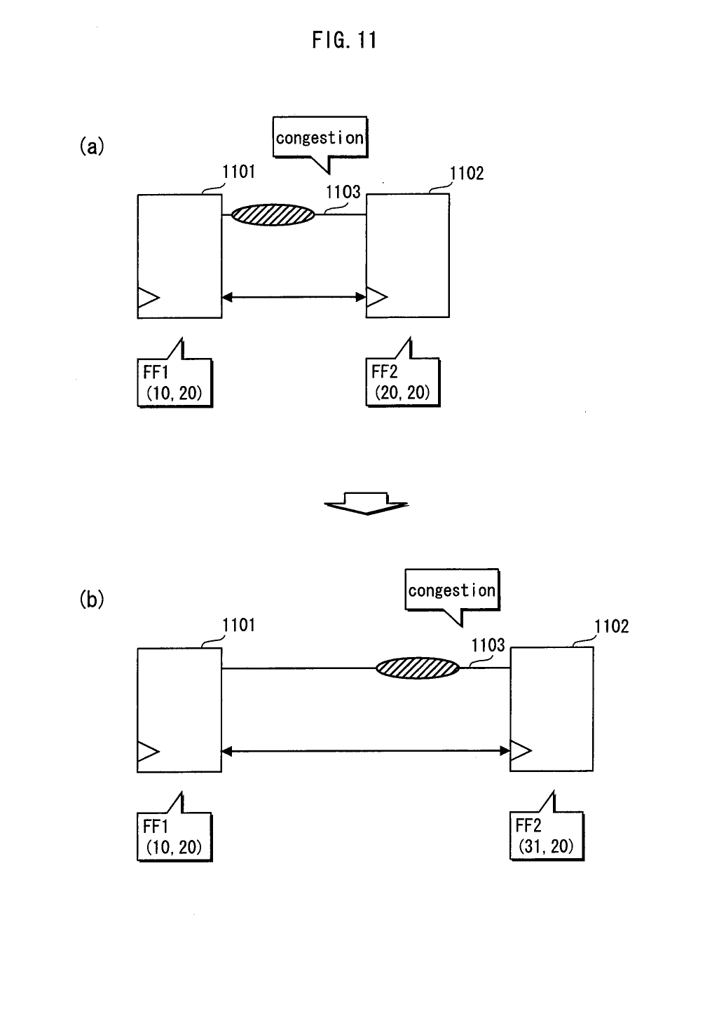

FIG. 11 shows a transition of the net structure.

The (a) of FIG. 11 shows the structure of part of nets in the original net list 201.

The (a) of FIG. 11 shows the structure of the nets in the original net list 201. As shown in (a) of FIG. 11, the original net list 201 includes a flip flop 1101, a flip flop 1102, and a congested net 1103, as the structure of part of nets in the original net list 201. The congested net 1103 connects between the flip flop 1101 and the flip flop 1102. The flip flop 1101 has a reference name “FF1”, and the flip flop 1102 has a reference name “FF2”.

The logic circuit synthesis device 1 performs the processes of steps S202, S203 and S204 to attach the net attribute “congestion” to the congested net 1103 among the nets specified by the original net list 201. And the logic circuit synthesis device 1 generates the new net list 211 by performing step S205, which is detailed as steps S1001 through S1006.

The (b) of FIG. 11 shows the structure of part of nets in the new net list 211.

The (b) of FIG. 11 shows, as the structure of the nets in the new net list 211, the flip flop 1101, the flip flop 1102, and the congested net 1103.

The arrangement position of “FF1” is, for example, (10,20), and the arrangement position of “FF2” is, for example, (31,20). That is to say, the distance between “FF1” and “FF2” is not smaller than 20. Accordingly, the structure of the net satisfies the condition specified by the minimum distance 88 in the library 207.

2.5 Update of Net List

Here will be described how the data held by the net list is updated, while the logic circuit synthesis device 1 of Embodiment 2 performs a process.

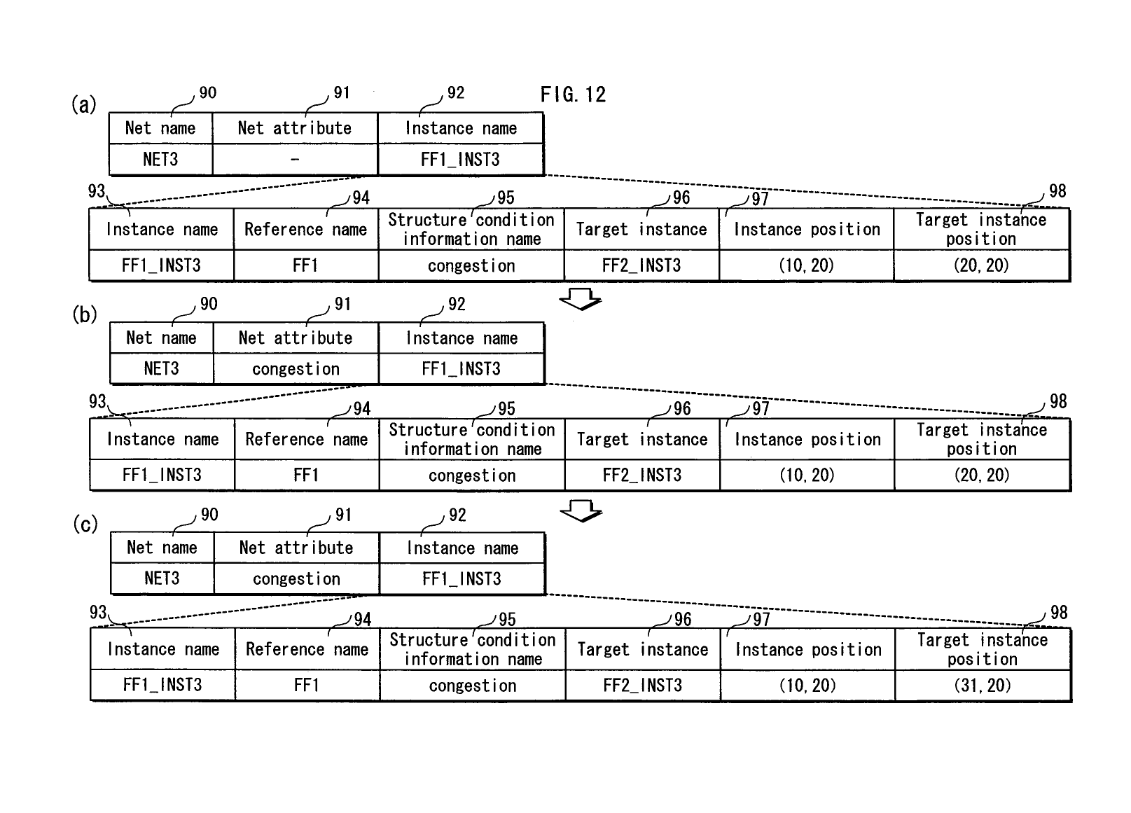

FIG. 12 shows the net list update process.

The (a) of FIG. 12 shows the original net list 201 in the state immediately after it is obtained by the obtaining unit 102 in step S201. In the original net list 201 in this state, the net attribute has not been attached yet. Also, positions of instances are specified by the target reference name 87 and the minimum distance 88.

The (b) of FIG. 12 shows the original net list 201 in the state immediately after step S204 in which the attribute attaching unit 105 attaches the net attribute “congestion” to the net, and the original net list 201 in this state is to be input to the net list generating unit 109 in step S205. The net attribute “congestion” has been attached to the net attribute 91.

The (c) of FIG. 12 shows the new net list 211 generated by the net list generating unit 109. It shows the net structure including the instance data structure where the distance between flip flops has been set to be no smaller than 20 by applying the structure condition information.

2.6 Modification to Embodiment 2

Here will be described a modification to Embodiment 2.

In addition to the restriction of the minimum distance described above, the distance in separating cells may be included in the condition specified by the structure condition information. For example, arrangement of some cells is restricted to the vertical direction, and arrangement of other cells is restricted to the horizontal direction, and these restrictions are added to the structure condition information for each cell. By adding such restrictions, it is possible to prevent wiring arrangement congestion by, for example, restricting arrangement of cells that have a small number of wiring arrangement resources in the horizontal direction, to the vertical direction.

It should be noted here that in the following description of the modification to Embodiment 2, a library stored in the storage unit 106 is referred to as a library 207-1. Also, a net list obtained by the obtaining unit 102 is referred to as an original net list 201-1, and a net list generated by the net list generating unit 109 is referred to as a new net list 211-1.

The following are the details.

2.7 Data of Modification to Embodiment 2

Here will be described the data structure of the library 207-1 stored in the storage unit 106 and the data structure of the net list.

2.7.1 Library 207-1

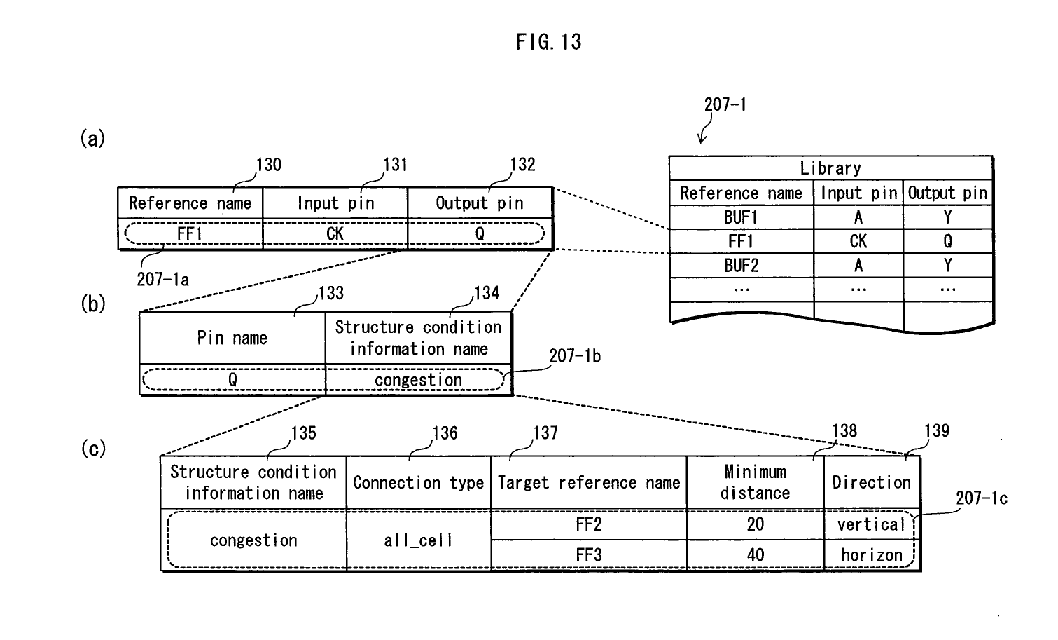

FIG. 13 shows the data structure of one cell contained in the library 207-1.

2.7.1.1 Data Structure of Library

As shown in (a) of FIG. 13, one piece of record 207-1a of the library 207-1 includes a reference name 130, an input pin 131, and an output pin 132. Description thereof is omitted here since they indicate a reference name and the like in the same manner as the reference name 80, the input pin 81, and the output pin 82 shown in FIG. 8.

2.7.1.2 Data Structure of Pin

In (b) of FIG. 13, the data structure of pin is shown.

One piece of record 207-1b constituting the data of pin includes a pin name 133 and a structure condition information name 134.

Description of the pin name 133 and structure condition information name 134 is omitted here since they are the same as the pin name 83 and the structure condition information name 84 shown in FIG. 8.

2.7.1.3 Data Structure of Structure Condition Information

In (c) of FIG. 13, the data structure of the structure condition information is shown. One piece of record 207-1c constituting data of the structure condition information includes a structure condition information name 135, a connection type 136, a target reference name 137, a minimum distance 138, and a direction 139. The modification differs from Embodiment 2 in that it includes the direction 139.

Description of the structure condition information name 135, connection type 136, target reference name 137, and minimum distance 138 is omitted since they are the same as the structure condition information name 85, connection type 86, target reference name 87, and minimum distance 88 shown in FIG. 8, respectively.

As shown in FIG. 13, each of the target reference name 137 and the minimum distance 138 stores a plurality of pieces of data. Not limited to this example of the modification, each data item may store a plurality of pieces of data. In the example shown in FIG. 13, data is stored for each of “FF2” and “FF3”. It indicates that “FF2” should be distanced away by 20 or more, and “FF3” should be distanced away by 40 or more. Note that “FF3” indicates a flip flop.

The direction 139 specifies a direction in which the target cell specified by the target reference name 137 should be arranged. When the direction 139 specifies “vertical”, the target cell specified by the target reference name 137 should be arranged vertically, relative to the cell specified by the connection type 136. Also, when the direction 139 specifies “horizon”, the target cell specified by the target reference name 137 should be arranged horizontally, relative to the cell specified by the reference name 130.

The data type of the direction 139 is a list composed of “vertical” and “horizontal”.

2.7.2 Data Structure of Net List

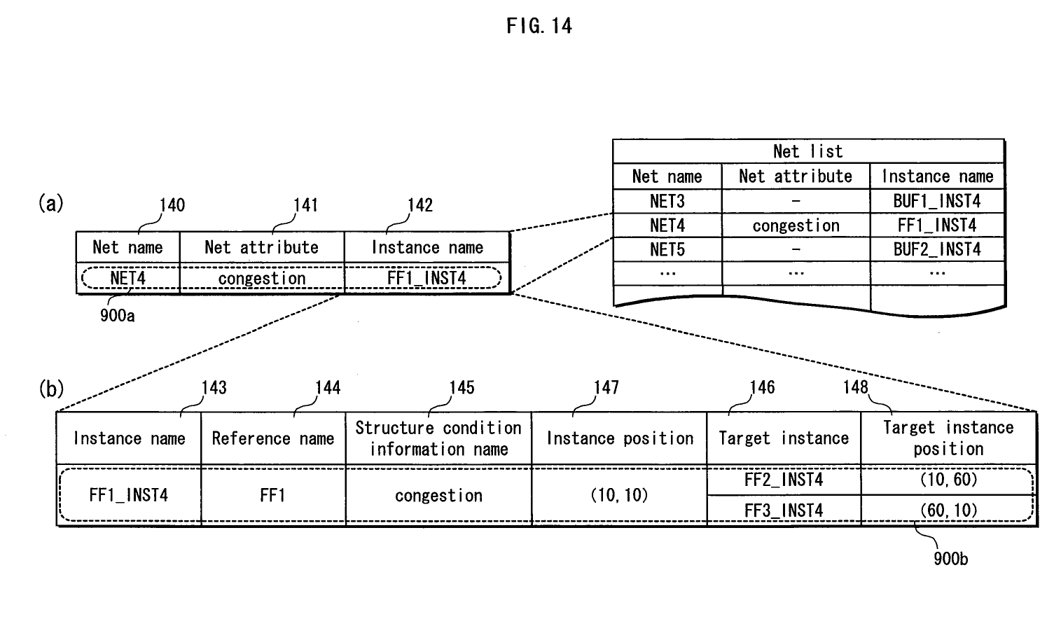

FIG. 14 shows the data structure of one net in the net list of Modification to Embodiment 2.

2.7.2.1 Data Structure of Net

The (a) of FIG. 14 shows the data structure of one net in the net list.

As shown in (a) of FIG. 14, one piece of record 1400a of the net includes a net name 140, a net attribute 141, and an instance name 142.

Description of the net name 140, net attribute 141, and instance name 142 is omitted since they are the same as the net name 90, net attribute 91, and instance name 92 shown in FIG. 9.

2.7.2.2 Data Structure of Instance

The (b) of FIG. 14 shows the data structure of an instance of the net.

As shown in (b) of FIG. 14, one piece of record 1400b of the instance includes an instance name 143, a reference name 144, a structure condition information name 145, a target instance 146, an instance position 147, and a target instance position 148. Description of the instance name 143, reference name 144, structure condition information name 145, target instance 14, instance position 147, and target instance position 14 is omitted since they are the same as the instance name 93, reference name 94, structure condition information name 95, target instance 96, instance position 97, and target instance position 98 shown in (b) of FIG. 9.

In the present modification, data is stored for each of the plurality of instances in the instance position 147 and the target instance position 148.

2.8 Details of Net List Generation Process in Modification

Next, the step S205 in Modification to Embodiment 2 will be described in detail.

As is the case with Embodiment 2, in the present modification, in step S202 shown in FIG. 2, the analyzing unit 104 checks on the congestion status of the net based on the layout information that specifies the wiring path of the logic circuit, and in step S203, selects a net whose wiring density is larger than a predetermined value. Further, in Embodiment 2, the attribute attaching unit 105 attaches net attribute “congestion” to the selected net.

The modification differs from Embodiment 2 in that the logic circuit synthesis device 1 performs the synthesizing process by taking the cell arrangement direction into consideration.

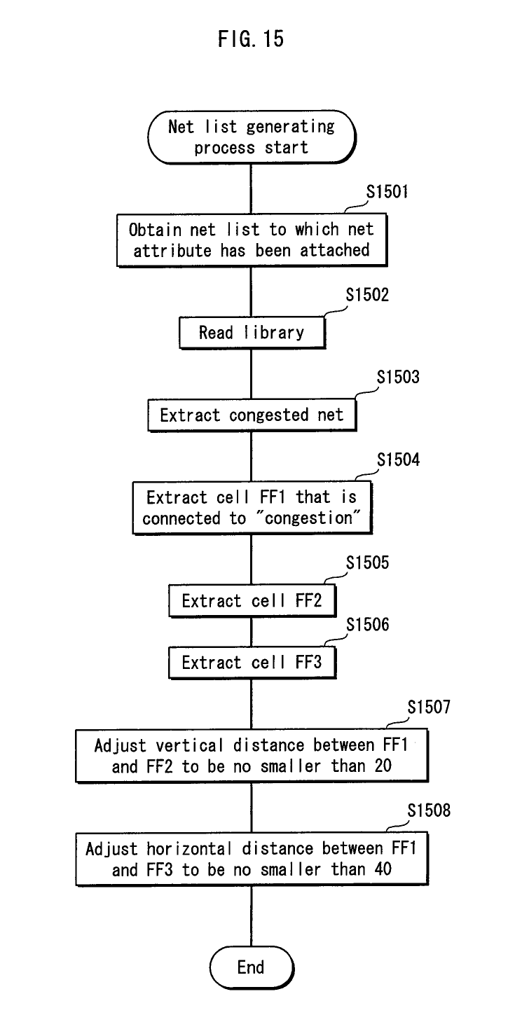

FIG. 15 is a flowchart showing the details of the process of step S205 in Modification to Embodiment 2.

Description of steps S1501 through S1505 is omitted since they are the same as steps S1001 through S1005 shown in FIG. 10. In the example of the present embodiment, “FF2” and “FF3” are extracted in step S1505.

After extracting a cell having reference name “FF2” in step S1505, the net list generating unit 109 extracts a cell that is connected to the net having the net attribute “congestion” and has a reference name “FF3” (step S1506).

After extracting cells “FF1”, “FF2” and “FF3”, the net list generating unit 109 adjusts the vertical distance between “FF1” and “FF2” to be no smaller than a value specified by the minimum distance 138 corresponding to “vertical” in the direction 139 of the library of “FF1”, namely, no smaller than 20 (step S1507).

Also, the net list generating unit 109 adjusts the horizontal distance between “FF1” and “FF3” to be no smaller than a value specified by the minimum distance 138 corresponding to “horizontal” in the direction 139 of the library of “FF1”, namely, no smaller than 40 (step S1508).

2.9 Transition of Net Structure

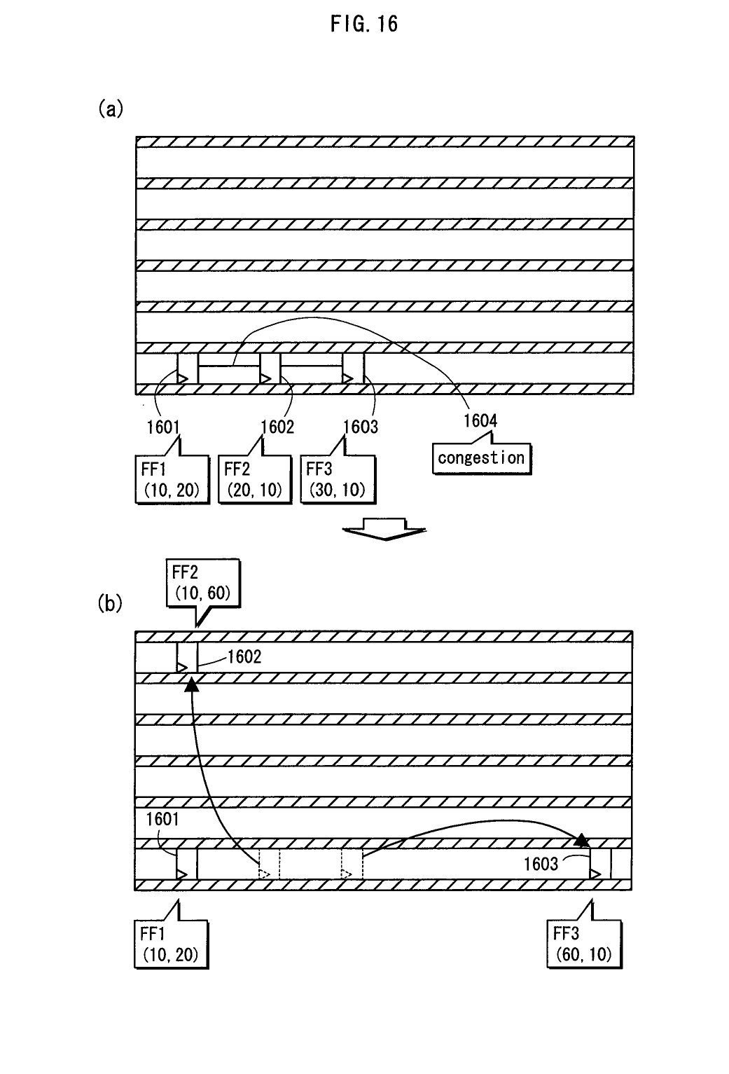

FIG. 16 shows a transition of the net structure.

The (a) of FIG. 16 shows the structure of part of nets in an original net list 201-1.

As shown in (a) of FIG. 16, a flip flops 1601, 1602, and 1603 are arranged in the horizontal direction in the original net list 201-1. A congested net 1604 is also included in this part of the original net list 201-1. The congested net 1604 connects the flip flop 1601, the flip flop 1602, and the flip flop 1603. The flip flop 1601 has a reference name “FF1”, is arranged at a position (10,10). The flip flop 1602 has a reference name “FF2”, is arranged at a position (20,10). The flip flop 1603 has a reference name “FF3”, is arrange data position (30,10).

The logic circuit synthesis device 1 performs the processes of steps S202, S203 and S204 to attach the net attribute “congestion” to the congested net 1604 among the nets specified by the original net list 201-1. And the logic circuit synthesis device 1 generates a new net list 211-1 by performing step S205, which is detailed as steps S1501 through S1508.

The (b) of FIG. 16 shows the structure of part of nets in the new net list 211-1.

As shown in (b) of FIG. 16, the flip flops 1601, 1602, and 1603 and the congested net 1604 are arranged as part of the new net list 211-1.

The “FF1” is arranged at a position (10,10), and the “FF2” is arranged at a position (10,60). That is to say, the distance between “FF1” and “FF2” is larger than 20, and “FF1” and “FF2” are arranged to be separate from each other in the vertical direction. Also, “FF3” is arranged at a position (60,10), the distance between “FF1” and “FF3” is larger than 40, and “FF1” and “FF3” are arranged to be separate from each other in the horizontal direction. Accordingly, the net structure satisfies the condition specified by the minimum distance 138 and the direction 139 of the library 207-1.

2.10 Update of Net List

Here will be described how the data held by the net list is updated, while the logic circuit synthesis device 1 performs a process of the modification to Embodiment 2.

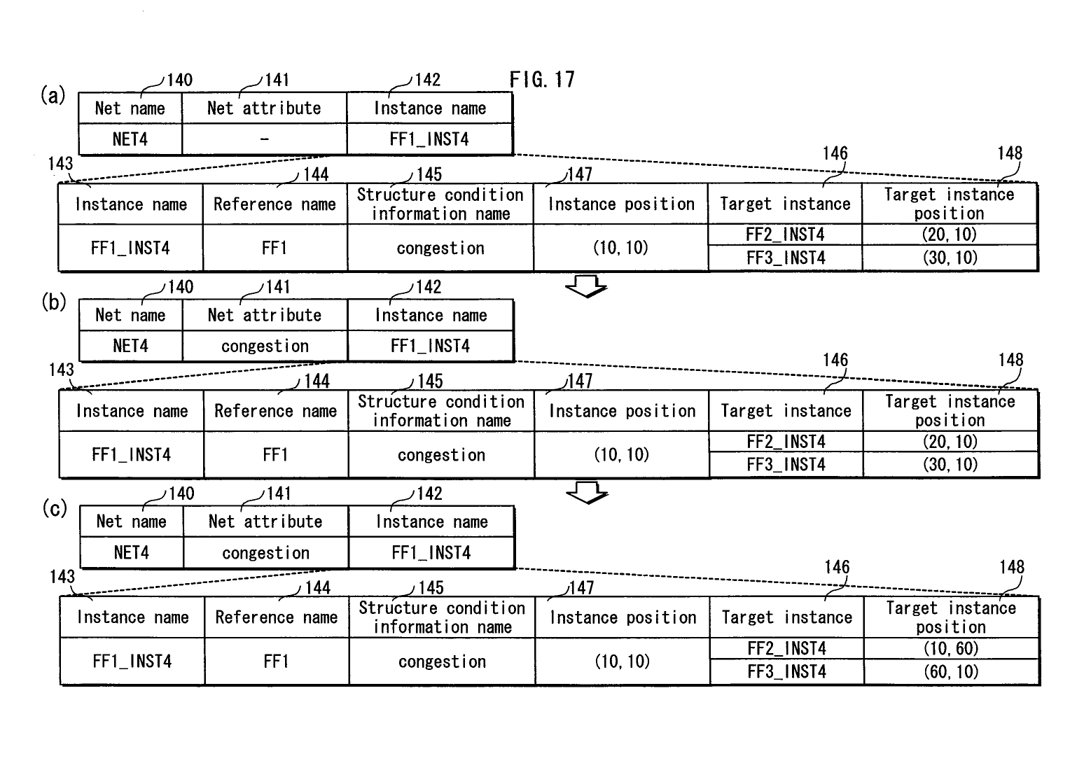

FIG. 17 shows the net list update process.

The (a) of FIG. 17 shows the original net list 201 in the state immediately after it is obtained by the obtaining unit 102 in step S201.

The (b) of FIG. 17 shows the original net list 201 in the state immediately after step S204 in which the attribute attaching unit 105 attaches the net attribute “congestion” to the net, and the original net list 201 in this state is to be input to the net list generating unit 109 in step S205.

The (c) of FIG. 17 shows the new net list 211 generated by the net list generating unit 109. In the data structure of instance, indicated is the structure of the net after the distance between flip flops and the arrangement direction thereof are adjusted by applying the structure condition information.

### Embodiment 3

3.1 Outline

In the following, another embodiment of the logic circuit synthesis device of the present invention will be described.

In Embodiment 3, the logic circuit synthesis device 1 selects, as a net having a predetermined property, a glitch occurrence net in which a glitch with a predetermined height has occurred.

When a glitch has occurred, a flip flop may perform an abnormal operation. The problem can be solved by inserting an appropriate number of buffers. When an appropriate number of buffers are inserted, the error attenuates, thus preventing the abnormal operation of the flip flop. It should be noted here that the number of buffers to be inserted between a cell and a flip flop is referred to as “the number of steps”. For example, two or more buffers should be inserted between a cell and a flip flop, the number of steps is two or more.

Also, since Embodiment 3 is different from Embodiment 1 in the data structure of the library, the library is referred to as a library 307 in Embodiment 3.

Further, since Embodiment 3 is different from Embodiment 1 in the data structure of the net list, the net lists of Embodiment 3 are referred to as an original net list 301 and a new net list 311.

With respect to the other functional blocks that are common with Embodiment 1, the reference signs used in Embodiment 1 are attached thereto and description thereof is omitted.

3.2 Data

In the following, the data structure of the library 307 stored in the storage unit 106 and the data structure of the net list will be described.

3.2.1 Library 307

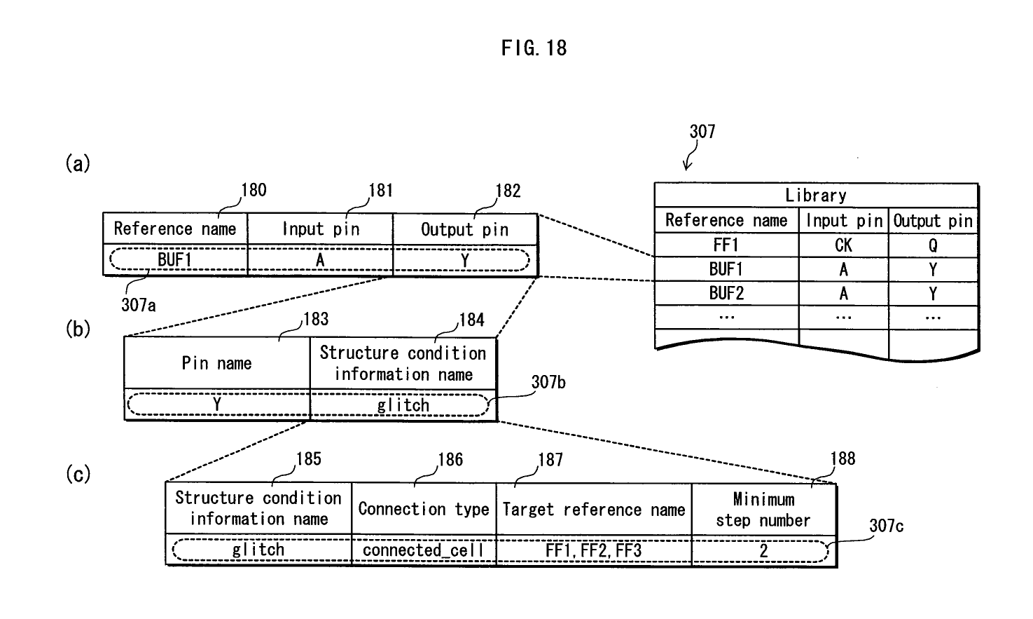

FIG. 18 shows the data structure of one cell contained in the library 307.

3.2.1.1 Data Structure of Library

As shown in (a) of FIG. 18, one piece of record 307a of the library 307 includes a reference name 180, an input pin 181, and an output pin 182. Description of the reference name 180, the input pin 181, and the output pin 182 is omitted here since they indicate a reference name and the like in the same manner as the reference name 30, the input pin 31, and the output pin 32 in Embodiment 1.

3.2.1.2 Data Structure of Pin

In (b) of FIG. 18, the data structure of pin is shown.

One piece of record 307b constituting the data of pin includes a pin name 183 and a structure condition information name 184.

Description of the pin name 183 and structure condition information name 184 is omitted here since they have the same structure as the pin name 33 and the structure condition information name 34 shown in FIG. 3.

In Embodiment 3, the structure condition information name 184 specifies “glitch”. The “glitch” is a reference name of a net attribute that specifies a glitch occurrence net.

3.2.1.3 Data Structure of Structure Condition Information

In (c) of FIG. 18, the data structure of the structure condition information is shown. One piece of record 307c constituting data of the structure condition information includes a structure condition information name 185, a connection type 186, a target reference name 187, and a minimum step number 188. Especially, the structure differs from Embodiment 1 in that it includes the minimum step number 188.

Description of the structure condition information name 185, connection type 186, and target reference name 187 is omitted since they are the same as the structure condition information name 35, connection type 36, and target reference name 37 shown in FIG. 3, respectively.

In Embodiment 3, the structure condition information name 185 specifies “glitch”, and the target reference name 187 specifies “FF1”, “FF2”, “FF3”. This indicates that a buffer should be inserted between “BUF1” shown in the reference name 180 and each of “FF1”, “FF2” and “FF3”, that are the targets.

The minimum step number 188 specifies a restriction regarding the minimum number of steps of buffers to be inserted between the references being targets to which the structure condition information is applied. The (c) of FIG. 18 shows that the minimum step number 188 is set to “2”. This indicates that 2 or more steps of buffers should be inserted between “BUF1” shown in the reference name 180 and each of “FF1”, “FF2” and “FF3” shown in the target reference name 187.

The data type of the minimum step number 188 is numeral.

3.2.2 Data Structure of Net List

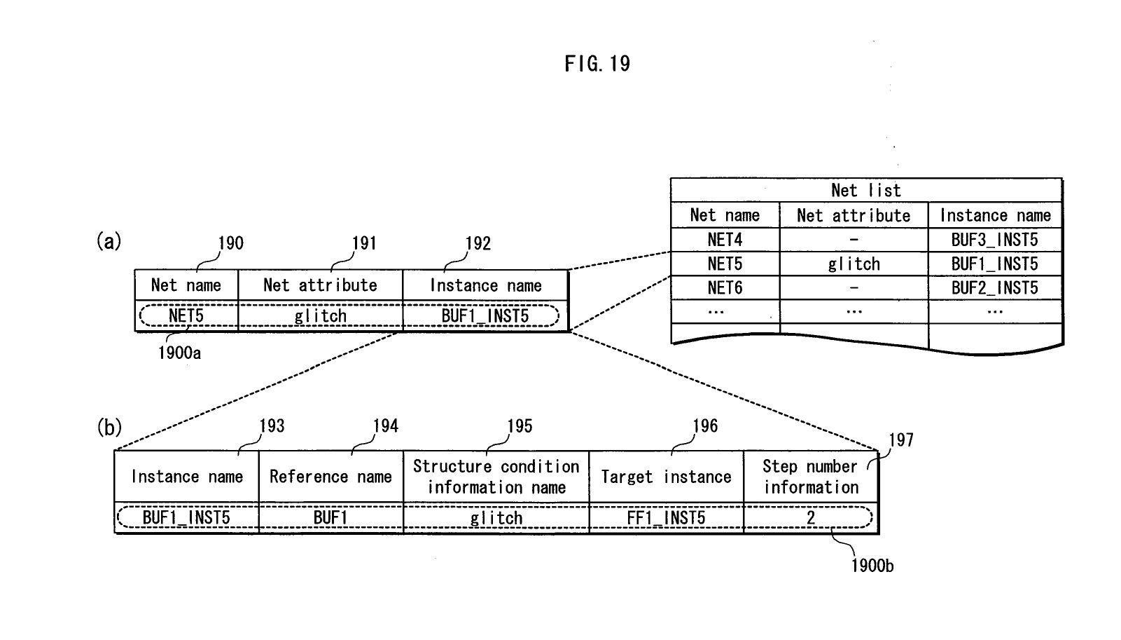

FIG. 19 shows the data structure of one net in the net list of Embodiment 3.

3.2.2.1 Data Structure of Net

The (a) of FIG. 19 shows the data structure of one net in the net list.

As shown in (a) of FIG. 9, one piece of record 1900a of the net includes a net name 190, a net attribute 191, and an instance name 192.

Description of the net name 190, net attribute 191, and instance name 192 is omitted since they are the same as the net name 40, net attribute 41, and instance name 42 shown in FIG. 4.

In Embodiment 3, the net attribute 191 specifies “glitch”, which indicates that net attribute “glitch” is attached to the net.

3.2.2.2 Data Structure of Instance

The (b) of FIG. 19 shows the data structure of an instance of the net.

As shown in (b) of FIG. 19, one piece of record 1900b of the instance includes an instance name 193, a reference name 194, a structure condition information name 195, a target instance 196, and step number information 197. Especially, Embodiment 3 differs from Embodiment 1 in that it includes the step number information 197. Description of the instance name 193, reference name 194, structure condition information name 195, and target instance 196 is omitted since they are the same as the instance name 43, reference name 44, structure condition information name 45, and target instance 46 shown in (b) of FIG. 4.

The step number information 197 specifies the number of steps of buffers inserted between the instance name 193 and the target instance 196. In FIG. 19, the step number information 197 specifies “2”, which indicates that two buffers are inserted there between.

3.3 Details of Net List Generation Process

Next, the step S205 in Embodiment 3 will be described in detail.

In Embodiment 3, the net having a predetermined property is a glitch occurrence net. Also, in step S202 shown in FIG. 2, the analyzing unit 104 analyzes the net by specifying the height of glitch of the glitch occurrence net to be selected, and in step S203, selects a net that was extracted as a result of the analysis. Further, in Embodiment 3, the attribute attaching unit 105 attaches net attribute “glitch” to the selected net, in step S204.

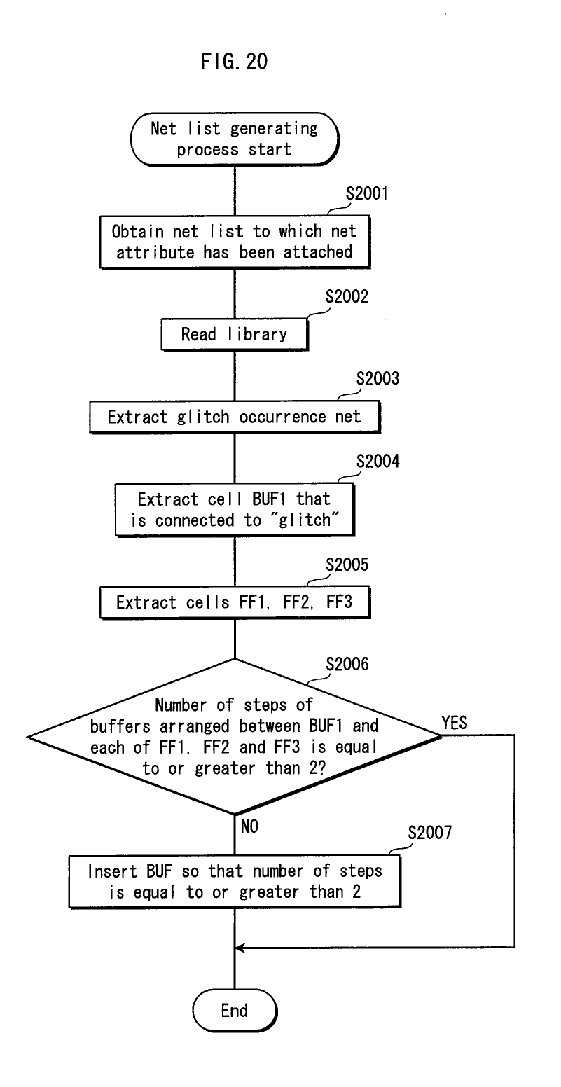

FIG. 20 is a flowchart showing the details of the process of step S205 in Embodiment 3.

As shown in FIG. 20, the net list generating unit 109 obtains the original net list 301 which was output from the attribute attaching unit 105 and to which the net attribute has been attached (step S2001).

The net list generating unit 109 then reads the library 307 from the storage unit 106 (step S2002).

The net list generating unit 109 extracts, from the original net list 301, a net in which net attribute “glitch” has been attached to the net attribute 191 (step S2003).

Next, the net list generating unit 109 refers to the read library 307 and extracts a cell for which the structure condition information name 184 specifies “glitch”. In the present embodiment, the net list generating unit 109 extracts a buffer with reference name “BUF1”. The net list generating unit 109 then extracts a cell that is connected to the net having the net attribute “glitch” and has a reference name “BUF1” (step S2004).

Also, the net list generating unit 109 extracts cells that are connected to the net having the net attribute “glitch” and have reference names “FF1”, “FF2”, and “FF3” (step S2005).

The net list generating unit 109 judges whether the number of steps of buffers arranged between “BUF1” and each of “FF1”, “FF2” and “FF3” is equal to or greater than a value specified by the minimum step number 188 of the library of “BUF1”. That is to say, the net list generating unit 109 judges whether the number of steps of buffers is equal to or greater than “2” (step S2006)

When it is judged in step S2006 that the number of steps of buffers arranged between “BUF1” and each of “FF1”, “FF2” and “FF3” is equal to or greater than the value specified by the minimum step number 188 of the library of “BUF1”, the process is ended. That is to say, in the present embodiment, when the number of steps is no smaller than “2”, the process is ended (YES in step S2006).

When it is judged in step S2006 that the number of steps of buffers is not equal to or greater than the value specified by the minimum step number 188 of the library of “BUF1”, namely, in the present embodiment, when the number of steps is smaller than “2” (NO in step S2006), the net list generating unit 109 inserts buffers so that the number of steps of buffers between “BUF1” and each of “FF1”, “FF2” and “FF3” is equal to or greater than the value specified by the minimum step number 188 of the library of “BUF1”. In the present embodiment, the net list generating unit 109 inserts buffers so that the number of steps of buffers is equal to or greater than “2” (step S2007).

3.4 Transition of Net Structure

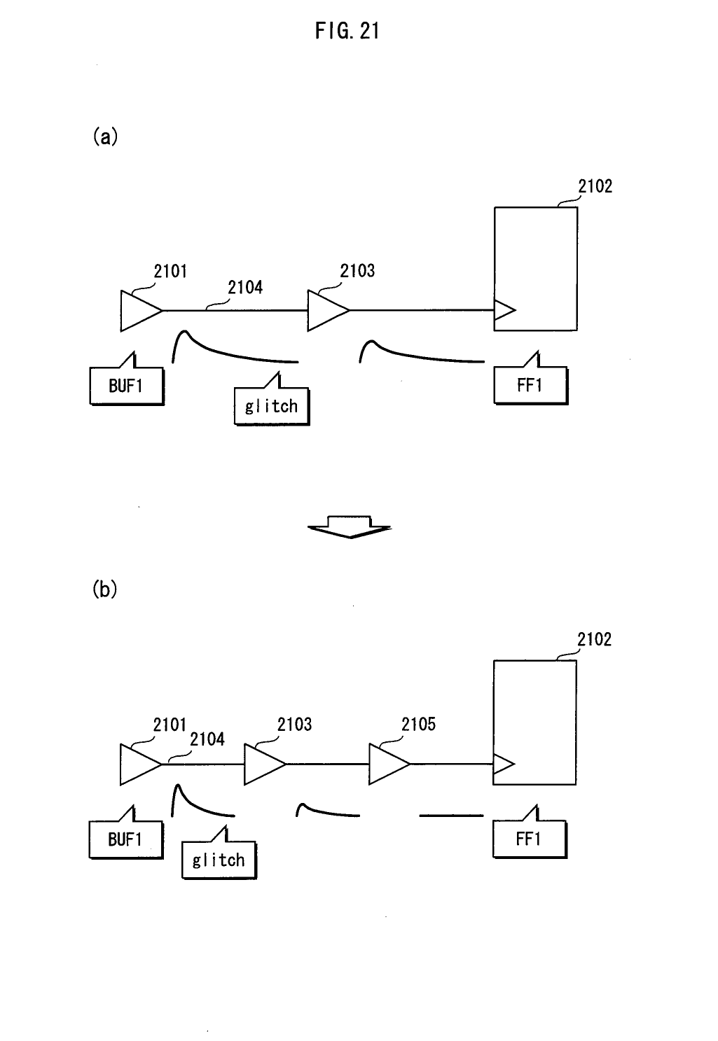

FIG. 21 shows a transition of the net structure.

The (a) of FIG. 21 shows the structure of part of nets in the original net list 301.

As shown in (a) of FIG. 21, the original net list 301 includes a buffer 2101, a flip flop 2102, a buffer 2103, and a glitch occurrence net 2104, as the structure of part of nets in the original net list 301. The buffer 2101 has a reference name “BUF1”, and the flip flop 2102 has a reference name “FF1”.

The logic circuit synthesis device 1 performs the processes of steps S202, S203 and S204 to attach the net attribute “glitch” to the glitch occurrence net 2104 among the nets specified by the original net list 301. And the logic circuit synthesis device 1 generates the new net list 311 by performing step S205, which is detailed as steps S2001 through S2007.

The (b) of FIG. 21 shows the structure of part of nets in the new net list 311.

The (b) of FIG. 21 shows, as the structure of the nets in the new net list 311, the buffer 2101, flip flop 2102, buffer 2103, glitch occurrence net 2104, and a buffer 2105. As shown in (b) of FIG. 21, two steps of buffers are arranged between the buffer 2101 having the reference name of “BUF1” and the flip flop 2102 having the reference name of “FF1”.

Accordingly, the structure of the net satisfies the condition specified by the minimum step number 188 in the library 307.

3.5 Update of Net List

Here will be described how the data held by the net list is updated, while the logic circuit synthesis device 1 of Embodiment 3 performs a process.

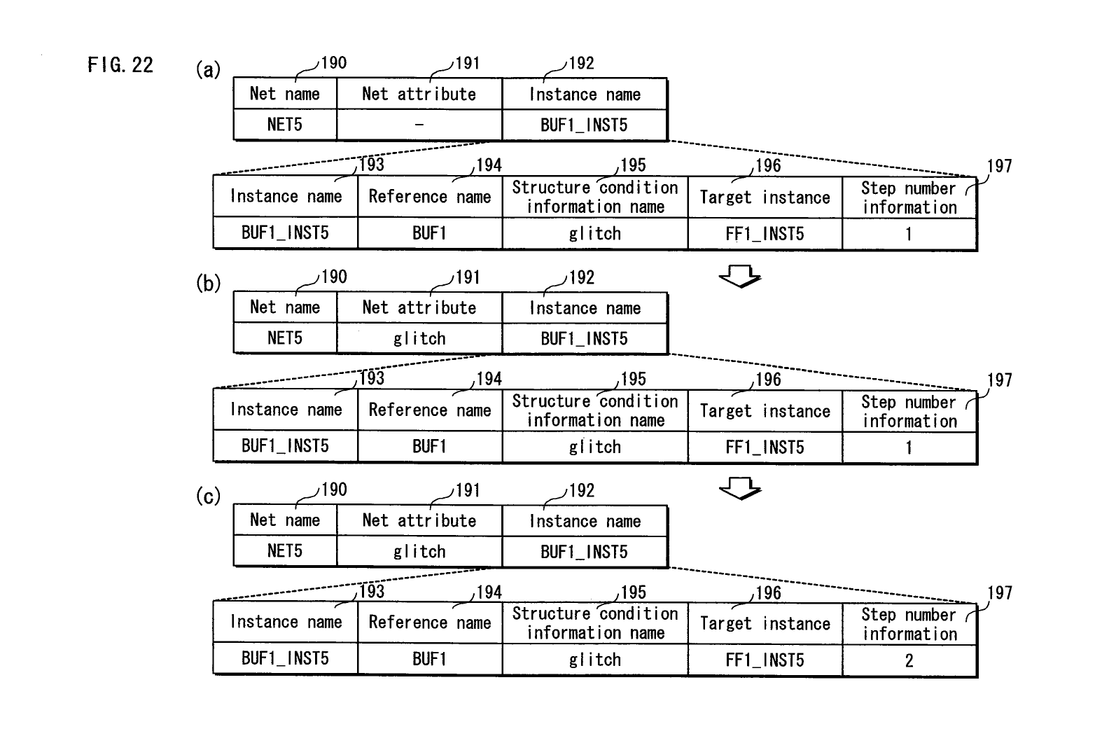

FIG. 22 shows the net list update process.

The (a) of FIG. 22 shows the original net list 301 in the state immediately after it is obtained by the obtaining unit 102 in step S201. In the original net list 301 in this state, the net attribute has not been attached yet. Also, the step number information 197 specifies “1” as the number of steps of buffers.

The (b) of FIG. 22 shows the original net list 301 in the state immediately after step S204 in which the attribute attaching unit 105 attaches the net attribute “glitch” to the net, and the original net list 301 in this state is to be input to the net list generating unit 109 in step S205. The net attribute “glitch” has been attached to the net attribute 191.

The (c) of FIG. 22 shows the new net list 311 generated by the net list generating unit 109. It shows the net structure including the instance data structure where the number of steps of buffers arranged between buffer “BUF1” and flip flop “FF1” has been set to be “2” by applying the structure condition information.

### Embodiment 4

4.1 Outline

In the following, another embodiment of the logic circuit synthesis device of the present invention will be described.

In Embodiment 4, the logic circuit synthesis device 1 selects, as a net having a predetermined property, a high frequency net through which a high frequency signal passes.

What is called pulse reject, in which a pulse disappears, may occur when a high frequency pulse enters into, for example, a cell having a great delay value. It is possible to prevent the pulse reject by replacing a cell, in which the pulse reject has occurred, with a cell which can connect to a high frequency net. In Embodiment 4, it is presumed that the library stores a cell that can connect to a net of up to 300 MHz of frequency, and a cell that can connect to a net of up to 600 MHz of frequency.

Also, since Embodiment 4 is different from Embodiment 1 in the data structure of the library, the library is referred to as a library 407 in Embodiment 4.

Further, since Embodiment 4 is different from Embodiment 1 in the data structure of the net list, the net lists of Embodiment 4 are referred to as an original net list 401 and a new net list 411.

With respect to the other functional blocks that are common with Embodiment 1, the reference signs used in Embodiment 1 are attached thereto and description thereof is omitted.

4.2 Data

In the following, the data structure of the library 407 stored in the storage unit 106 and the data structure of the net list will be described.

4.2.1 Library 407

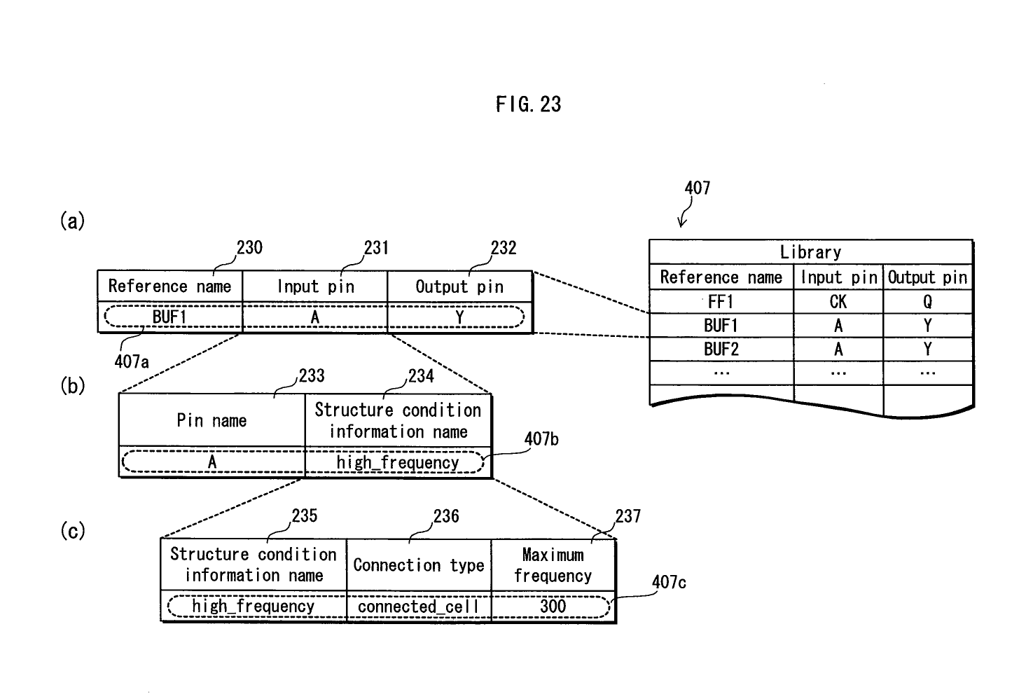

FIG. 23 shows the data structure of one cell contained in the library 407.

4.2.1.1 Data Structure of Library

As shown in (a) of FIG. 23, one piece of record 407a of the library 407 includes a reference name 230, an input pin 231, and an output pin 232. Description of the reference name 230, the input pin 231, and the output pin 232 is omitted here since they indicate a reference name and the like in the same manner as the reference name 30, the input pin 31, and the output pin 32 in Embodiment 1.

4.2.1.2 Data Structure of Pin

In (b) of FIG. 23, the data structure of pin is shown.

One piece of record 407b constituting the data of pin includes a pin name 233 and a structure condition information name 234.

Description of the pin name 233 and structure condition information name 234 is omitted here since they are the same as the pin name 33 and the structure condition information name 34 shown in FIG. 3.

In Embodiment 4, the structure condition information name 234 specifies “high_frequency”. The “high_frequency” is a reference name of a net attribute that specifies a high frequency net.

4.2.1.3 Data Structure of Structure Condition Information

In (c) of FIG. 23, the data structure of the structure condition information is shown. One piece of record 407c constituting data of the structure condition information includes a structure condition information name 235, a connection type 236, and a maximum frequency 237. Especially, the structure differs from Embodiment 1 in that it includes the maximum frequency 237.

Description of the structure condition information name 235 and connection type 236 is omitted since they are the same as the structure condition information name 35 and connection type 36 shown in FIG. 3, respectively. In Embodiment 4, the structure condition information name 235 specifies “high_frequency”.

The 237 specifies the maximum frequency (in unit of MHz) of the net to which the cell specified by the reference name 230 is permitted to be connected. In (c) of FIG. 23, the maximum frequency 237 specifies “300” indicating that “BUF1” specified by the reference name 230 is permitted to be connected to a net having the maximum frequency of 300 MHz. Further, although not illustrated, the library 407 stores a library concerning reference name “BUF2”, and the maximum frequency 237 for “BUF2” specifies “600”. Namely, it is presumed that a buffer with reference name “BUF2” is permitted to be connected to a net having the maximum frequency of 600 MHz.

The data type of the maximum frequency 237 is numeral.

4.2.2 Data Structure of Net List

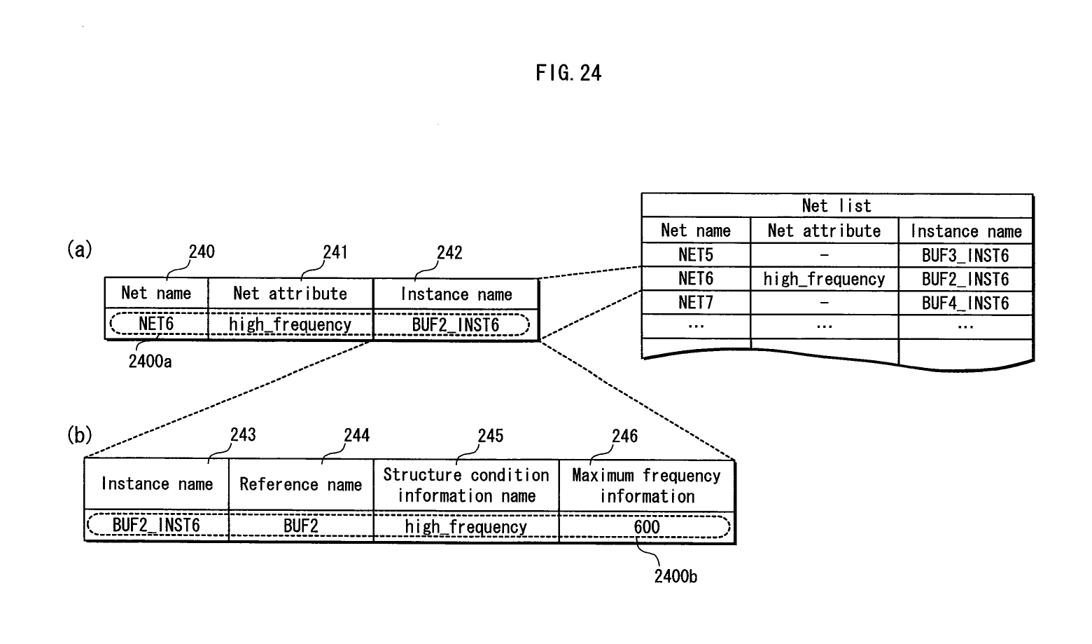

FIG. 24 shows the data structure of one net in the net list of Embodiment 4.

4.2.2.1 Data Structure of Net

The (a) of FIG. 24 shows the data structure of one net in the net list.

As shown in (a) of FIG. 24, one piece of record 2400a of the net includes a net name 240, a net attribute 241, and an instance name 242.

Description of the net name 240, net attribute 241, and instance name 242 is omitted since they are the same as the net name 40, net attribute 41, and instance name 42 shown in FIG. 4.

In Embodiment 4, the net attribute 241 specifies “high_frequency”, which indicates that net attribute “high_frequency” is attached to the net.

4.2.2.2 Data Structure of Instance

The (b) of FIG. 24 shows the data structure of an instance of the net.

As shown in (b) of FIG. 24, one piece of record 2400b of the instance includes an instance name 243, a reference name 244, a structure condition information name 245, and maximum frequency information 246. Especially, the structure differs from Embodiment 1 in that it includes the maximum frequency information 246. Description of the instance name 243, reference name 244, and structure condition information name 245 is omitted since they are the same as the instance name 43, reference name 44, and structure condition information name 45 shown in (b) of FIG. 4.

The maximum frequency information 246 specifies a restriction regarding the maximum frequency of the net to which an instance specified by the instance name 243 is permitted to be connected. In FIG. 24, the maximum frequency information 246 specifies “600”, which indicates that an instance having instance name “BUF2_INST6” is permitted to be connected to a net having the maximum frequency of 600 MHz.

4.3 Details of Net List Generation Process

Next, the step S205 in Embodiment 4 will be described in detail.

In Embodiment 4, the net having a predetermined property is a high frequency net. Also, in step S202 shown in FIG. 2, the analyzing unit 104 analyzes the nets by specifying the lower limit of the frequency, and extracts a net having a frequency higher than the specified lower limit value. In step S203, a net that was extracted as a result of the analysis is selected. Further, in Embodiment 4, the attribute attaching unit 105 attaches net attribute “high_frequency” to the selected net, in step S204. The net selecting unit 103 notifies the net list generating unit 109 of the frequency value specified by the analyzing unit 104 in the analysis. It should be noted here that the frequency value may be held, and the net list generating unit 109 may read the held value.

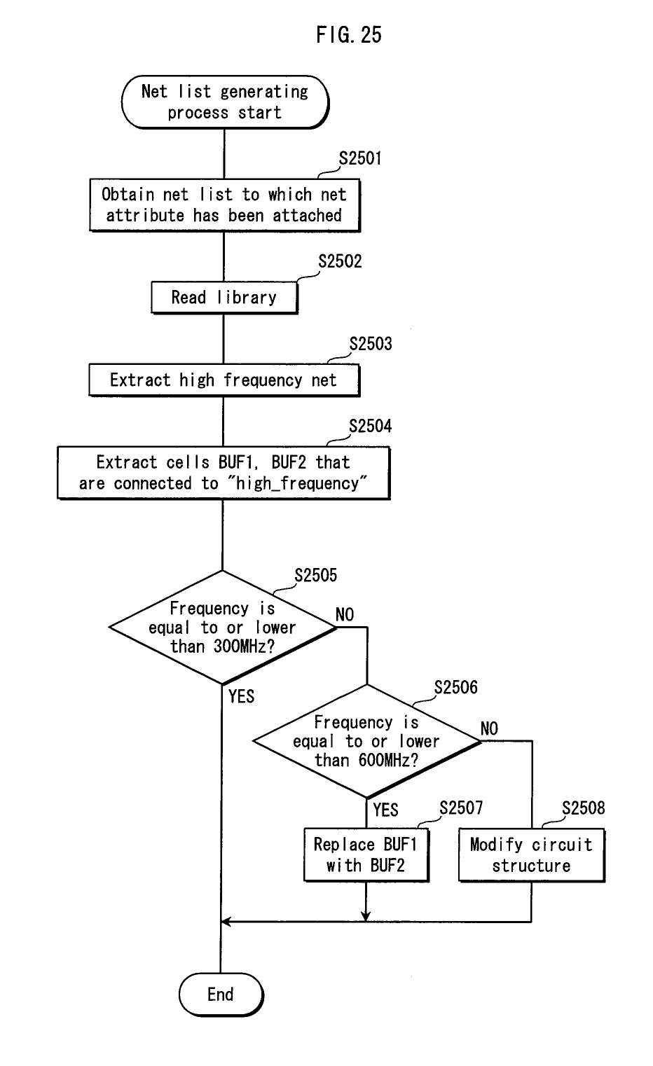

FIG. 25 is a flowchart showing the details of the process of step S205 in Embodiment 4.

As shown in FIG. 25, the net list generating unit 109 obtains the original net list 401 which was output from the attribute attaching unit 105 and to which the net attribute has been attached (step S2501).

The net list generating unit 109 then reads the library 407 from the storage unit 106 (step S2502).

The net list generating unit 109 extracts, from the original net list 401, a net in which net attribute “high_frequency” has been attached to the net attribute 241 (step S2503).

Next, the net list generating unit 109 extracts cells that are connected to the net having the net attribute “high_frequency” and have reference names “BUF1” and “BUF2” (step S2504).

The net list generating unit 109 judges whether the frequency value specified by the analyzing unit 104 in the analysis is equal to or lower than 300 MHz (step S2505).

When it is judged in step S2505 that the frequency value is equal to or lower than 300 MHz (YES in step S2505), the process in ended.

When it is judged in step S2505 that the frequency value is higher than 300 MHz (NO in step S2505), the net list generating unit 109 judges whether the frequency value specified by the analyzing unit 104 in the analysis is equal to or lower than 600 MHz (step S2506).

When it is judged in step S2506 that the frequency value is equal to or lower than 600 MHz (YES in step S2506), the net list generating unit 109 replaces “BUF1” with “BUF2” (step S2507).

When it is judged in step S2506 that the frequency value is higher than 600 MHz (NO in step S2506), the structure of the logic circuits is modified, and the logic circuits after the modification are synthesized (step S2508).

In the present embodiment, the nets, to which buffers “BUF1” and “BUF2” are permitted to be connected, have the maximum frequencies of 300 MHz and 600 MHz, respectively. Thus explanation is given for each case where the frequency value specified by the analyzing unit 104 in the analysis is 300 MHz or 600 MHz. It should be noted here however that the frequency value specified by the analyzing unit 104 in the analysis is not limited to these values, but that it is preferable that the frequency value is determined flexibly depending on the frequency with which the cell is connectable.

4.4 Transition of Net Structure

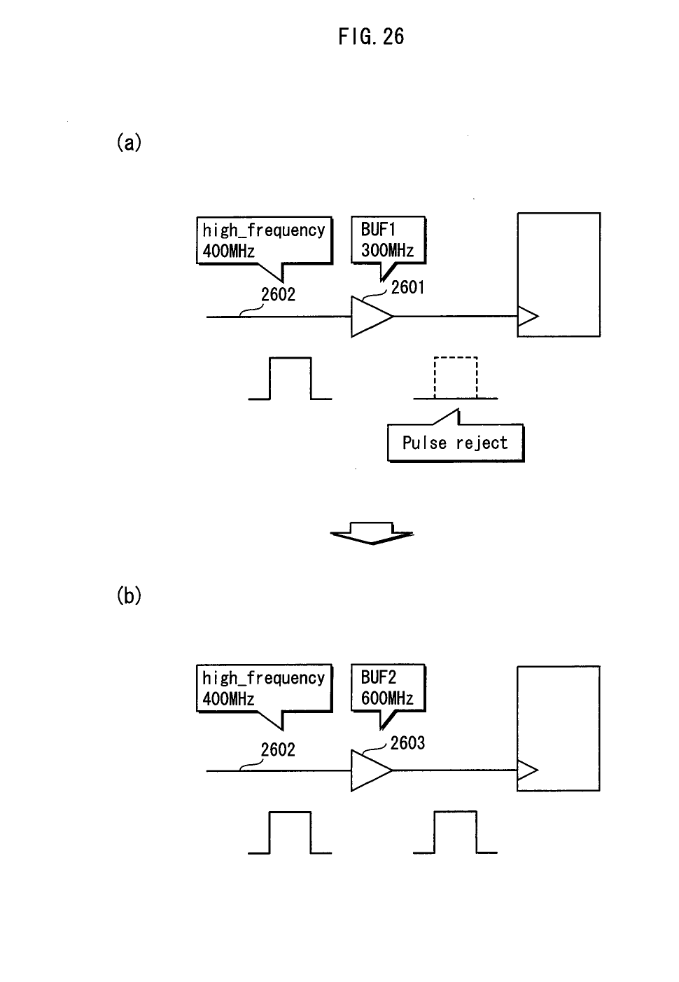

FIG. 26 shows a transition of the net structure.

The (a) of FIG. 26 shows the structure of part of nets in the original net list 401.

As shown in (a) of FIG. 26, the original net list 401 includes a buffer 2601 and a high frequency net 2602 as the structure of part of nets in the original net list 401. It is presumed here that the buffer 2601 has a reference name “BUF1”, 400 MHz of frequency passes through the high frequency net 2602, and the frequency value specified by the analyzing unit is 400 MHz.

The logic circuit synthesis device 1 performs the processes of steps S202, S203 and S204 to attach the net attribute “high_frequency” to the high frequency net 2602 among the nets specified by the original net list 401. And the logic circuit synthesis device 1 generates the new net list 411 by performing step S205, which is detailed as steps S2501 through S2508.

The (b) of FIG. 26 shows the structure of part of nets in the new net list 411.

The (b) of FIG. 26 shows, as the structure of the nets in the new net list 411, the buffer 2603 and high frequency net 2602. Here, the buffer 2603 has a reference name “BUF2” and can be connected to a net having frequency of up to 600 MHz (maximum frequency of 600 MHz).

Accordingly, the structure of the net satisfies the condition specified by the maximum frequency 237 in the library 407.

4.5 Update of Net List

Here will be described how the data held by the net list is updated, while the logic circuit synthesis device 1 of Embodiment 4 performs a process.

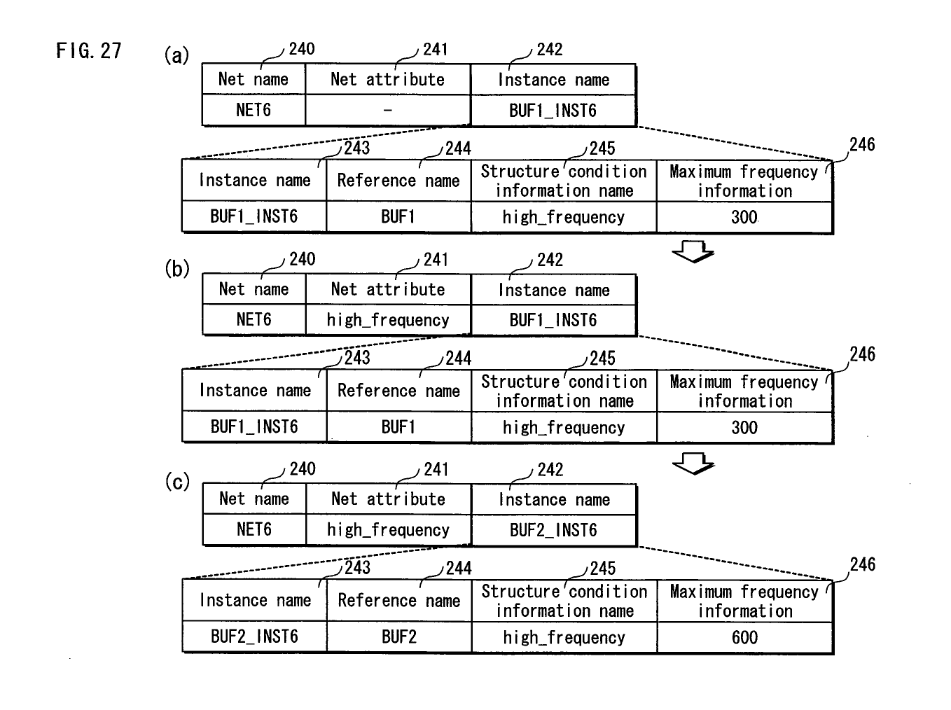

FIG. 27 shows the net list update process.

The (a) of FIG. 27 shows the original net list 401 in the state immediately after it is obtained by the obtaining unit 102 in step S201. In the original net list 401 in this state, the net attribute has not been attached yet. Also, the maximum frequency information 246 specifies “300”.

The (b) of FIG. 27 shows the original net list 401 in the state immediately after step S204 in which the attribute attaching unit 105 attaches the net attribute “high_frequency” to the net, and the original net list 401 in this state is to be input to the net list generating unit 109 in step S205. The net attribute “high_frequency” has been attached to the net attribute 241.

The (c) of FIG. 27 shows the new net list 411 generated by the net list generating unit 109. It shows the net structure including the instance data structure where the buffer “BUF1” has been replaced with buffer “BUF2” by applying the structure condition information.

### Embodiment 5

5.1 Outline

In the following, another embodiment of the logic circuit synthesis device of the present invention will be described.

In Embodiment 5, the logic circuit synthesis device 1 selects, as a net having a predetermined property, a bus signal net through which a bus signal passes.

In the bus signal net through which a bus signal passes, a reflection wave, which has a bad influence on a signal, may occur. This problem can be prevented by connecting a terminating resistor to the net through which the bus signal passes. This matches the impedance in the net through which the bus signal passes, and restricts the occurrence of the reflection wave.

Also, since Embodiment 5 is different from Embodiment 1 in the data structure of the library, the library is referred to as a library 507 in Embodiment 5.

Further, since Embodiment 5 is different from Embodiment 1 in the data structure of the net list, the net lists of Embodiment 5 are referred to as an original net list 501 and a new net list 511.

With respect to the other functional blocks that are common with Embodiment 1, the reference signs used in Embodiment 1 are attached thereto and description thereof is omitted.

5.2 Data

In the following, the data structure of the library 507 stored in the storage unit 106 and the data structure of the net list will be described.

5.2.1 Library 507

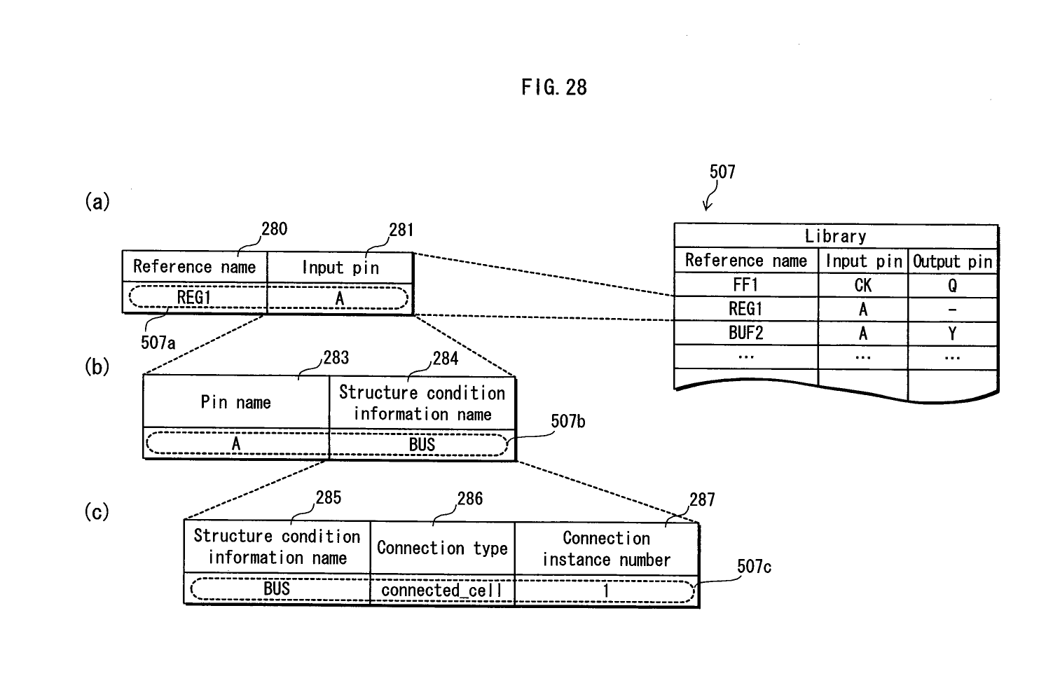

FIG. 28 shows the data structure of one cell contained in the library 507.

5.2.1.1 Data Structure of Library

As shown in (a) of FIG. 28, one piece of record 507a of the library 507 includes a reference name 280 and an input pin 281. Description of the reference name 280 and input pin 281 is omitted here since they indicate a reference name and the like in the same manner as the reference name 30 and the input pin 31 in Embodiment 1.

The reference name 280 specifies “REG1”, which indicates that it is a library concerning the terminating resistor.

5.2.1.2 Data Structure of Pin

In (b) of FIG. 28, the data structure of pin is shown. One piece of record 507b constituting the data of pin includes a pin name 283 and a structure condition information name 284.

Description of the pin name 283 and structure condition information name 284 is omitted here since they are the same as the pin name 33 and the structure condition information name 34 shown in FIG. 3.

In Embodiment 5, the structure condition information name 284 specifies “BUS”. The “BUS” is a reference name of a net attribute that specifies a bus signal net.

5.2.1.3 Data Structure of Structure Condition Information

In (c) of FIG. 28, the data structure of the structure condition information is shown. One piece of record 507c constituting data of the structure condition information includes a structure condition information name 285, a connection type 286, and a connection instance number 287. Especially, the structure differs from Embodiment 1 in that it includes the connection instance number 287.

Description of the structure condition information name 285 and connection type 286 is omitted since they are the same as the structure condition information name 35 and connection type 36 shown in FIG. 3, respectively. In Embodiment 5, the structure condition information name 285 specifies “BUS”.

The connection instance number 287 specifies the restriction on the number of connections when the cell specified by the reference name 280 connects to a net having net attribute “BUS” specified by the structure condition information name 285. In FIG. 28, the connection instance number 287 specifies “1”, which indicates that only one piece of resistor having reference name “REG1” is permitted to be connected to a net having net attribute “BUS”.

The data type of the connection instance number 287 is numeral.

5.2.2 Data Structure of Net List

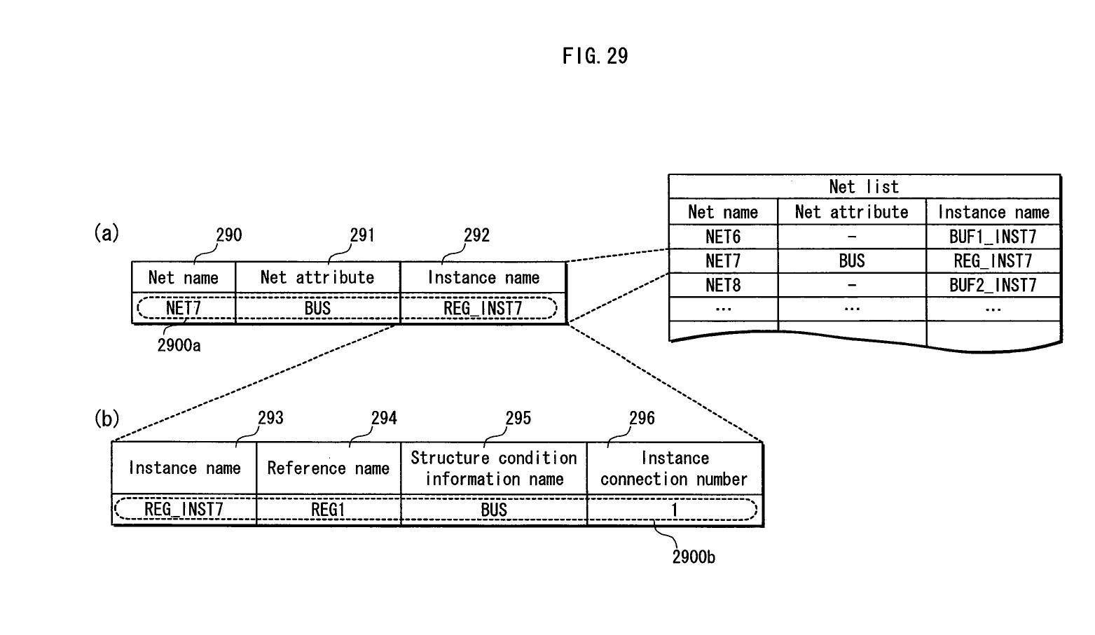

FIG. 29 shows the data structure of one net in the net list of Embodiment 5.

5.2.2.1 Data Structure of Net

The (a) of FIG. 29 shows the data structure of one net in the net list.

As shown in (a) of FIG. 29, one piece of record 2900a of the net includes a net name 290, a net attribute 291, and an instance name 292.

Description of the net name 290, net attribute 291, and instance name 292 is omitted since they are the same as the net name 40, net attribute 41, and instance name 42 shown in FIG. 4.

In Embodiment 5, the net attribute 291 specifies “BUS”, which indicates that net attribute “BUS” is attached to the net.

5.2.2.2 Data Structure of Instance

The (b) of FIG. 29 shows the data structure of an instance of the net.

As shown in (b) of FIG. 29, one piece of record 2900b of the instance includes an instance name 293, a reference name 294, a structure condition information name 295, and instance connection number 296. Especially, the structure differs from Embodiment 1 in that it includes the instance connection number 296. Description of the instance name 293, reference name 294, and structure condition information name 295 is omitted since they are the same as the instance name 43, reference name 44, and structure condition information name 45 shown in (b) of FIG. 4.

The instance connection number 296 specifies the number of connections of the instance specified by the instance name 293, to the net. In FIG. 29, the instance connection number 296 specifies “1”, which indicates that an instance having instance name “REG1_INST7” is connected to a net having net attribute “BUS”.

5.3 Details of Net List Generation Process

Next, the step S205 in Embodiment 5 will be described in detail.

In Embodiment 5, the net having a predetermined property is a bus signal net. Also, in step S202 shown in FIG. 2, the analyzing unit 104 analyzes the new net list 511 by specifying the bus signal, and extracts a net through which the specified bus signal passes. In step S203, a net that was extracted as a result of the analysis is selected. Further, in Embodiment 5, the attribute attaching unit 105 attaches net attribute “BUS” to the selected net, in step S204.

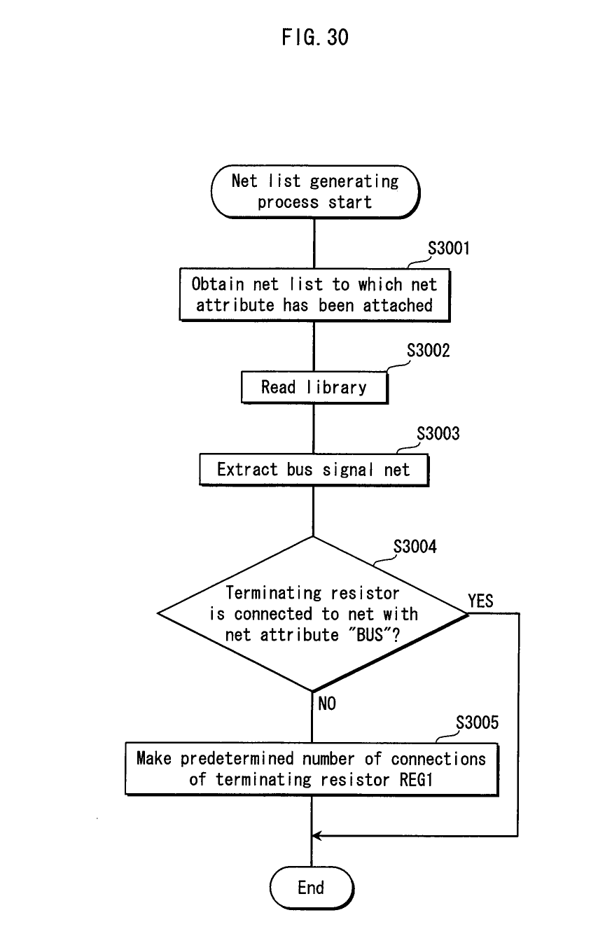

FIG. 30 is a flowchart showing the details of the process of step S205 in Embodiment 5.

As shown in FIG. 30, the net list generating unit 109 obtains the original net list 501 which was output from the attribute attaching unit 105 and to which the net attribute has been attached (step S3001).

The net list generating unit 109 then reads the library 507 from the storage unit 106 (step S3002).

The net list generating unit 109 extracts, from the original net list 501, a net in which net attribute “BUS” has been attached to the net attribute 291 (step S3003).

Next, the net list generating unit 109 judges whether a terminating resistor is connected to the net with the net attribute “BUS” (step S3004).

When it is judged in step S3004 that a terminating resistor is connected to the net with the net attribute “BUS” (YES in step S3004), the process is ended.

When it is judged in step S3004 that a terminating resistor is not connected to the net with the net attribute “BUS” (NO in step S3004), the net list generating unit 109 reads a cell, which is specified as “BUS” by the structure condition information name 284, from the library 507 read in step S3002. In Embodiment 5, the net list generating unit 109 reads a terminating resistor having a reference name “REG1”. And the net list generating unit 109 makes as many connections of the read terminating resistor “REG1” to the net with the net attribute “BUS”, as the number specified by the connection instance number 287 of the library of “REG1” (step S3005). In Embodiment 5, the net list generating unit 109 makes one connection of a terminating resistor having reference name “REG1” to the net with the net attribute “BUS”.

5.4 Transition of Net Structure

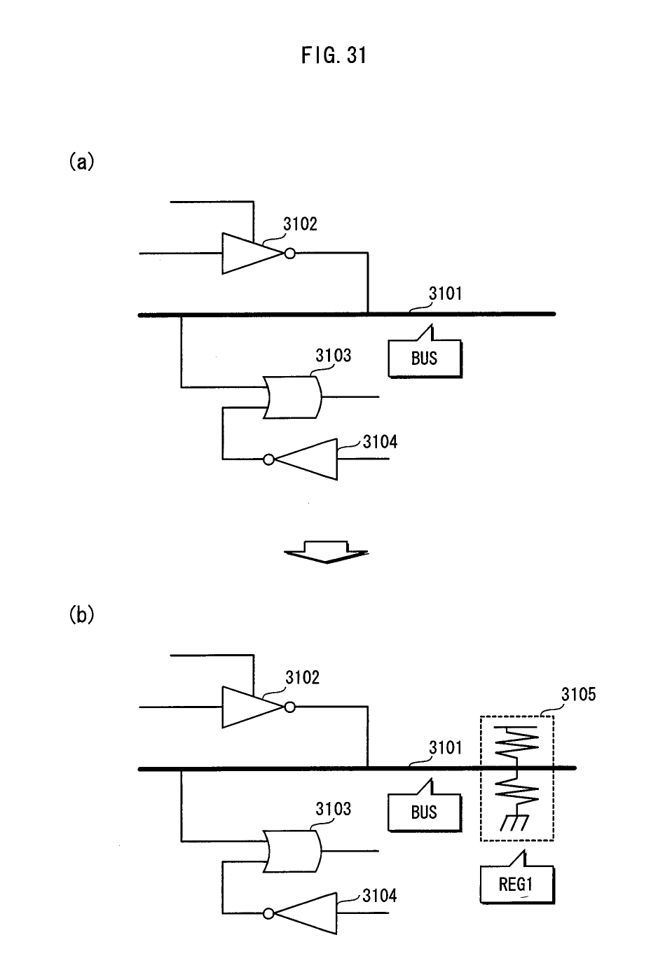

FIG. 31 shows a transition of the net structure.

The (a) of FIG. 31 shows the structure of part of nets in the original net list 501.

As shown in (a) of FIG. 31, the original net list 501 includes a bus signal net 3101 through which a bus signal passes, an inverter 3102, an “or” circuit 3103, and an inverter 3104 as the structure of part of nets in the original net list 501.

The logic circuit synthesis device 1 performs the processes of steps S202, S203 and S204 to attach the net attribute “BUS” to the bus signal net 3101 among the nets specified by the original net list 501. And the logic circuit synthesis device 1 generates the new net list 511 by performing step S205, which is detailed as steps S3001 through S3005.

The (b) of FIG. 31 shows the structure of part of nets in the new net list 511.

The (b) of FIG. 31 shows, as the structure of the nets in the new net list 511, a terminating resistor 3105 having a reference name “REG1”, in addition to the structural elements shown in (a) of FIG. 31, as the structure of part of nets in the new net list 511.

Accordingly, the structure of the net satisfies the condition specified by the connection instance number 287 in the library 507.

5.5 Update of Net List

Here will be described how the data held by the net list is updated, while the logic circuit synthesis device 1 of Embodiment 5 performs a process.

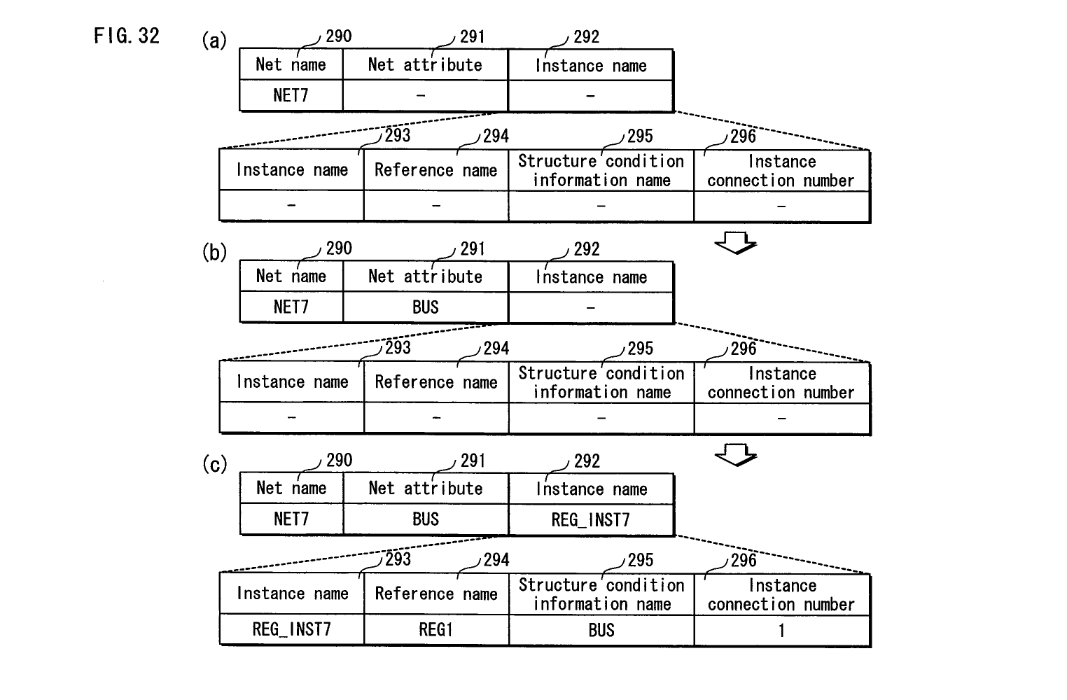

FIG. 32 shows the net list update process.

The (a) of FIG. 32 shows the original net list 501 in the state immediately after it is obtained by the obtaining unit 102 in step S201. In the original net list 501 in this state, the net attribute has not been attached yet. The (b) of FIG. 32 shows the original net list 501 in the state immediately after step S204 in which the attribute attaching unit 105 attaches the net attribute “BUS” to the net, and the original net list 501 in this state is to be input to the net list generating unit 109 in step S205. The net attribute “BUS” has been attached to the net attribute 291.

The (c) of FIG. 32 shows the new net list 511 generated by the net list generating unit 109. It shows the net structure including the instance data structure where one piece of terminating resistor “REG1” has been connected to the bus signal net by applying the structure condition information.

### Embodiment 6

6.1 Outline

In the following, another embodiment of the logic circuit synthesis device of the present invention will be described.

In Embodiment 6, the logic circuit synthesis device 1 selects, as a net having a predetermined property, a high toggle net being a bet having a predetermined toggle rate.

When the toggle rate is high, it indicates that the voltage change occurs with a high frequency in the net. When a voltage change occurs with a high frequency in a cell such as a flip flop that consumes a lot of power, a large amount of heat is emitted from the cell. As a result, when high power consumption cells are connected with a relatively short distance there between, a large amount of heat may be generated locally, and influence of noise due to the heat generated at the cells may increase. To prevent this problem, high power consumption cells may be arranged at separate positions. This makes it possible to prevent such a heat from being generated locally.

Also, since Embodiment 6 is different from Embodiment 1 in the data structure of the library, the library is referred to as a library 607 in Embodiment 6.

Further, since Embodiment 6 is different from Embodiment 1 in the data structure of the net list, the net lists of Embodiment 6 are referred to as an original net list 601 and a new net list 611.

With respect to the other functional blocks that are common with Embodiment 1, the reference signs used in Embodiment 1 are attached thereto and description thereof is omitted.

6.2 Data

In the following, the data structure of the library 607 stored in the storage unit 106 and the data structure of the net list will be described.

6.2.1 Library 607

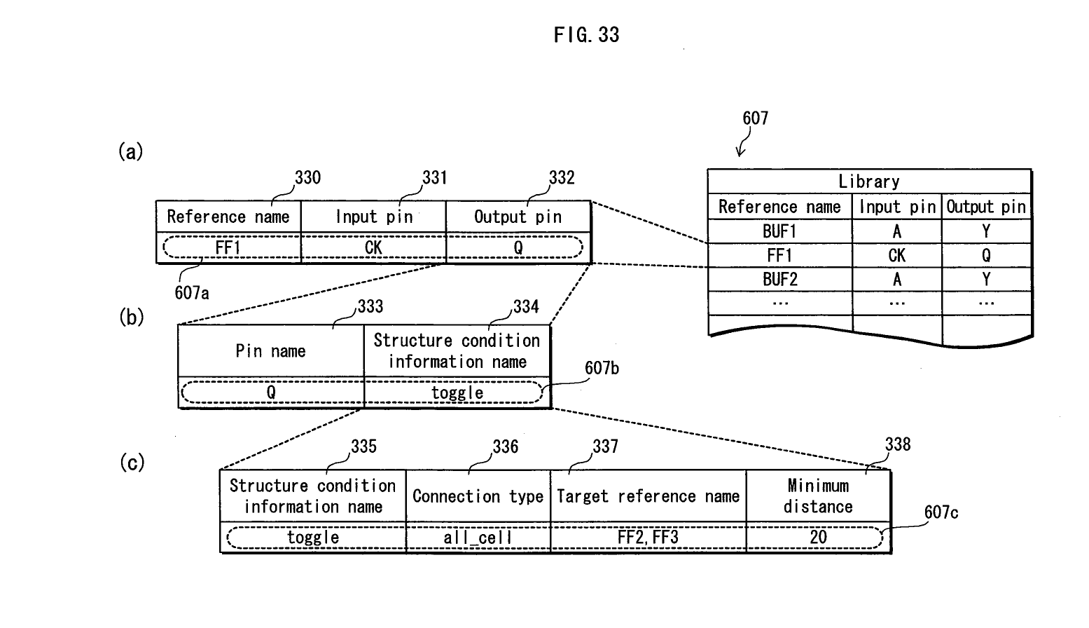

FIG. 33 shows the data structure of one cell contained in the library 607.

6.2.1.1 Data Structure of Library

As shown in (a) of FIG. 33, one piece of record 607a of the library 607 includes a reference name 330, an input pin 331, and an output pin 332. Description of the reference name 330, input pin 331, and output pin 332 is omitted here since they indicate a reference name and the like in the same manner as the reference name 30, the input pin 31, and the output pin 32 in Embodiment 1.

6.2.1.2 Data Structure of Pin

In (b) of FIG. 33, the data structure of pin is shown. One piece of record 607b constituting the data of pin includes a pin name 333 and a structure condition information name 334.

Description of the pin name 333 and structure condition information name 334 is omitted here since they are the same as the pin name 33 and the structure condition information name 34 shown in FIG. 3.

In Embodiment 6, the structure condition information name 334 specifies “toggle”. The “toggle” is a reference name of a net attribute that specifies a high toggle net.

6.2.1.3 Data Structure of Structure Condition Information

In (c) of FIG. 33, the data structure of the structure condition information is shown. One piece of record 607c constituting data of the structure condition information includes a structure condition information name 335, a connection type 336, a target reference name 337, and a minimum distance 338. Especially, the structure differs from Embodiment 1 in that it includes the minimum distance 338.

Description of the structure condition information name 335, connection type 336, and target reference name 337 is omitted since they are the same as the structure condition information name 35, connection type 36, and target reference name 37 shown in FIG. 3, respectively.

The minimum distance 338 specifies the minimum distance between a cell specified by the pin name 330 and a cell specified by the target reference name 337.

In Embodiment 6, the structure condition information name 335 specifies “toggle”, and the target reference name 337 specifies “FF2, FF3”. This indicates that the distance between “FF1”, which is specified by the pin name 330, and “FF2” and the distance between “FF1” and “FF3” should be equal to or greater than the distance specified by the minimum distance 338.

The data type of the minimum distance 338 is numeral.

6.2.2 Data Structure of Net List

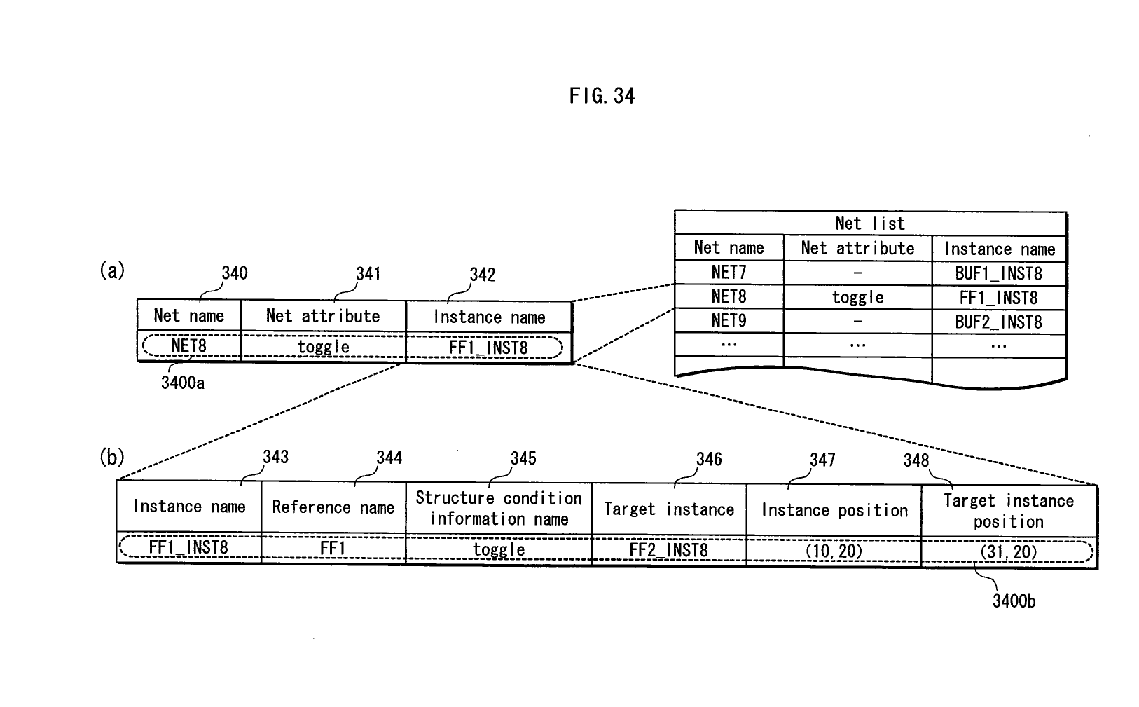

FIG. 34 shows the data structure of one net in the net list of Embodiment 6.

6.2.2.1 Data Structure of Net

The (a) of FIG. 34 shows the data structure of one net in the net list.

As shown in (a) of FIG. 34, one piece of record 3400a of the net includes a net name 340, a net attribute 341, and an instance name 342.

Description of the net name 340, net attribute 341, and instance name 342 is omitted since they are the same as the net name 40, net attribute 41, and instance name 42 shown in FIG. 4.

In Embodiment 6, the net attribute 341 specifies “toggle”, which indicates that net attribute “toggle” is attached to the net.

6.2.2.2 Data Structure of Instance

The (b) of FIG. 34 shows the data structure of an instance of the net.

As shown in (b) of FIG. 34, one piece of record 3400b of the instance includes an instance name 343, a reference name 344, a structure condition information name 345, a target instance 346, an instance position 347, and a target instance position 348. Description of the instance name 343, reference name 344, structure condition information name 345, target instance 346, instance position 347, and target instance position 348 is omitted since they are the same as the instance name 43, reference name 44, structure condition information name 45, target instance 46, instance position 47, and target instance position 48 shown in (b) of FIG. 4.

6.3 Details of Net List Generation Process

Next, the step S205 in Embodiment 6 will be described in detail.

In Embodiment 6, the net having a predetermined property is a high toggle net. Also, in step S202 shown in FIG. 2, the analyzing unit 104 analyzes nets by specifying a toggle rate, and extracts nets. In step S203, nets that were extracted as a result of the analysis are selected as high toggle nets. Further, in Embodiment 6, the attribute attaching unit 105 attaches net attribute “toggle” to the selected nets, in step S204.

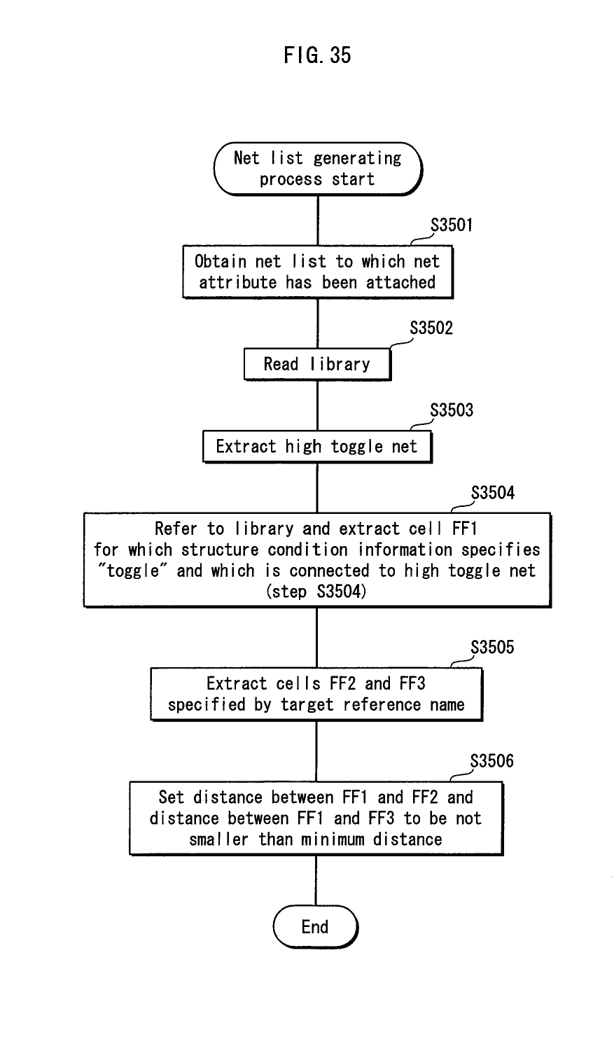

FIG. 35 is a flowchart showing the details of the process of step S205 in Embodiment 6.

As shown in FIG. 35, the net list generating unit 109 obtains the original net list 601 which was output from the attribute attaching unit 105 and to which the net attribute has been attached (step S3501).

The net list generating unit 109 then reads the library 607 from the storage unit 106 (step S3502).

The net list generating unit 109 extracts, from the original net list 601, nets in which net attribute “toggle” has been attached to the structure condition information name 341 (step S3503).

Next, the net list generating unit 109 refers to the library 607, and reads a cell for which the structure condition information name 334 specifies “toggle”, namely, reads a library of a flip flop having reference name “FF1”. The net list generating unit 109 extracts a cell that is connected to the net with net attribute “toggle”, and has reference name “FF1” (step S3504).

Further, the net list generating unit 109 refers to the target reference name 337 in the library of the cell having reference name “FF1”, and upon reading that the target reference name 337 specifies “FF2, FF3”, extracts the cells having reference names “FF2” and “FF3” from the original net list 601 (step S3505).

The net list generating unit 109, regarding the extracted cells “FF1”, “FF2” and “FF3” as the targets, sets the distance between “FF1” and “FF2” and the distance between “FF1” and “FF3” to be not smaller than the numeral specified by the minimum distance 338 of the library of “FF1”, namely sets the distances to be not smaller than “20”, respectively (step S3506).

6.4 Transition of Net Structure

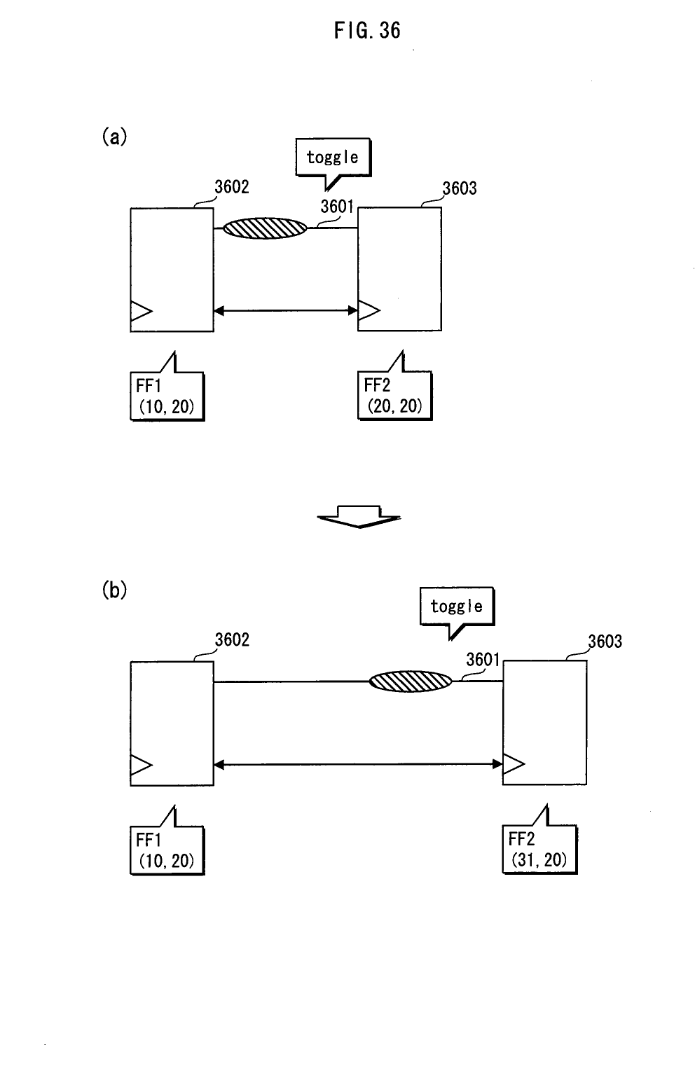

FIG. 36 shows a transition of the net structure.

The (a) of FIG. 36 shows the structure of part of nets in the original net list 601.

As shown in (a) of FIG. 36, the original net list 601 includes a high toggle net 3601, a flip flop 3602, and a flip flop 3603 as the structure of part of nets in the original net list 601. The flip flop 3602 has a reference name “FF1”, and the flip flop 3603 has a reference name “FF2”.

The logic circuit synthesis device 1 performs the processes of steps S202, S203 and S204 to attach the net attribute “toggle” to the high toggle net 3601 among the nets specified by the original net list 601. And the logic circuit synthesis device 1 generates the new net list 611 by performing step S205, which is detailed as steps S3501 through S3506.

The (b) of FIG. 36 shows the structure of part of nets in the new net list 611.

The (b) of FIG. 36 shows, as the structure of the nets in the new net list 611, the high toggle net 3601, flip flop 3602, and flip flop 3603, as the structure of part of nets in the new net list 611. As a result of the process performed by the net list generating unit 109, the distance between the flip flop 3602 and the flip flop 3603 is not smaller than 20.

Accordingly, the structure of the net satisfies the condition specified by the minimum distance 338 in the library 607.

6.5 Update of Net List

Here will be described how the data held by the net list is updated, while the logic circuit synthesis device 1 of Embodiment 6 performs a process.

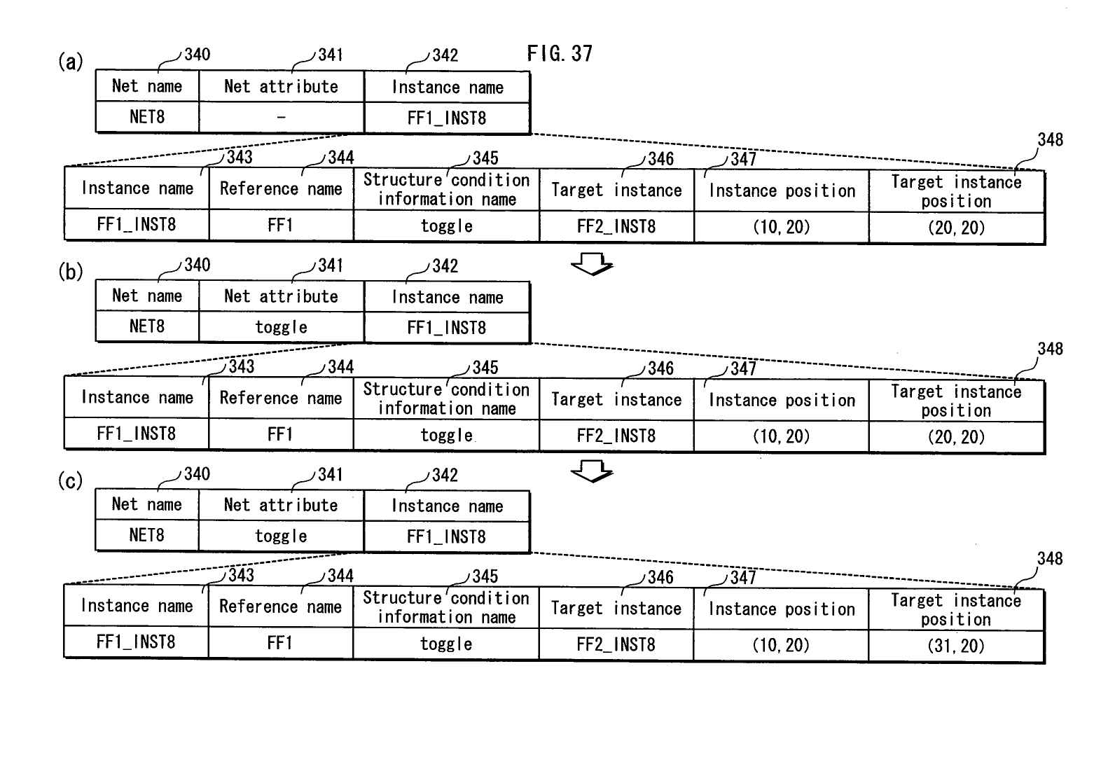

FIG. 37 shows the net list update process.

The (a) of FIG. 37 shows the original net list 601 in the state immediately after it is obtained by the obtaining unit 102 in step S201. In the original net list 601 in this state, the net attribute has not been attached yet. The (b) of FIG. 37 shows the original net list 601 in the state immediately after step S204 in which the attribute attaching unit 105 attaches the net attribute “toggle” to the net, and the original net list 601 in this state is to be input to the net list generating unit 109 in step S205. The net attribute “toggle” has been attached to the structure condition information name 341.

The (c) of FIG. 37 shows the new net list 611 generated by the net list generating unit 109. It shows the net structure including the instance data structure where the distance between instance “FF1_INST8” and instance “FF2_INST8” has been set to be not smaller than 20, by applying the structure condition information. Here, the instance “FF1_INST8” is a flip flop “FF1”, and the instance “FF2_INST8” is a flip flop “FF2”.

6.6 Modification 1 to Embodiment 6

In the Embodiment 6 described above, the distance between flip flops connecting to the high toggle net is set to be equal to or greater than a predetermined value, as one specific example. However, the logic synthesis may be performed by applying a restriction on power supply lines for supplying power to cells, instead of the restriction on the distance between cells. There a plurality of power supply lines. Lines to which a plus voltage is applied and lines to which a minus voltage is applied are arranged alternately and in parallel. Here, when a plurality of cells receive supply of power via a predetermined pair of plus voltage line and minus voltage line, it is said that the plurality of cells are on the same row. Conversely, when at least one of the plus voltage line and the minus voltage line is not in a same pair of lines to which the cells are connected, it is said that the plurality of cells are on different rows.

When power is supplied to a plurality of cells via the same row, enough power may not be supplied and an IR drop may occur.

The occurrence of IR drop can be reduced by adding a restriction on the arrangement of rows into the structure condition information to prevent cells with high power consumption from being arranged in the same row such that as many cells as possible receive power from different rows.

It should be noted here that in the following description of Modification 1 to Embodiment 6, a library stored in the storage unit 106 is referred to as a library 607-1. Also, a net list obtained by the obtaining unit 102 is referred to as an original net list 601-1, and a net list generated by the net list generating unit 109 is referred to as a new net list 611-1.

6.7 Data of Modification 1 to Embodiment 6

Here will be described the data structure of the library 607-1 stored in the storage unit 106 and the data structure of the net list.

6.7.1 Library 607-1

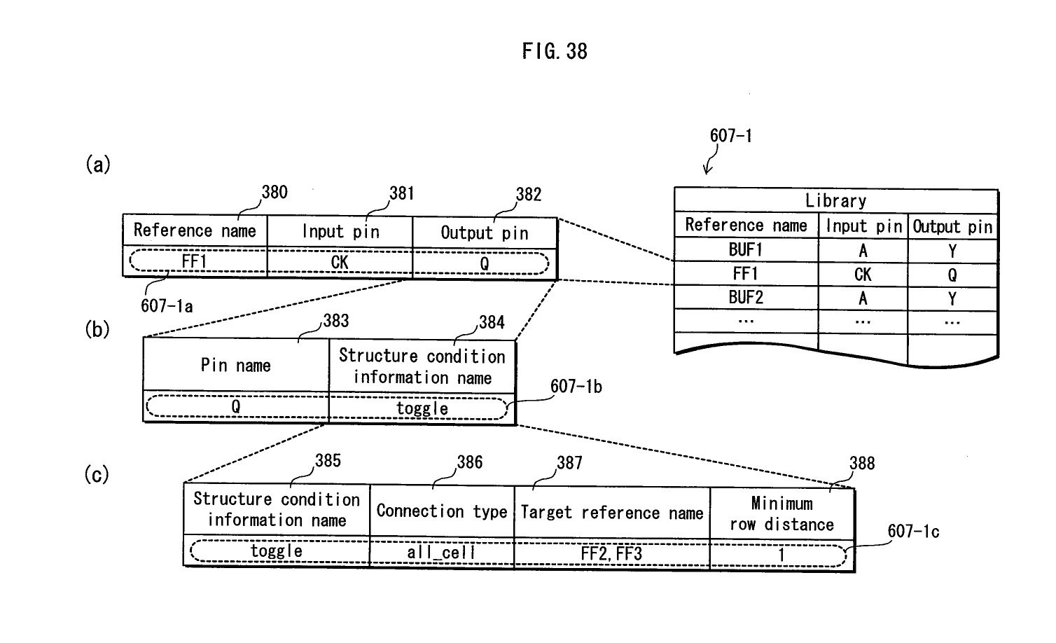

FIG. 38 shows the data structure of one cell contained in the library 607-1.

6.7.1.1 Data Structure of Library

As shown in (a) of FIG. 38, one piece of record 607-1a of the library 607-1 includes a reference name 380, an input pin 381, and an output pin 382. Description of the reference name 380, input pin 381, and output pin 382 is omitted since they indicate a reference name and the like in the same manner as the pin name 330, the pin name 331, and the pin name 332 shown in FIG. 33.

6.7.1.2 Data Structure of Pin

In (b) of FIG. 38, the data structure of pin is shown.

One piece of record 607-1b constituting the data of pin includes a pin name 383 and a structure condition information name 384.

Description of the pin name 383 and structure condition information name 384 is omitted here since they are the same as the pin name 333 and the structure condition information name 334 shown in FIG. 33.

6.7.1.3 Data Structure of Structure Condition Information

In (c) of FIG. 38, the data structure of the structure condition information is shown. One piece of record 607-1c constituting data of the structure condition information includes a structure condition information name 385, a connection type 386, a target reference name 387, and a minimum row distance 388. Modification 1 differs from Embodiment 6 in that it includes the minimum row distance 388.

Description of the structure condition information name 385, connection type 386, and target reference name 387 is omitted since they are the same as the structure condition information name 335, connection type 336, and target reference name 337 shown in FIG. 33, respectively.

The minimum row distance 388 specifies that a cell specified by the reference name 380 and a cell specified by the target reference name 387 should be arranged in rows that are separated from each other by the value specified by the minimum row distance 388. In the example shown in FIG. 38, the minimum row distance 388 specifies “1”. This indicates, for example, that “FF1” specified by the reference name 380 and “FF2” specified by the target reference name 387 should be arranged in rows that are separated from each other by one.

The data type of the minimum row distance 388 is an integer.

6.7.2 Data Structure of Net List

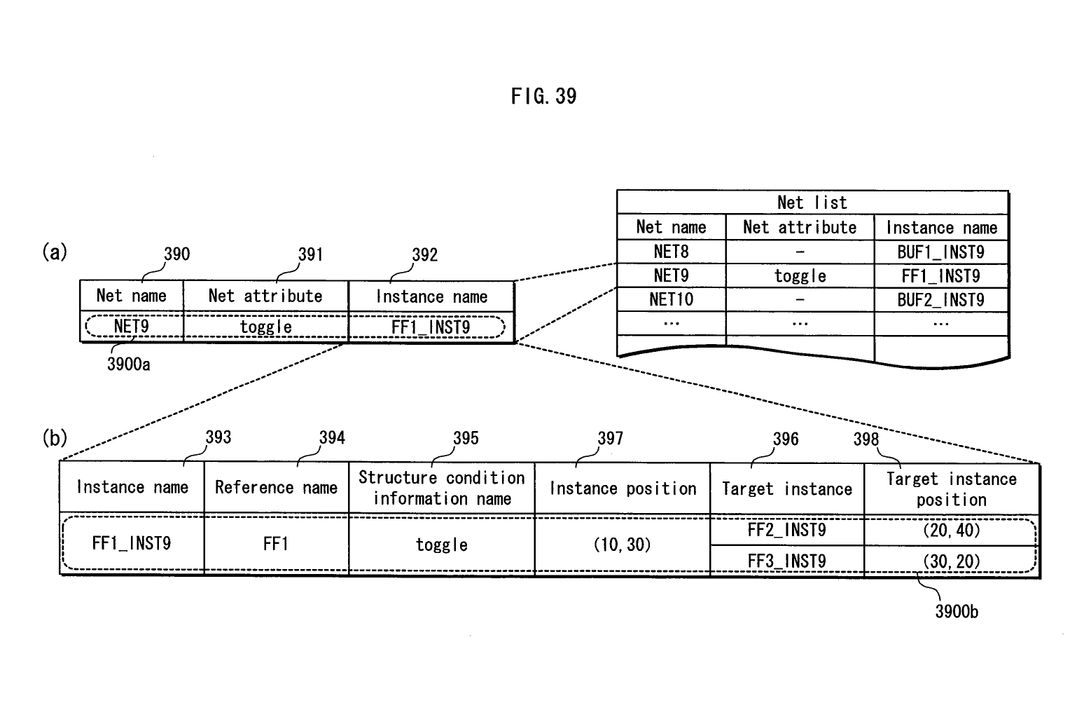

FIG. 39 shows the data structure of one net in the net list of Modification 1 to Embodiment 6.

6.7.2.1 Data Structure of Net

The (a) of FIG. 39 shows the data structure of one net in the net list.

As shown in (a) of FIG. 39, one piece of record 3900a of the net includes a net name 390, a net attribute 391, and an instance name 392.

Description of the net name 390, net attribute 391, and instance name 392 is omitted since they are the same as the net name 340, net attribute 341, and instance name 342 shown in FIG. 34.

6.7.2.2 Data Structure of Instance

The (b) of FIG. 39 shows the data structure of an instance of the net.

As shown in (b) of FIG. 39, one piece of record 3900b of the instance includes an instance name 393, a reference name 394, a structure condition information name 395, a target instance 396, an instance position 397, and a target instance position 398. Description of the instance name 393, reference name 394, structure condition information name 395, target instance 396, instance position 397, and target instance position 398 is omitted since they are the same as the instance name 343, reference name 344, structure condition information name 345, target instance 346, instance position 347, and target instance position 348 shown in (b) of FIG. 34.

In Modification 1, data is stored for each of the plurality of instances in the target instance 396 and the target instance position 398.

6.8 Details of Net List Generation Process in Modification 1

Next, the step S205 in Modification 1 to Embodiment 6 will be described in detail.

Steps S202 and S203 are performed in the manner as in Embodiment 6.

Modification 1 differs from Embodiment 6 in that the logic circuit synthesis device 1 performs the synthesizing process by taking the restriction on the row arrangement into consideration.

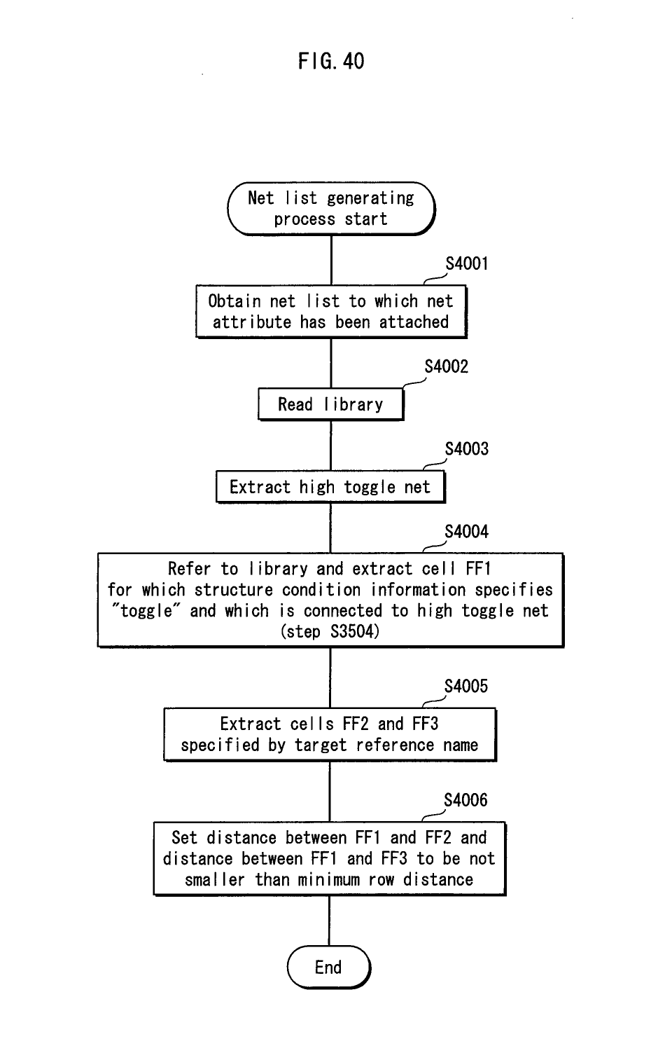

FIG. 40 is a flowchart showing the details of the process of step S205 in Modification 1 to Embodiment 6.

Description of steps S4001 through S4005 is omitted since they are the same as steps S3501 through S3505 shown in FIG. 35.

After step S4005, the net list generating unit 109 arranges cell “FF1” and cell “FF2” in rows that are separated from each other by one or more. Also, the net list generating unit 109 arranges cell “FF1” and cell “FF3” in rows that are separated from each other by the value specified by the minimum row distance 388 or more, namely, separated from each other by one or more (step S4006).

6.9 Transition of Net Structure

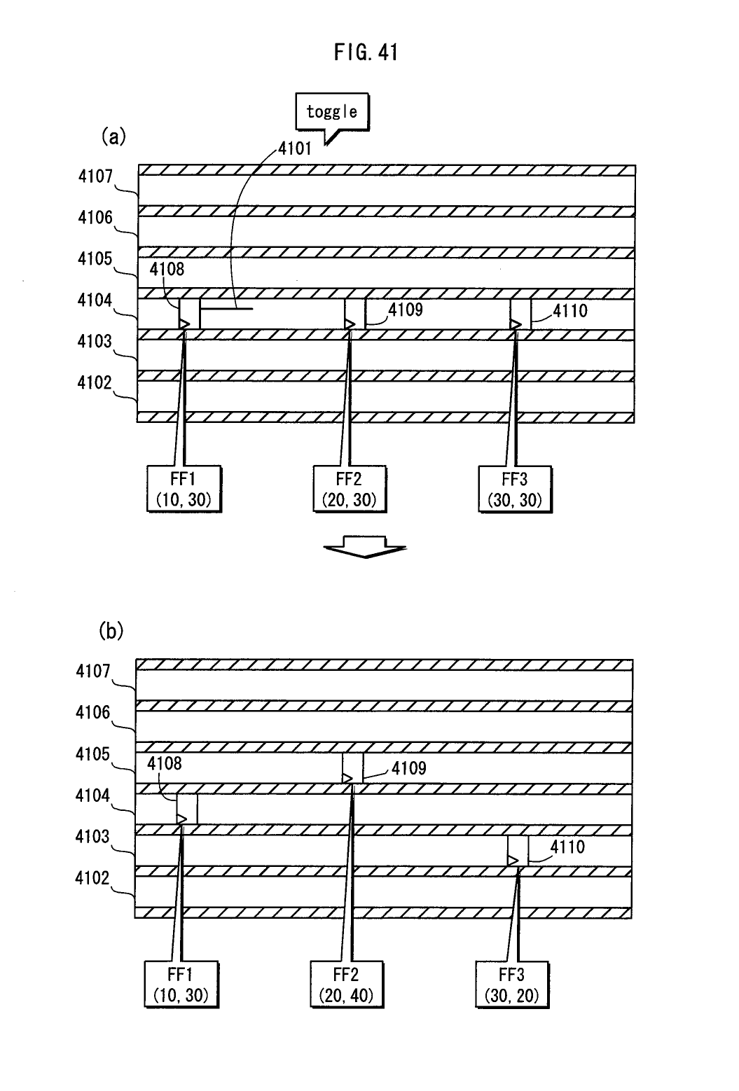

FIG. 41 shows a transition of the net structure.

The (a) of FIG. 41 shows the structure of part of nets in an original net list 601-1.

As shown in (a) of FIG. 41, the original net list 601-1 includes a high toggle net 4101, rows 4102 through 4107, and flip flops 4108 through 4110 as the structure of part of nets in the original net list 601-1. The flip flop 4108 has a reference name “FF1”, the flip flop 4109 has a reference name “FF2”, and the flip flop 4110 has a reference name “FF3”.

The logic circuit synthesis device 1 performs the processes of steps S202, S203 and S204 to attach the net attribute “toggle” to the high toggle net 4101 among the nets specified by the original net list 601-1. And the logic circuit synthesis device 1 generates a new net list 611-1 by performing step S205, which is detailed as steps S4001 through S4006.

The (b) of FIG. 41 shows the structure of part of nets in the new net list 611-1.

As shown in (b) of FIG. 41, the cells contained in the original net list 601-1 are arranged as part of the new net list 611-1.

Here, as shown in (b) of FIG. 41, the “FF1” receives power supply from the row 4104. Also, the “FF2” receives power supply from the row 4105, and the “FF3” receives power supply from the row 4103. Namely, “FF1”, “FF2”, and “FF3” are arranged at different rows.

As such, the position at which the “FF1” is arranged is (10,30) as indicated by the instance position 397, the position at which the “FF2” is arranged is (20,40) as indicated by the target instance position 398, and the position at which the “FF3” is arranged is (30,20) as indicated by the target instance position 398.

Accordingly, the net structure satisfies the condition specified by the minimum row distance 388 of the library 607-1.

6.10 Update of Net List

Here will be described how the data held by the net list is updated, while the logic circuit synthesis device 1 of Modification 1 to Embodiment 6 performs a process.

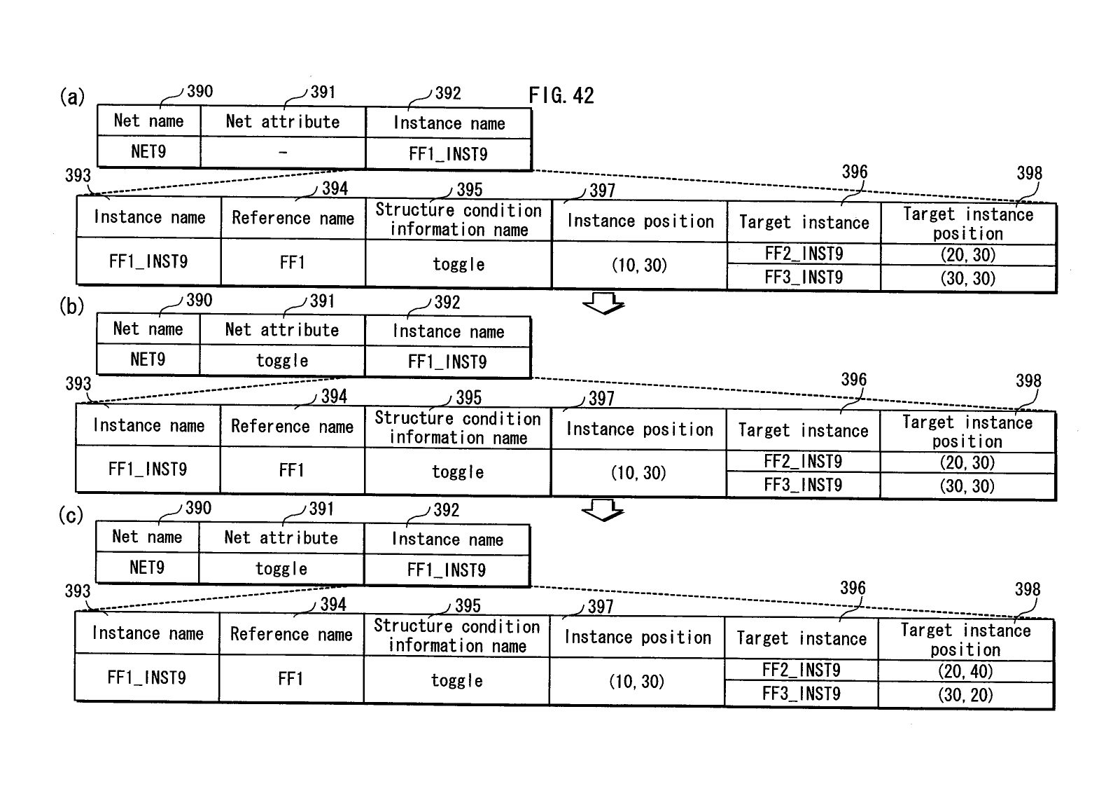

FIG. 42 shows the net list update process.

The (a) of FIG. 42 shows the original net list 601-1 in the state immediately after it is obtained by the obtaining unit 102 in step S201.

The (b) of FIG. 42 shows the original net list 601-1 in the state immediately after step S204 in which the attribute attaching unit 105 attaches the net attribute “toggle” to the net, and the original net list 601-1 in this state is to be input to the net list generating unit 109 in step S205.

The (c) of FIG. 42 shows the new net list 611-1 generated by the net list generating unit 109. Indicated in the data structure of instance is the net structure after the arrangement position between flip flops has been adjusted by applying the structure condition information.

6.11 Modification 2 to Embodiment 6

In Modification 1 described above, the restriction on the arrangement of rows is added into the structure condition information. As another modification different from this, the cells may be arranged by taking the strap line into account.

Here, strap lines are lines for connecting one another the supply lines through which the power is supplied to the rows, and the strap lines are wired to pass over the rows. The strap line is classified into: a strap line that connects one another supply lines through which the plus power is supplied to the rows; and a strap line that connects one another supply lines through which the minus power is supplied to the rows. In general, a plurality of strap lines are wired.

The occurrence of IR drop can be reduced by adding a restriction on the arrangement of strap lines into the structure condition information such that as many cells as possible receive power from different rows.

It should be noted here that in the following description of Modification 2 to Embodiment 6, a library stored in the storage unit 106 is referred to as a library 607-2. Also, a net list obtained by the obtaining unit 102 is referred to as an original net list 601-2, and a net list generated by the net list generating unit 109 is referred to as a new net list 611-2.

6.12 Data of Modification 2 to Embodiment 6

Here will be described the data structure of the library 607-2 stored in the storage unit 106 and the data structure of the net list.

6.12.1 Library 607-2

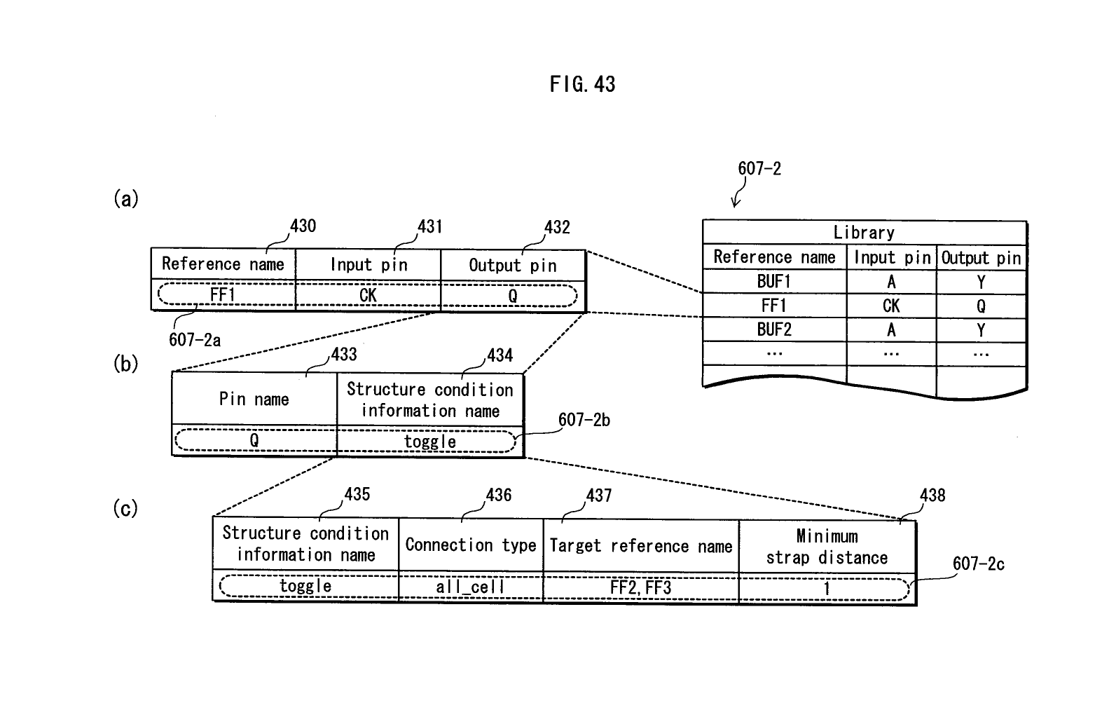

FIG. 43 shows the data structure of one cell contained in the library 607-2.

6.12.1.1 Data Structure of Library

As shown in (a) of FIG. 43, one piece of record 607-2a of the library 607-2 includes a reference name 430, an input pin 431, and an output pin 432. Description of the reference name 430, input pin 431, and output pin 432 is omitted since they indicate a reference name and the like in the same manner as the pin name 330, the pin name 331, and the pin name 332 shown in FIG. 33.

6.12.1.2 Data Structure of Pin

In (b) of FIG. 43, the data structure of pin is shown. One piece of record 607-2b constituting the data of pin includes a pin name 433 and a structure condition information name 434.

Description of the pin name 433 and structure condition information name 434 is omitted here since they are the same as the pin name 333 and the structure condition information name 334 shown in FIG. 33.

6.12.1.3 Data Structure of Structure Condition Information

In (c) of FIG. 43, the data structure of the structure condition information is shown. One piece of record 607-2c constituting data of the structure condition information includes a structure condition information name 435, a connection type 436, a target reference name 437, and a minimum strap distance 438. Modification 2 differs from Embodiment 6 in that it includes the minimum strap distance 438.

Description of the structure condition information name 435, connection type 436, and target reference name 437 is omitted since they are the same as the structure condition information name 335, connection type 336, and target reference name 337 shown in FIG. 33, respectively.

The minimum strap distance 438 specifies that a cell specified by the reference name 430 and a cell specified by the target reference name 437 should be arranged with at least as many strap lines as indicated by the minimum strap distance 438 sandwiched there between. In the example shown in FIG. 43, the minimum strap distance 438 specifies “1”. This indicates, for example, that “FF1” specified by the reference name 430 and “FF2” specified by the target reference name 437 should be arranged with at least one strap line sandwiched there between.

The data type of the minimum strap distance 438 is an integer.

6.12.2 Data Structure of Net List

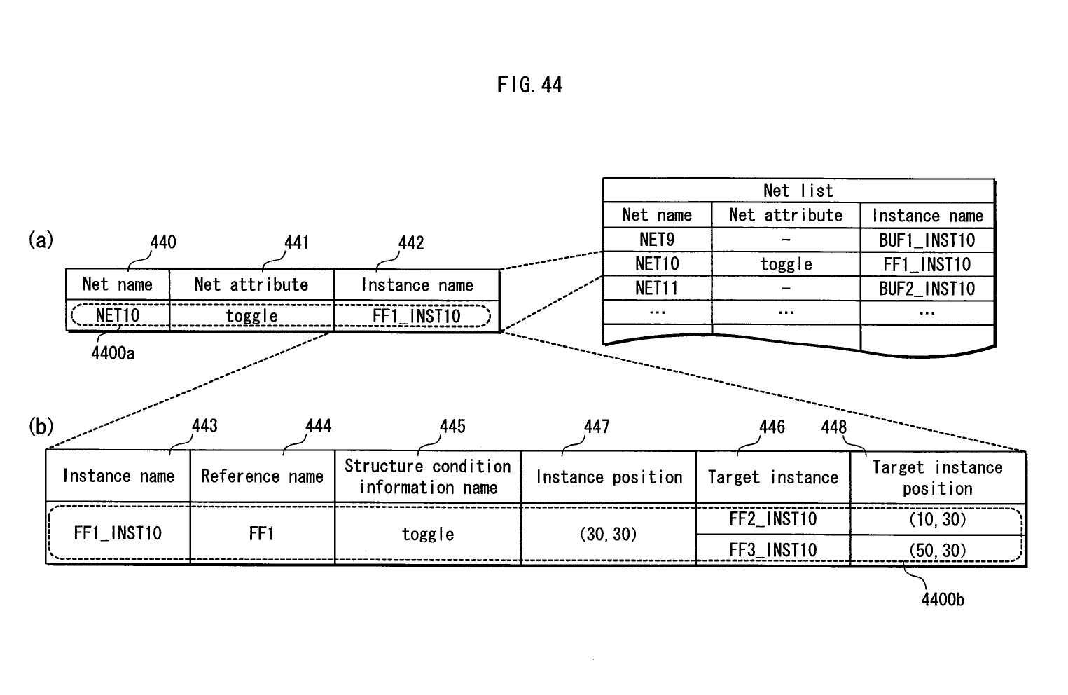

FIG. 44 shows the data structure of one net in the net list of Modification 2 to Embodiment 6.

6.12.2.1 Data Structure of Net

The (a) of FIG. 44 shows the data structure of one net in the net list.

As shown in (a) of FIG. 44, one piece of record 4400a of the net includes a net name 440, a net attribute 441, and an instance name 442.

Description of the net name 440, net attribute 441, and instance name 442 is omitted since they are the same as the net name 340, net attribute 341, and instance name 342 shown in FIG. 34.

6.12.2.2 Data Structure of Instance

The (b) of FIG. 44 shows the data structure of an instance of the net.

As shown in (b) of FIG. 44, one piece of record 4400b of the instance includes an instance name 443, a reference name 444, a structure condition information name 445, a target instance 446, an instance position 447, and a target instance position 448. Description of the instance name 4443, reference name 444, structure condition information name 445, target instance 446, instance position 447, and target instance position 448 is omitted since they are the same as the instance name 343, reference name 344, structure condition information name 345, target instance 346, instance position 347, and target instance position 348 shown in (b) of FIG. 34.

In Modification 2, data is stored for each of the plurality of instances in the target instance 446 and the target instance position 448.

6.13 Details of Net List Generation Process in Modification 2

Next, the step S205 in Modification 2 to Embodiment 6 will be described in detail.

Steps S202 and S203 are performed in the manner as in Embodiment 6.

Modification 2 differs from Embodiment 6 in that the logic circuit synthesis device 1 performs the synthesizing process by taking the restriction on the strap line arrangement into consideration.

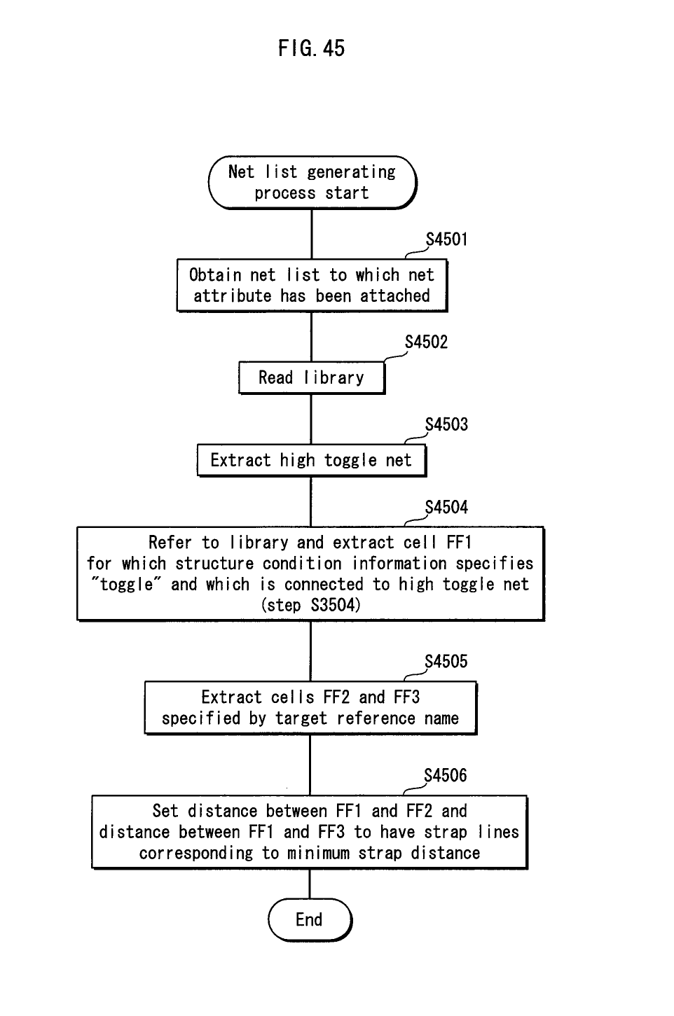

FIG. 45 is a flowchart showing the details of the process of step S205 in Modification 2 to Embodiment 6.

Description of steps S4501 through S4505 is omitted since they are the same as steps S3501 through S3505 shown in FIG. 35.

After step S4505, the net list generating unit 109 arranges cell “FF1” and cell “FF2” with one strap line sandwiched there between. Also, the net list generating unit 109 arranges cell “FF1” and cell “FF3” with at least as many strap lines as indicated by the minimum strap distance 438 sandwiched there between. Namely, the net list generating unit 109 arranges cell “FF1” and cell “FF3” with one strap line sandwiched there between (step S4506).

6.14 Transition of Net Structure

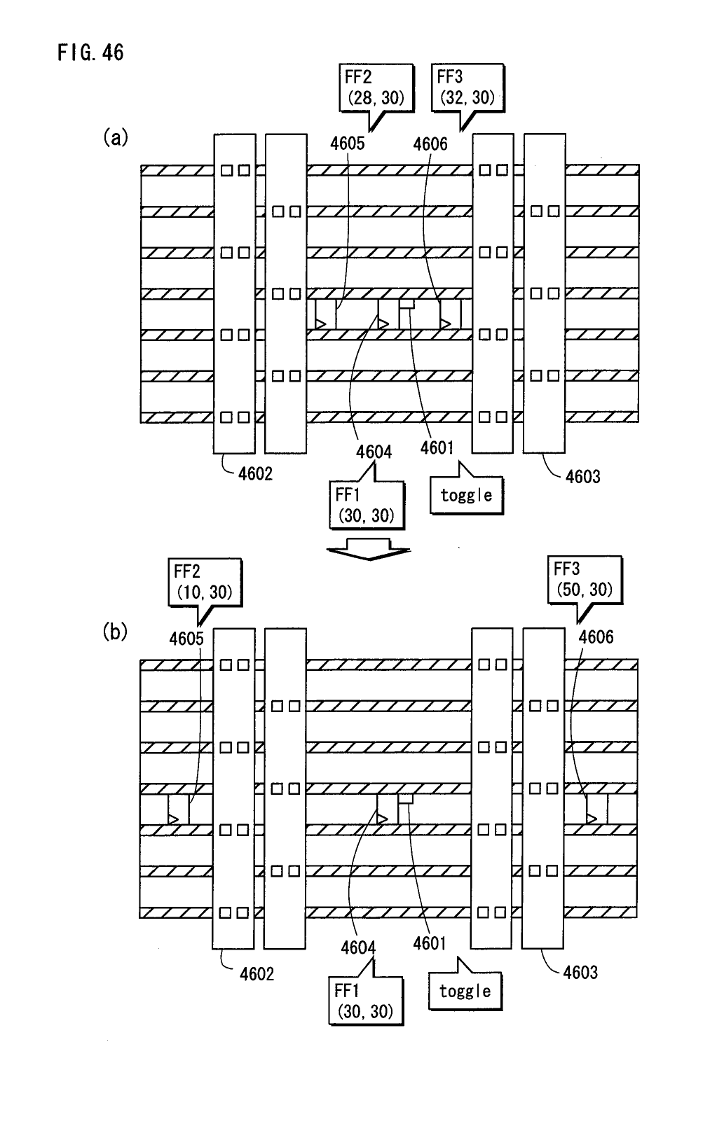

FIG. 46 shows a transition of the net structure.

The (a) of FIG. 46 shows the structure of nets as part of an original net list 601-2.

As shown in (a) of FIG. 46, the original net list 601-2 includes a high toggle net 4601, strap lines 4602 and 4603, and flip flops 4604 through 4606 as the structure of part of nets in the original net list 601-2. The flip flop 4604 has a reference name “FF1”, the flip flop 4605 has a reference name “FF2”, and the flip flop 4606 has a reference name “FF3”.

The logic circuit synthesis device 1 performs the processes of steps S202, S203 and S204 to attach the net attribute “toggle” to the high toggle net 4601 among the nets specified by the original net list 601-2. And the logic circuit synthesis device 1 generates a new net list 611-2 by performing step S205, which is detailed as steps S4501 through S4506.

The (b) of FIG. 46 shows the structure of part of nets in the new net list 611-2.

As shown in (b) of FIG. 46, the cells contained in the original net list 601-2 are arranged as part of the new net list 611-2.

Here, as shown in (b) of FIG. 46, “FF1”, “FF2”, and “FF3” are arranged with one strap line sandwiched between “FF1” and “FF2” and between “FF2” and “FF3”.

Accordingly, the net structure satisfies the condition specified by the minimum strap distance 438 of the library 607-2.

6.15 Update of Net List

Here will be described how the data held by the net list is updated, while the logic circuit synthesis device 1 of Modification 2 to Embodiment 6 performs a process.

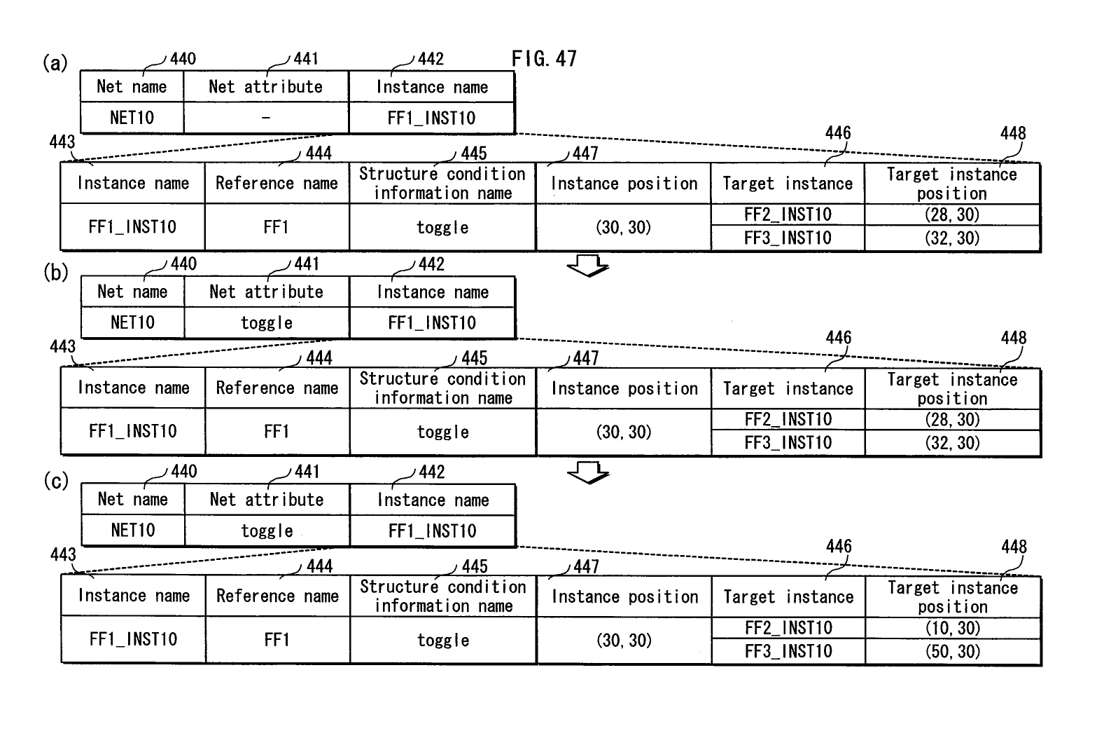

FIG. 47 shows the net list update process.

The (a) of FIG. 47 shows the original net list 601-2 in the state immediately after it is obtained by the obtaining unit 102 in step S201.

The (b) of FIG. 47 shows the original net list 601-2 in the state immediately after step S204 in which the attribute attaching unit 105 attaches the net attribute “toggle” to the net, and the original net list 601-2 in this state is to be input to the net list generating unit 109 in step S205.

The (c) of FIG. 47 shows the new net list 611-2 generated by the net list generating unit 109. Indicated in the data structure of instance is the net structure after the arrangement position between flip flops has been adjusted by applying the structure condition information.

### Embodiment 7

7.1 Outline

In the following, another embodiment of the logic circuit synthesis device of the present invention will be described.

In Embodiment 7, the logic circuit synthesis device 1 selects, as a net having a predetermined property, an FF direct connection net in which flip flops are directly connected.

In such a net in which flip flops are directly connected, a time period between (i) a time at which a signal is output from an output pin of a first flip flop and (ii) a time at which the signal reaches an input pin of a second flip flop should synchronize with a clock cycle. The case where the signal reaches earlier than expected is called a hold error. This error can be solved by inserting buffers.

In Embodiment 7, to create a delay time of a predetermined time, for example 1 nanosecond, or more between the first flip flop and the second flip flop, buffers are inserted between the first flip flop and the second flip flop. It should be noted here that the predetermined time is determined preliminarily so that the hold error does not occur, based on the internal delay time of the first flip flop and the hold check time of the second flip flop. Also, the delay time between flip flops in the logic circuit is measured by a simulation or the like.

Also, since Embodiment 7 is different from Embodiment 1 in the data structure of the library, the library is referred to as a library 707 in Embodiment 7.

Further, since Embodiment 7 is different from Embodiment 1 in the data structure of the net list, the net lists of Embodiment 7 are referred to as an original net list 701 and a new net list 711.

With respect to the other functional blocks that are common with Embodiment 1, the reference signs used in Embodiment 1 are attached thereto and description thereof is omitted.

7.2 Data

In the following, the data structure of the library 707 stored in the storage unit 106 and the data structure of the net list will be described.

7.2.1 Library 707

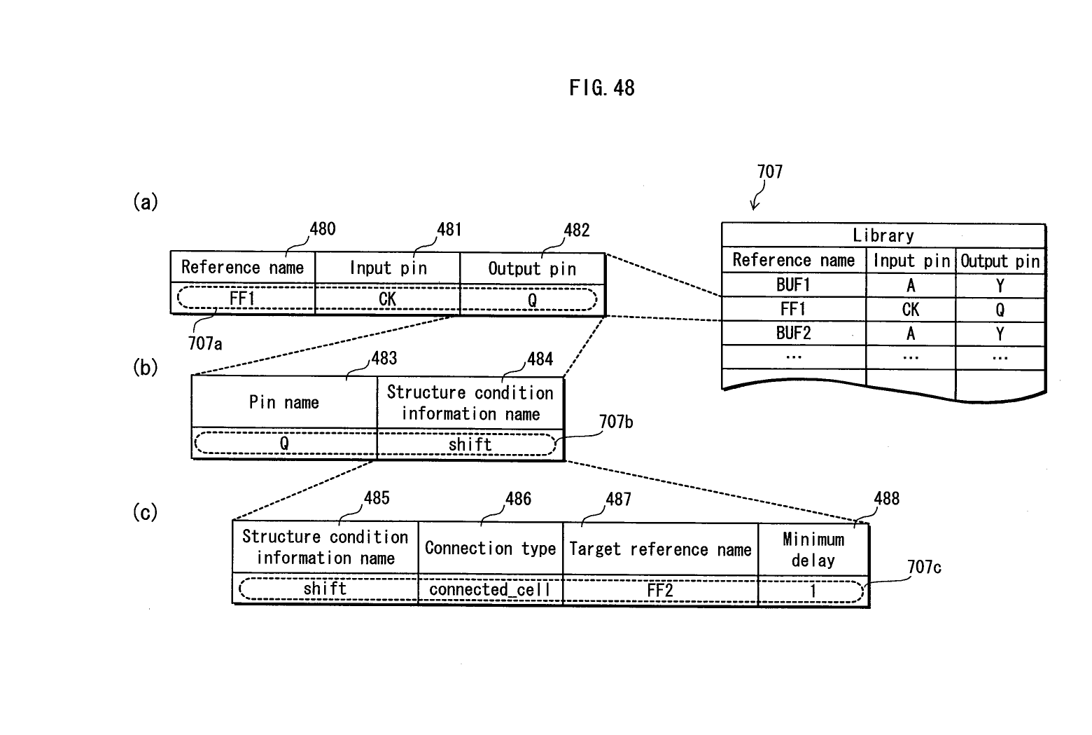

FIG. 48 shows the data structure of one cell contained in the library 707.

7.2.1.1 Data Structure of Library

As shown in (a) of FIG. 48, one piece of record 707a of the library 707 includes a reference name 480, an input pin 481, and an output pin 482. Description of the reference name 480, input pin 481, and output pin 482 is omitted here since they indicate a reference name and the like in the same manner as the reference name 30, the input pin 31, and the output pin 32 shown in FIG. 3.

7.2.1.2 Data Structure of Pin

In (b) of FIG. 48, the data structure of pin is shown.

One piece of record 707b constituting the data of pin includes a pin name 483 and a structure condition information name 484.

Description of the pin name 483 and structure condition information name 484 is omitted here since they are the same as the pin name 33 and the structure condition information name 34 shown in FIG. 3.

In Embodiment 7, the structure condition information name 484 specifies “shift”. The “shift” is a reference name of a net attribute that specifies a net in which flip flops are directly connected.

7.2.1.3 Data Structure of Structure Condition Information

In (c) of FIG. 48, the data structure of the structure condition information is shown. One piece of record 707c constituting data of the structure condition information includes a structure condition information name 485, a connection type 486, a target reference name 487, and a minimum delay 488. Especially, the structure differs from Embodiment 1 in that it includes the minimum delay 488.

Description of the structure condition information name 485, connection type 486, and target reference name 487 is omitted since they are the same as the structure condition information name 35, connection type 36, and target reference name 37 shown in FIG. 3, respectively.

In Embodiment 7, the structure condition information name 485 specifies “shift”. Also, the target reference name 487 specifies “FF2”. This indicates that buffers should be inserted between “FF2” and “FF1” specified by the reference name 480 to adjust the delay time.

The minimum delay 488 specifies the minimum delay time between the target references to which the structure condition information is applied. Namely, the minimum delay 488 specifies a time period of which or more, a delay should be. The unit of time is, for example, nanosecond. In (c) of FIG. 48, the minimum delay 488 specifies “1”. This indicates that a delay of 1 nanosecond or more should be created between “FF1”, which is specified by the reference name 480, and “FF2”, which is specified by the target reference name 487.

The data type of the minimum delay 488 is numeral.

7.2.2 Data Structure of Net List

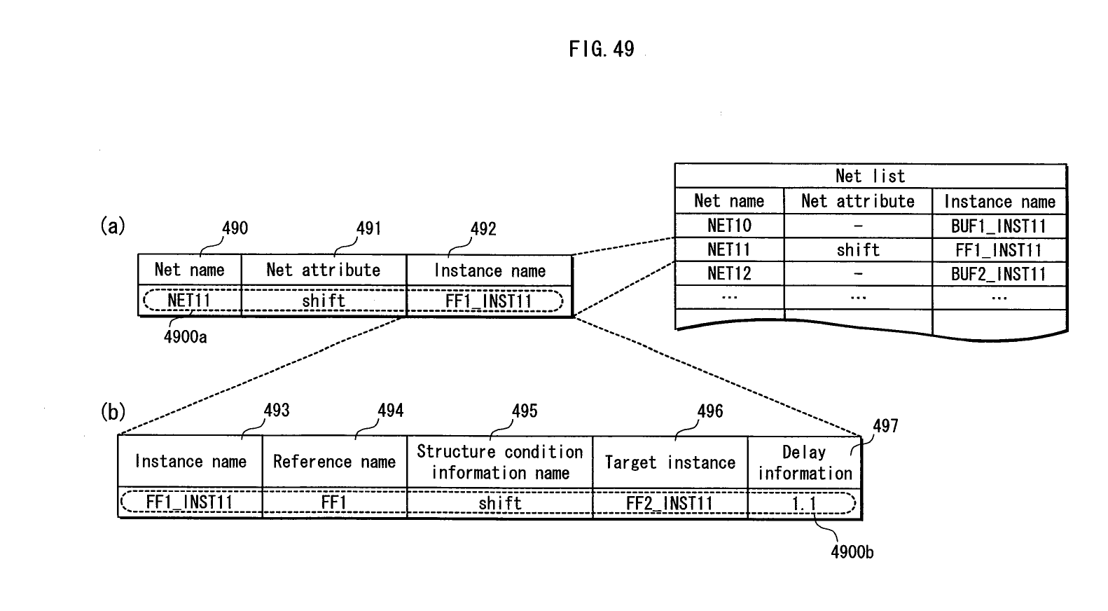

FIG. 49 shows the data structure of one net in the net list of Embodiment 7.

7.2.2.1 Data Structure of Net

The (a) of FIG. 49 shows the data structure of one net in the net list.

As shown in (a) of FIG. 49, one piece of record 4900a of the net includes a net name 490, a net attribute 491, and an instance name 492.

Description of the net name 490, net attribute 491, and instance name 492 is omitted since they are the same as the net name 40, net attribute 41, and instance name 42 shown in FIG. 4.

In Embodiment 7, the net attribute 491 specifies “shift”, which indicates that net attribute “shift” is attached to the net.

7.2.2.2 Data Structure of Instance

The (b) of FIG. 49 shows the data structure of an instance of the net.

As shown in (b) of FIG. 49, one piece of record 4900b of the instance includes an instance name 493, a reference name 494, a structure condition information name 495, a target instance 496, and delay information 497. Description of the instance name 493, reference name 494, structure condition information name 495, and target instance 496 is omitted since they are the same as the instance name 43, reference name 44, structure condition information name 45, and target instance 46 shown in (b) of FIG. 4.

The delay information 497 indicates a delay time between the instance name 493 and the target instance 496. The unit of time is, for example, nanosecond. In (c) of FIG. 49, the delay information 497 specifies “1.1”. This indicates that a delay of 1.1 nanoseconds should be created between the references.

7.3 Details of Net List Generation Process

Next, the step S205 in Embodiment 7 will be described in detail.

In Embodiment 7, the net having a predetermined property is an FF direct connection net. Also, in step S202 shown in FIG. 2, the analyzing unit 104 extracts FF direct connection nets based on the layout information, and selects the extracted nets in step S203. In step S204, the attribute attaching unit 105 attaches net attribute “shift” to the selected nets.

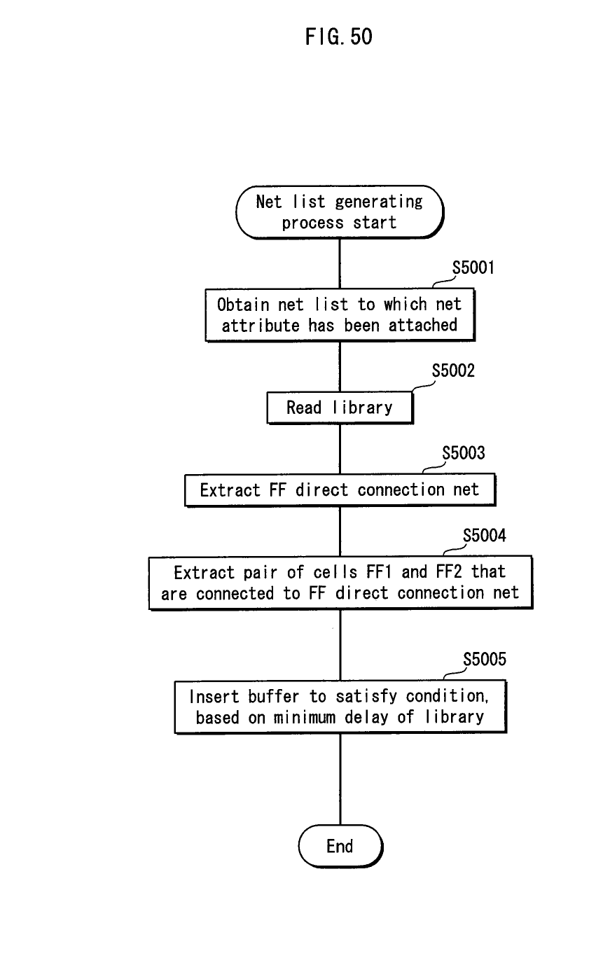

FIG. 50 is a flowchart showing the details of the process of step S205 in Embodiment 7.

As shown in FIG. 50, the net list generating unit 109 obtains the original net list 701 which was output from the attribute attaching unit 105 and to which the net attribute has been attached (step S5001).

The net list generating unit 109 then reads the library 707 from the storage unit 106. In this step, the net list generating unit 109 extracts a cell that is specified as “shift” in the structure condition information name 484. In the present embodiment, the net list generating unit 109 extracts “FF1” (step S5002).

The net list generating unit 109 extracts, from the original net list 701, nets in which net attribute “shift” has been attached to the net attribute 491 (step S5003).

Next, the net list generating unit 109 extracts, from among the cells connected to the net with net attribute “shift”, a pair of (i) cell that is specified as “shift” in the structure condition information name 484 and (ii) cell that is specified in the target reference name 487 as the target of the cell (i). In the present embodiment, the net list generating unit 109 extracts cells “FF1” and “FF2” as the pair (step S5004).

Further, the net list generating unit 109 refers to the minimum delay 488 of “FF1” and reads the minimum delay time, then inserts buffers between FF1 and FF2 so that the delay time of the minimum delay time specified in the minimum delay 488, or more, namely 1 nanosecond or more can be made between FF1 and FF2 (step S5005).

7.4 Transition of Net Structure

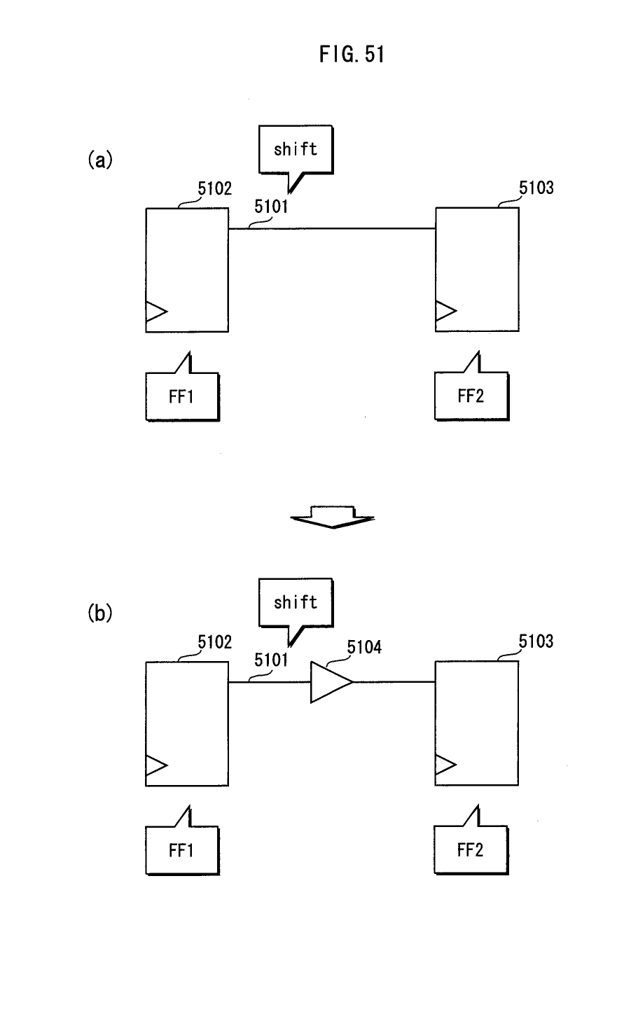

FIG. 51 shows a transition of the net structure.

The (a) of FIG. 51 shows the structure of part of nets in the original net list 701.

As shown in (a) of FIG. 51, the original net list 701 includes an FF direct connection net 5101, a flip flop 5102, and a flip flop 5103 as the structure of part of nets in the original net list 701. The flip flop 5102 has a reference name “FF1”, and the flip flop 5103 has a reference name “FF2”.

The logic circuit synthesis device 1 performs the processes of steps S202, S203 and S204 to attach the net attribute “shift” to the FF direct connection net 5101 among the nets specified by the original net list 701. And the logic circuit synthesis device 1 generates the new net list 711 by performing step S205, which is detailed as steps S5001 through S5005.

The (b) of FIG. 51 shows the structure of part of nets in the new net list 711.

The (b) of FIG. 51 shows, as the structure of the nets in the new net list 711, the FF direct connection net 5101, flip flop 5102, flip flop 5103, and buffer 5104 as the structure of part of nets in the new net list 711. As a result of the process performed by the net list generating unit 109, the buffer 5104 has been inserted between “FF1” and “FF2” that are specified as the structure of part of nets in the new net list 711, and the delay time between flip flops is 1 nanosecond or more.

Accordingly, the structure of the net satisfies the condition specified by the minimum delay 488 in the library 707.

7.5 Update of Net List

Here will be described how the data held by the net list is updated, while the logic circuit synthesis device 1 of Embodiment 7 performs a process.

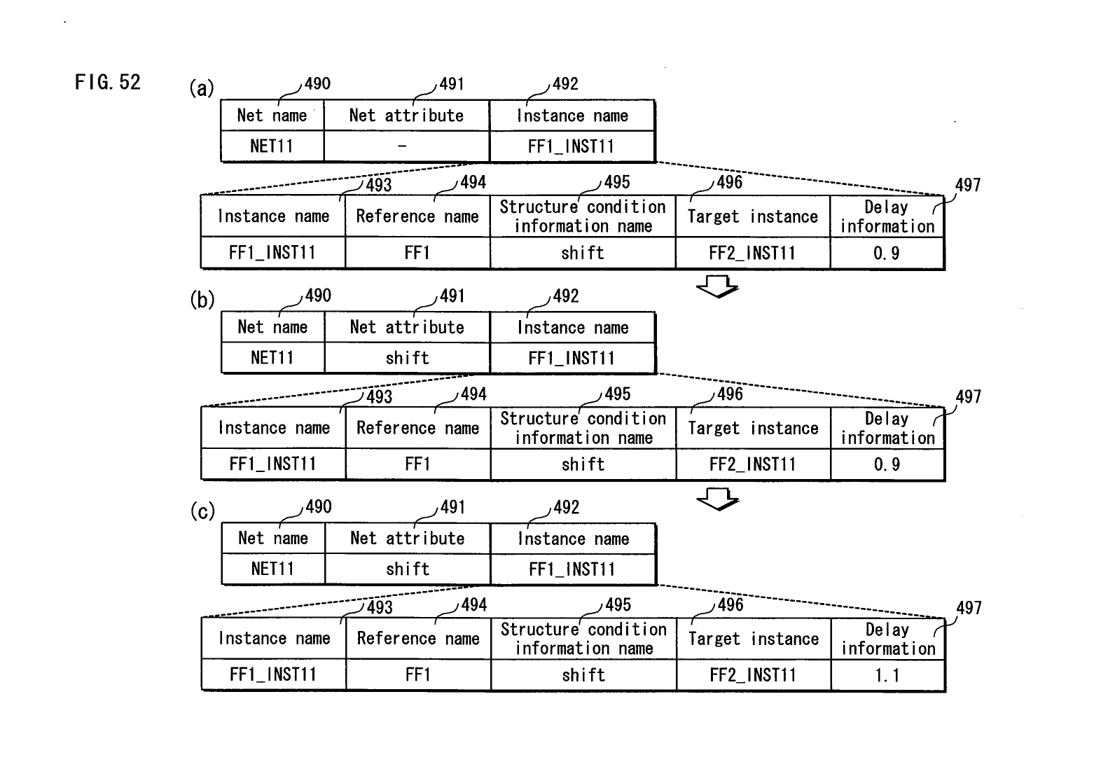

FIG. 52 shows the net list update process.

The (a) of FIG. 52 shows the original net list 701 in the state immediately after it is obtained by the obtaining unit 102 in step S201. In the original net list 701 in this state, the net attribute has not been attached yet, and the delay information 497 specifies “0.9” as the delay time of the net. This indicates that the structure of the net at this point in time does not satisfy the condition specified by the minimum delay 488 in the library 707 concerning the delay time of the FF direct connection net.

The (b) of FIG. 52 shows the original net list 701 in the state immediately after step S204 in which the attribute attaching unit 105 attaches the net attribute “shift” to the net, and the original net list 701 in this state is to be input to the net list generating unit 109 in step S205. The net attribute “shift” has been attached to the net attribute 491.

The (c) of FIG. 52 shows the new net list 711 generated by the net list generating unit 109. Indicated in the data structure of instance is the structure of the net that has been re-structured by inserting buffers such that the delay time between flip flops satisfies the restriction specified by the minimum delay 488 in the library 707.

### Embodiment 8

8.1 Outline

In the following, another embodiment of the logic circuit synthesis device of the present invention will be described.

In Embodiment 8, the logic circuit synthesis device 1 selects, as a net having a predetermined property, an observation target net that is observed to detect a defect or the like. The net is observed by, for example, connecting a flip flop to the observation target net. That is to say, it is possible to detect a defect or the like by comparing a signal input into the observation target net with a signal input from the observation target net into the flip flop.

However, there may be a case where the detection of defect or the like does not have a sufficient level depending on the location in the observation target net to which the flip flop is connected. For example, when the flip flop is connected to the observation target net at a location near the input thereof, a defect in the vicinity of the center of the observation target net may not be detected.

In view of this problem, in Embodiment 8, the structure condition information stored in the library includes information of a restriction that the flip flop should be connected to the observation target net at a location near the output thereof.

Also, since Embodiment 8 is different from Embodiment 1 in the data structure of the library, the library is referred to as a library 807 in Embodiment 7.

Further, since Embodiment 8 is different from Embodiment 1 in the data structure of the net list, the net lists of Embodiment 8 are referred to as an original net list 801 and a new net list 811.

With respect to the other functional blocks that are common with Embodiment 1, the reference signs used in Embodiment 1 are attached thereto and description thereof is omitted.

8.2 Data

In the following, the data structure of the library 807 stored in the storage unit 106 and the data structure of the net list will be described.

8.2.1 Library 807

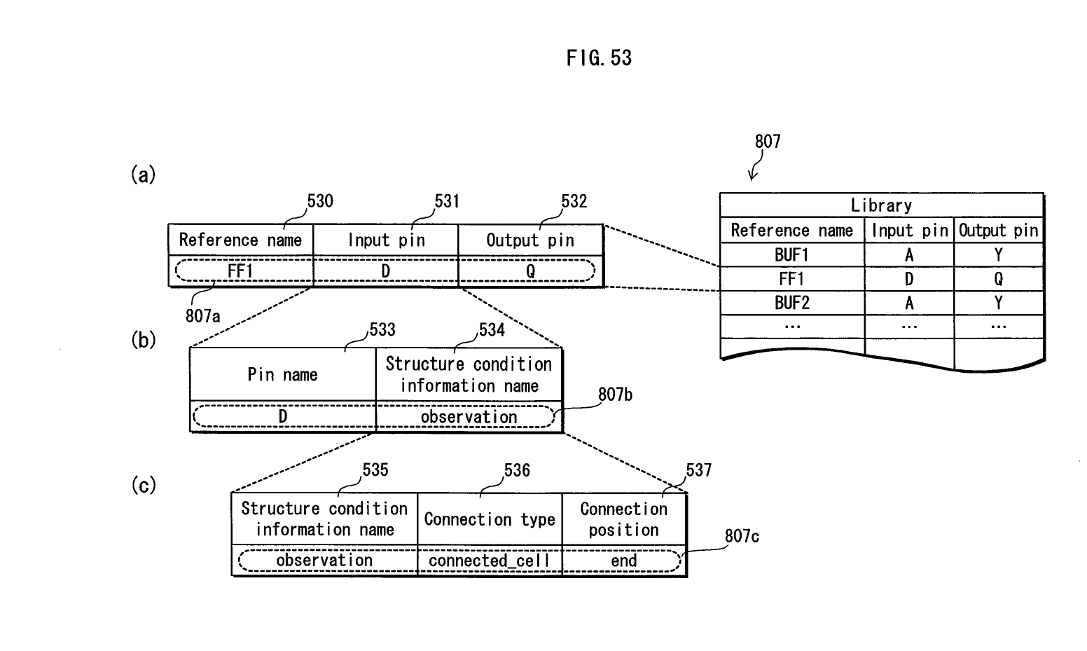

FIG. 53 shows the data structure of one cell contained in the library 807.

8.2.1.1 Data Structure of Library

As shown in (a) of FIG. 53, one piece of record 807a of the library 807 includes a reference name 530, an input pin 531, and an output pin 532. Description of the reference name 530, input pin 531, and output pin 532 is omitted here since they indicate a reference name and the like in the same manner as the reference name 30, the input pin 31, and the output pin 32 shown in FIG. 3.

8.2.1.2 Data Structure of Pin

In (b) of FIG. 53, the data structure of pin is shown.

One piece of record 807b constituting the data of pin includes a pin name 533 and a structure condition information name 534.

Description of the pin name 533 and structure condition information name 534 is omitted here since they are the same as the pin name 33 and the structure condition information name 34 shown in FIG. 3.

In Embodiment 8, the structure condition information name 534 specifies “observation”. The “observation” is a reference name of a net attribute that specifies an observation target net.

8.2.1.3 Data Structure of Structure Condition Information

In (c) of FIG. 53, the data structure of the structure condition information is shown. One piece of record 807c constituting data of the structure condition information includes a structure condition information name 535, a connection type 536, and a connection position 537. Especially, the structure differs from Embodiment 1 in that it includes the connection position 537.

Description of the structure condition information name 535 and the connection type 536 is omitted since they are the same as the structure condition information name 35 and the connection type 36 shown in FIG. 3, respectively.

In Embodiment 8, the structure condition information name 535 specifies “observation”.

The connection position 537 specifies a restriction on the connection position at which the cell specified by the reference name 530 is connected to a net that has the same net attribute as the reference name specified by the structure condition information name 535. The data type of the connection position 537 is a list, and the list includes “start”, “middle”, and “end”. When “start” is specified, the cell is connected to the input side of the net; when “middle” is specified, the cell is connected to a vicinity of the center of the net; and when “end” is specified, the cell is connected to the output side of the net. In (c) of FIG. 53, the connection position 537 specifies “end”. This indicates that “FF1” specified by the reference name 530 is connected to the output side of a net having net attribute “observation”.

8.2.2 Data Structure of Net List

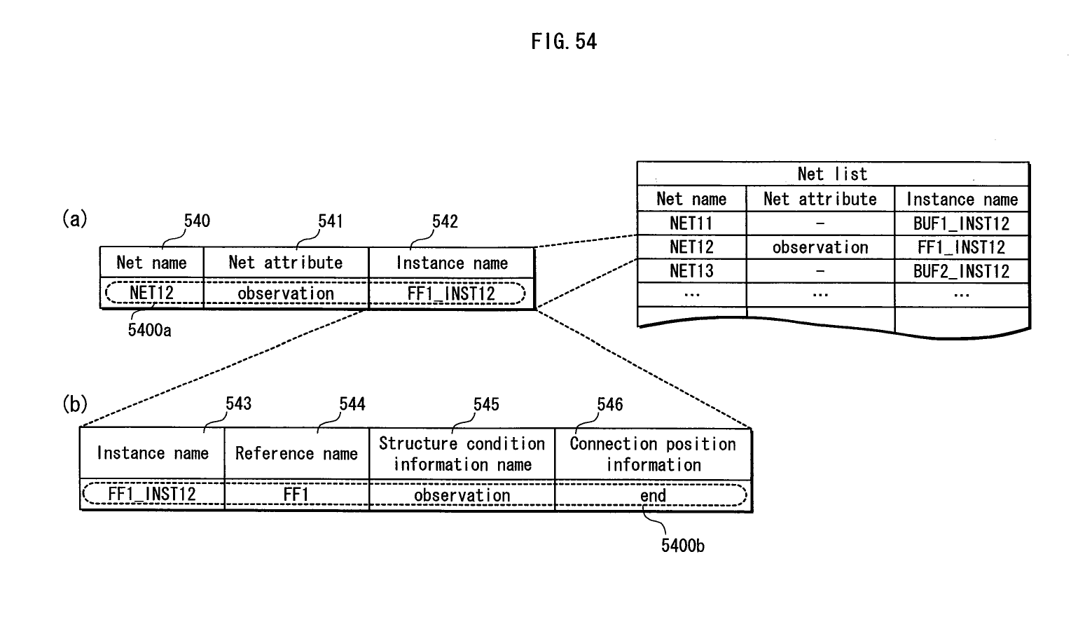

FIG. 54 shows the data structure of one net in the net list of Embodiment 8.

8.2.2.1 Data Structure of Net

The (a) of FIG. 54 shows the data structure of one net in the net list.

As shown in (a) of FIG. 54, one piece of record 5400a of the net includes a net name 540, a net attribute 541, and an instance name 542.

Description of the net name 540, net attribute 541, and instance name 542 is omitted since they are the same as the net name 40, net attribute 41, and instance name 42 shown in FIG. 4.

In Embodiment 8, the net attribute 541 specifies “observation”, which indicates that net attribute “observation” is attached to the net.

8.2.2.2 Data Structure of Instance

The (b) of FIG. 54 shows the data structure of an instance of the net.

As shown in (b) of FIG. 54, one piece of record 5400b of the instance includes an instance name 543, a reference name 544, a structure condition information name 545, and connection position information 546. It is different from Embodiment 1 in that it includes the connection position information 546. Description of the instance name 543, reference name 544, and structure condition information name 545 is omitted since they are the same as the instance name 43, reference name 44, and structure condition information name 45 shown in (b) of FIG. 4.

The connection position information 546 specifies the connection position at which the instance specified by the instance name 543 is connected to a net that has a name specified by the net name 540. The connection position information 546 specifies any of “start”, “middle”, and “end”. When it specifies “start”, it indicates that the instance is connected to the input side of the net; when it specifies “middle”, it indicates that the instance is connected to a vicinity of the center of the net; and when it specifies “end”, it indicates that the instance is connected to the output side of the net. In (b) of FIG. 54, the connection position information 546 specifies “end”. It indicates that flip flop “FF1” specified by the reference name 544 is connected to the output side of net “NET12” specified by the net name 540.

8.3 Details of Net List Generation Process

Next, the step S205 in Embodiment 8 will be described in detail.

In Embodiment 8, the net having a predetermined property is an observation target net. Also, in step S202 shown in FIG. 2, the analyzing unit 104 specifies an observation target net based on the layout information, and selects the specified net in step S203. In step S204, the attribute attaching unit 105 attaches net attribute “observation” to the selected net.

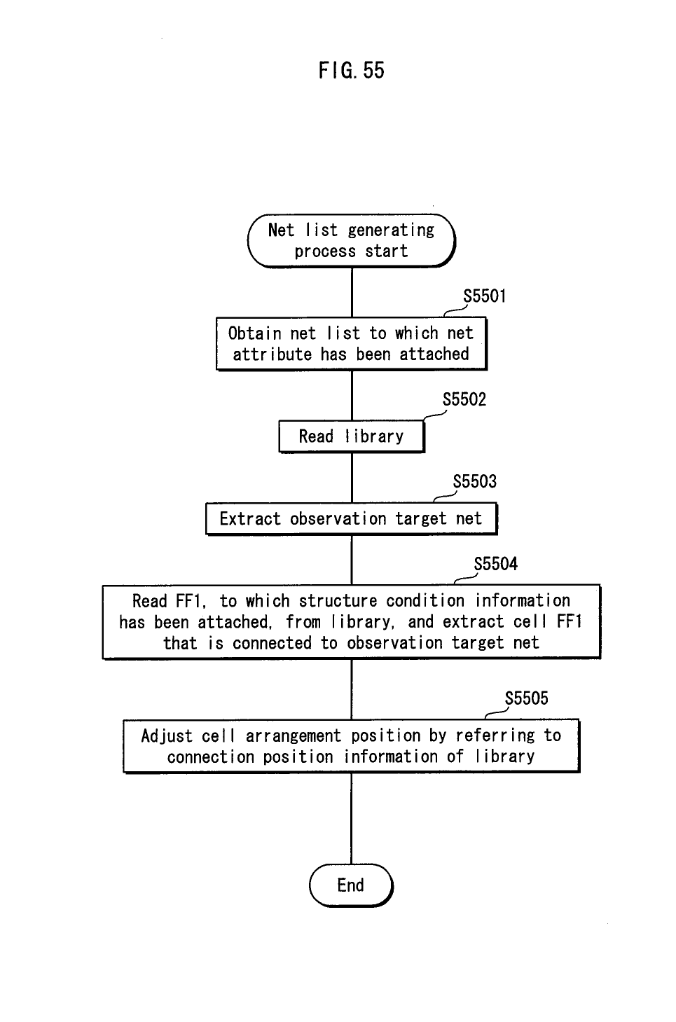

FIG. 55 is a flowchart showing the details of the process of step S205 in Embodiment 8.

As shown in FIG. 55, the net list generating unit 109 obtains the original net list 801 which was output from the attribute attaching unit 105 and to which the net attribute has been attached (step S5501).

The net list generating unit 109 then reads the library 807 from the storage unit 106 (step S5502).

The net list generating unit 109 extracts, from the original net list 801, a net in which net attribute “observation” has been attached to the net attribute 541 (step S5003).

Next, based on the library 807, the net list generating unit 109 reads a reference name of a cell for which “observation” has been attached to the structure condition information name 534. In Embodiment 8, the net list generating unit 109 reads flip flop “FF1”. The net list generating unit 109 extracts a cell that has the reference name read from the library 807, and is connected to the net having the net attribute “observation”. Namely, net list generating unit 109 extracts flip flop “FF1” that is connected to the net having the net attribute “observation” (step S5504).

Further, the net list generating unit 109 refers to the connection position information 546 regarding the extracted cell, and adjusts the arrangement position of the extracted cell. That is to say, in the example of Embodiment 8, to satisfy the condition “end” specified by the connection position information 546 with respect to “FF1”, the net list generating unit 109 connects “FF1” to the output side of the net having net attribute “observation” (step S5505).

8.4 Transition of Net Structure

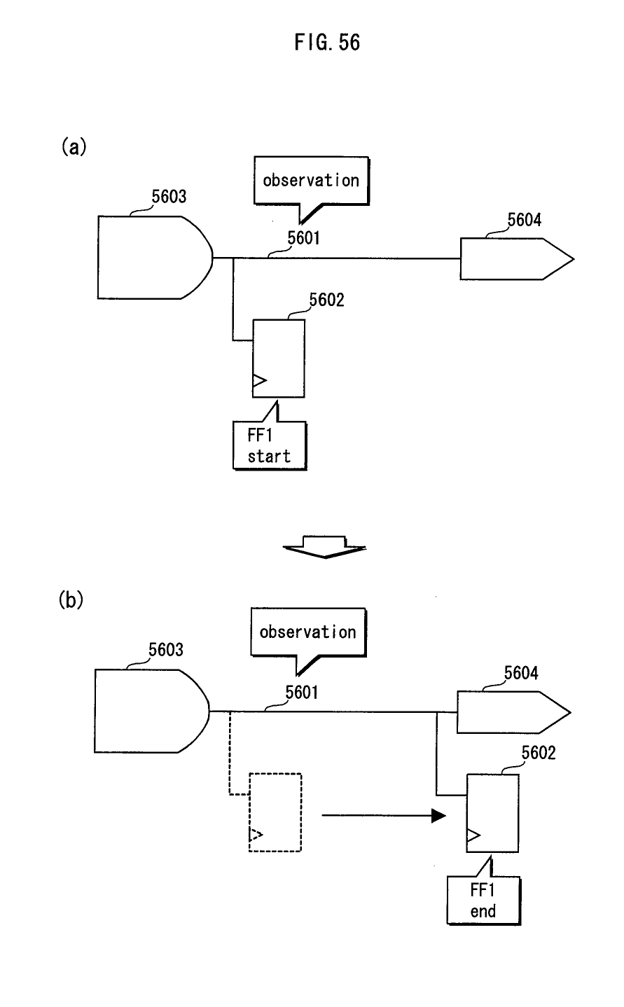

FIG. 56 shows a transition of the net structure.

The (a) of FIG. 56 shows the structure of part of nets in the original net list 801.

As shown in (a) of FIG. 56, the original net list 801 includes an observation target net 5601, a flip flop 5602, an AND cell 5603, and an output port 5604 as the structure of part of nets in the original net list 801. The flip flop 5602 is connected to the input side of the observation target net 5601. The flip flop 5602 has a reference name “FF1”.

The logic circuit synthesis device 1 performs the processes of steps S202, S203 and S204 to attach the net attribute “observation” to the observation target net 5601 among the nets specified by the original net list 801. And the logic circuit synthesis device 1 generates the new net list 811 by performing step S205, which is detailed as steps S5501 through S5505.

The (b) of FIG. 56 shows the structure of part of nets in the new net list 811.

The (b) of FIG. 56 shows the cells shown in (a) of FIG. 56 that are arranged as the structure of part of the nets in the new net list 811. As understood from comparing it with (a) of FIG. 56, the flip flop 5602 is connected to the output side of the observation target net 5601.

Accordingly, the structure of the net satisfies the condition specified by the connection position 537 in the library 807.

8.5 Update of Net List

Here will be described how the data held by the net list is updated, while the logic circuit synthesis device 1 of Embodiment 8 performs a process.

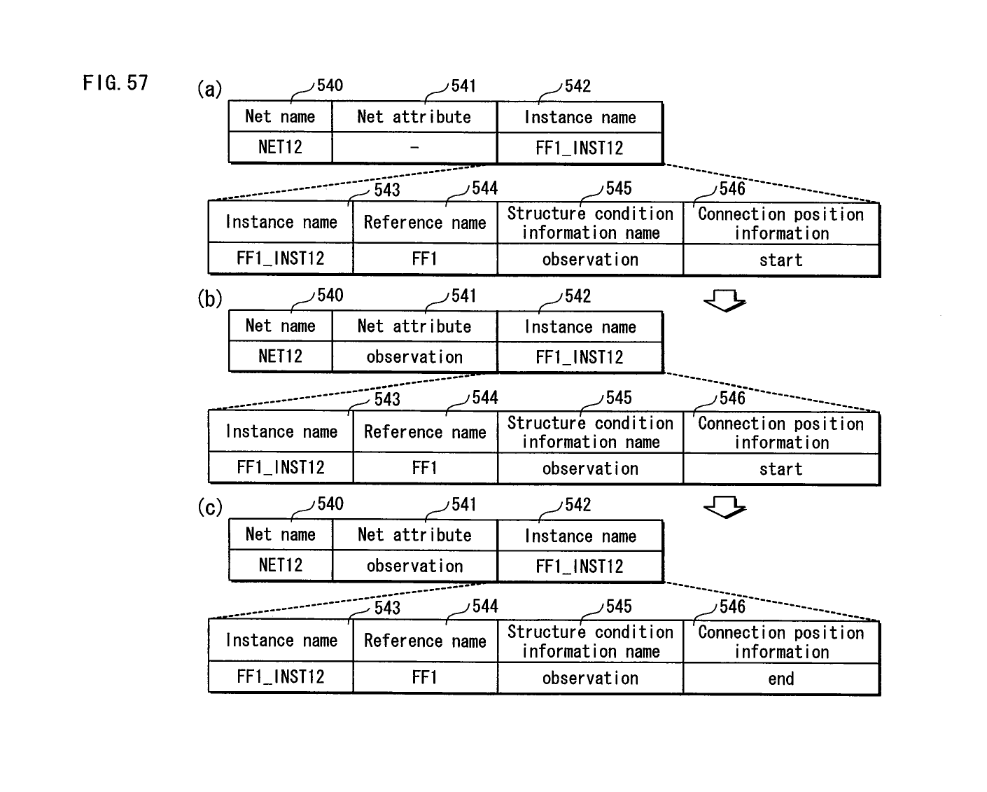

FIG. 57 shows the net list update process.

The (a) of FIG. 57 shows the original net list 801 in the state immediately after it is obtained by the obtaining unit 102 in step S201. In the original net list 801 in this state, the net attribute has not been attached yet, and the connection position information 546 specifies “start”.

The (b) of FIG. 57 shows the original net list 801 in the state immediately after step S204 in which the attribute attaching unit 105 attaches the net attribute “observation” to the net, and the original net list 801 in this state is to be input to the net list generating unit 109 in step S205. The net attribute “observation” has been attached to the net attribute 541.

The (c) of FIG. 57 shows the new net list 811 generated by the net list generating unit 109. Indicated in the data structure of instance is the structure of the net where flip flop “FF1” is connected to the output side of the observation target net, as a result of applying the structure condition information thereto.

### Embodiment 9

5.1 Outline

In the following, another embodiment of the logic circuit synthesis device of the present invention will be described.

In Embodiment 9, the logic circuit synthesis device 1 selects, as a net having a predetermined property, a signal EM (Electro-Migration) violation net that has a signal EM error.

When a signal EM violation has occurred, the via should be converted into double via to solve the signal EM error. However, there is no need to make double all of a plurality of vias for connection in a board composed of a plurality of layers. Also, to increase the density of the circuit, it is preferable that the minimum number of vias are made double and that a small number of layers are permitted for wiring, in line with the conversion into the double via.

In Embodiment 9, in the library, when a certain cell constitutes the net, the vias to be made double and the layers to be permitted for wiring are restricted.

Also, since Embodiment 9 is different from Embodiment 1 in the data structure of the library, the library is referred to as a library 907 in Embodiment 9.

Further, since Embodiment 9 is different from Embodiment 1 in the data structure of the net list, the net lists of Embodiment 9 are referred to as an original net list 901 and a new net list 911.

With respect to the other functional blocks that are common with Embodiment 1, the reference signs used in Embodiment 1 are attached thereto and description thereof is omitted.

9.2 Data

In the following, the data structure of the library 907 stored in the storage unit 106 and the data structure of the net list will be described.

9.2.1 Library 907

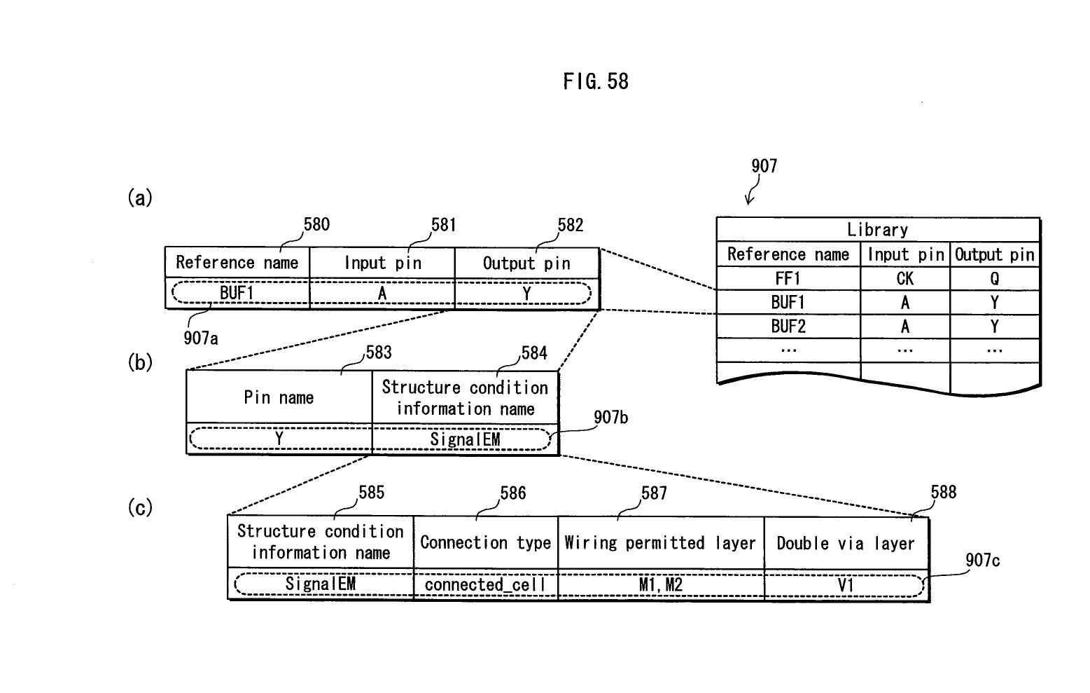

FIG. 58 shows the data structure of one cell contained in the library 907.

9.2.1.1 Data Structure of Library

As shown in (a) of FIG. 58, one piece of record 907a of the library 907 includes a reference name 580, an input pin 581, and an output pin 582. Description of the reference name 580, input pin 581, and output pin 582 is omitted here since they indicate a reference name and the like in the same manner as the reference name 30, the input pin 31, and the output pin 32 in Embodiment 1.

9.2.1.2 Data Structure of Pin

In (b) of FIG. 58, the data structure of pin is shown.

One piece of record 907b constituting the data of pin includes a pin name 583 and a structure condition information name 584.

Description of the pin name 583 and structure condition information name 584 is omitted here since they are the same as the pin name 33 and the structure condition information name 34 shown in FIG. 3.

In Embodiment 9, the structure condition information name 584 specifies “SignalEM”. The “SignalEM” is a reference name of a net attribute that specifies an signal EM violation net.

9.2.1.3 Data Structure of Structure Condition Information

In (c) of FIG. 58, the data structure of the structure condition information is shown. One piece of record 907c constituting data of the structure condition information includes a structure condition information name 585, a connection type 586, a wiring permitted layer 587, and a double via layer 588. Especially, the structure differs from Embodiment 1 in that it includes the wiring permitted layer 587 and the double via layer 588.

Description of the structure condition information name 585 and connection type 586 is omitted since they are the same as the structure condition information name 35 and connection type 36 shown in FIG. 3, respectively.

In Embodiment 9, the structure condition information name 585 specifies “SignalEM”.

The wiring permitted layer 587 specifies wiring layers that are permitted to be used by the cell specified by the reference name 580. In FIG. 58, the wiring permitted layer 587 specifies “M1,M2”, which indicates that buffer “BUF1” specified by the reference name 580 is permitted to connect a layer having the reference name “M1” with a layer having the reference name “M2”.

The double via layer 588 specifies vias to be converted into double via. In FIG. 58, the double via layer 588 specifies “V1”, indicating that the via having the reference name “V1” should be converted into double via.

9.2.2 Data Structure of Net List

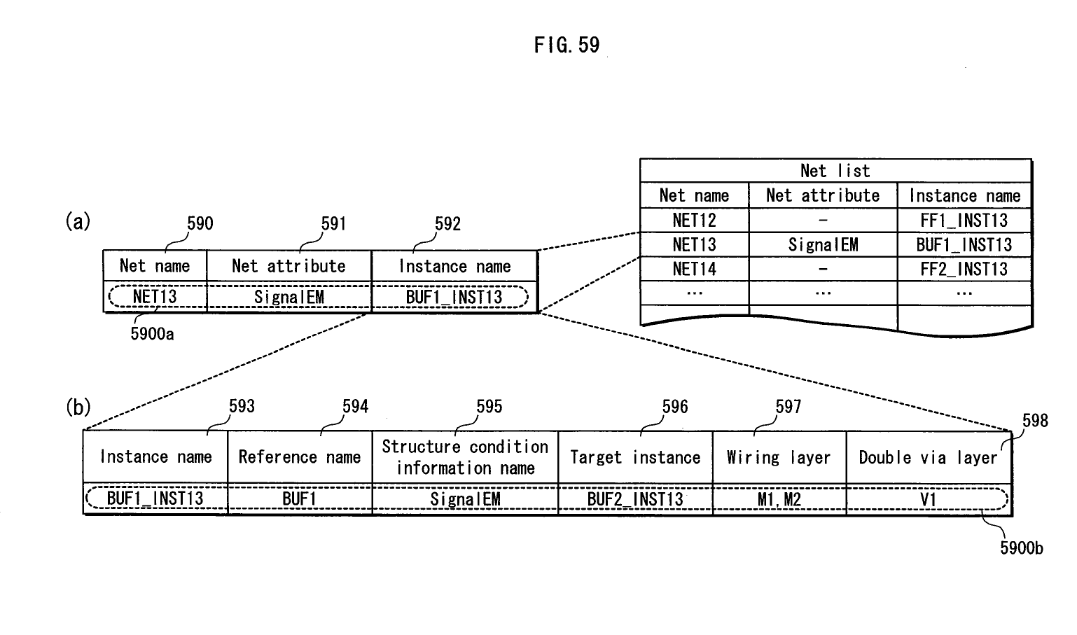

FIG. 59 shows the data structure of one net in the net list of Embodiment 9.

9.2.2.1 Data Structure of Net

The (a) of FIG. 59 shows the data structure of one net in the net list.

As shown in (a) of FIG. 59, one piece of record 5900a of the net includes a net name 590, a net attribute 591, and an instance name 592.

Description of the net name 590, net attribute 591, and instance name 592 is omitted since they are the same as the net name 40, net attribute 41, and instance name 42 shown in FIG. 4.

In Embodiment 9, the net attribute 591 specifies “SignalEM”, which indicates that net attribute “SignalEM” is attached to the net.

9.2.2.2 Data Structure of Instance

The (b) of FIG. 59 shows the data structure of an instance of the net.

As shown in (b) of FIG. 59, one piece of record 5900b of the instance includes an instance name 593, a reference name 594, a structure condition information name 595, a target instance 596, a wiring layer 597, and a double via layer 598. Especially, the structure differs from Embodiment 1 in that it includes the wiring layer 597 and the double via layer 598. Description of the instance name 593, reference name 594, structure condition information name 595, and target instance 596 is omitted since they are the same as the instance name 43, reference name 44, structure condition information name 45, and target instance 46 shown in (b) of FIG. 4.

The wiring layer 597 specifies layers to which the net specified by the net name 590 is wired. In FIG. 59, the wiring layer 597 specifies “M1,M2”. This indicates that “NET13” is wired to layers “M1” and “M2”.

The double via layer 598 specifies a via that is made double by the net specified by the net name 590. In FIG. 58, the double via layer 598 specifies “V1”, which indicates that “NET13” has converted via “V1” into double via.

9.3 Details of Net List Generation Process

Next, the step S205 in Embodiment 9 will be described in detail.

In Embodiment 9, the net having a predetermined property is a signal EM violation net. Also, in step S202 shown in FIG. 2, the analyzing unit 104 sets rules for the signal EM violation. The rules for the signal EM violation are, for example, the number of layers through which a wiring passes, or the wiring length. After the rules are set, a process is performed to detect nets that violate the rules, from the original net list 901. In step S203, the analyzing unit 104 selects the detected nets. Further, the attribute attaching unit 105 attaches net attribute “SignalEM” to the selected nets, in step S204.

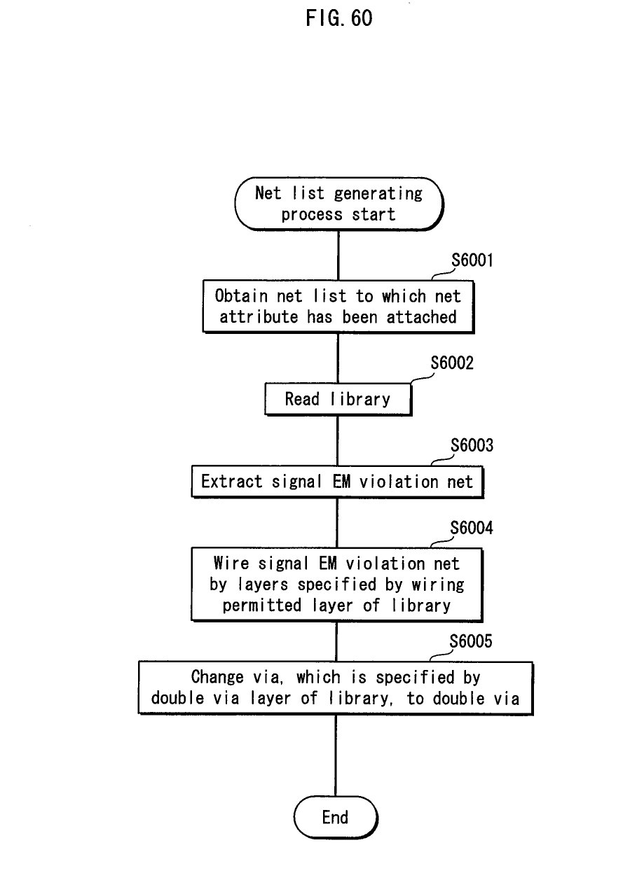

FIG. 60 is a flowchart showing the details of the process of step S205 in Embodiment 9.

As shown in FIG. 60, the net list generating unit 109 obtains the original net list 901 which was output from the attribute attaching unit 105 and to which the net attribute has been attached (step S6001).

The net list generating unit 109 then reads the library 907 from the storage unit 106 (step S6002).

The net list generating unit 109 extracts, from the original net list 901, a net in which net attribute “SignalEM” has been attached to the net attribute 591 (step S6003).

Next, based on the library 907, the net list generating unit 109 reads the reference name 580, the wiring permitted layer 587, and the double via layer 588 with respect to the cell for which “SignalEM” has been attached to the structure condition information name 584. In the example of Embodiment 9, the net list generating unit 109 reads buffer “BUF1”. Also, the net list generating unit 109 specifies “BUF1” as the starting cell of the net having net attribute “SignalEM”, and performs the wiring only in the layers specified by the wiring permitted layer 587. More specifically, the net list generating unit 109 performs the wiring only in layers “M1” and “M2” in the net having net attribute “SignalEM” (step S6004).

Also, the net list generating unit 109 converts the via specified by the read double via layer 588 into double via. More specifically, the net list generating unit 109 converts via “V1” into double via in the net having net attribute “SignalEM” (step S6005).

9.4 Transition of Net Structure

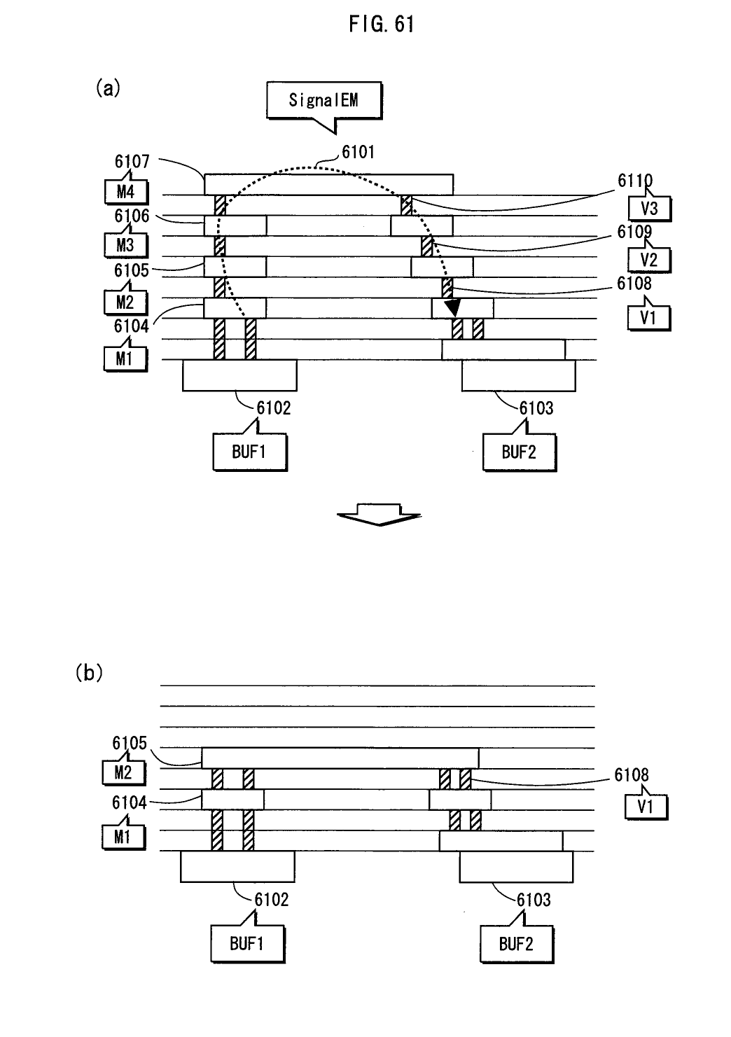

FIG. 61 shows a transition of the net structure.

The (a) of FIG. 61 shows the structure of part of nets in the original net list 901.

As shown in (a) of FIG. 61, the original net list 901 includes a signal EM violation net 6101, buffers 6102 and 6103, an M1 layer wiring 6104, an M2 layer wiring 6105, an M3 layer wiring 6106, an M4 layer wiring 6107, a V1 via 6108, a V2 via 6109, and a V3 via 6110 as the structure of part of nets in the original net list 901. The buffer 6102 has a reference name “BUF1”, and the buffer 6103 has a reference name “BUF2”. In the example shown in FIG. 61, via “V1” connects layers “M1” and “M2”, via “V2” connects layers “M2” and “M3”, and via “V3” connects layers “M3” and “M4”.

The logic circuit synthesis device 1 performs the processes of steps S202, S203 and S204 to attach the net attribute “SignalEM” to the signal EM violation net 6101 among the nets specified by the original net list 901. And the logic circuit synthesis device 1 generates the new net list 911 by performing step S205, which is detailed as steps S6001 through S6005.

The (b) of FIG. 61 shows the structure of part of nets in the new net list 911.

The (b) of FIG. 61 shows buffers 6102 and 6103, M1 layer wiring 6104, M2 layer wiring 6105, and V1 via 6108 as the structure of part of nets in the new net list 911. This net structure satisfies the condition specified by the wiring permitted layer 587 and the double via layer 588 in the library 907.

9.5 Update of Net List

Here will be described how the data held by the net list is updated, while the logic circuit synthesis device 1 of Embodiment 9 performs a process.

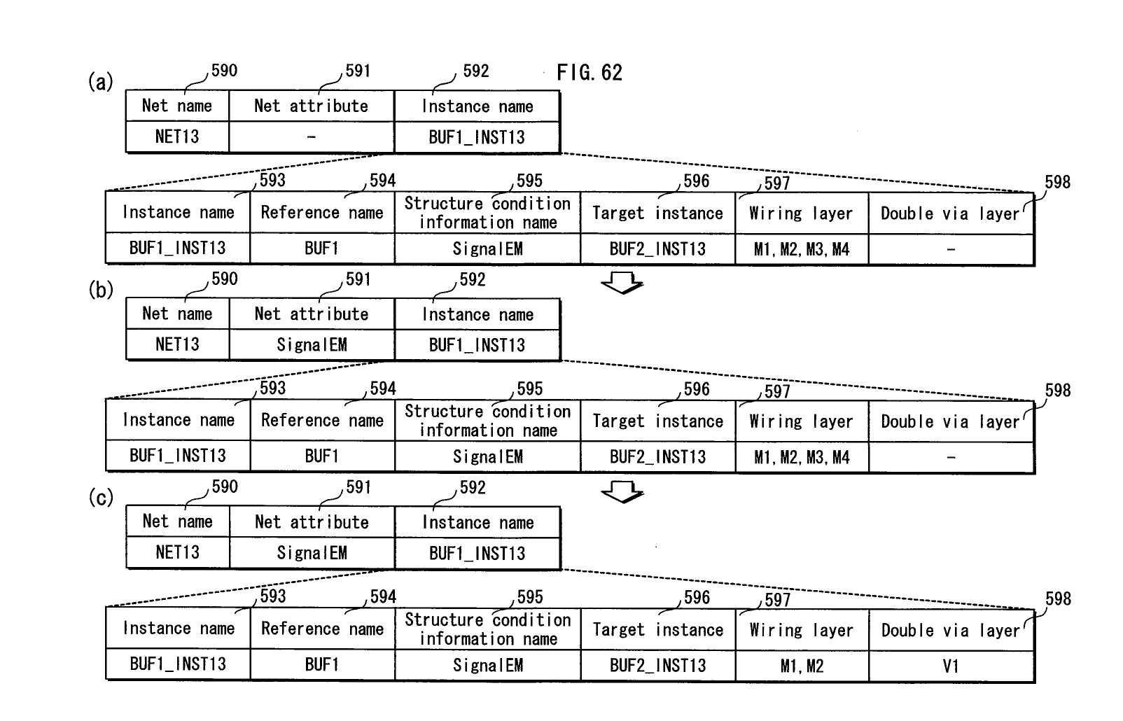

FIG. 62 shows the net list update process.

The (a) of FIG. 62 shows the original net list 901 in the state immediately after it is obtained by the obtaining unit 102 in step S201. In the original net list 901 in this state, the net attribute has not been attached yet. Also, as indicated by the wiring layer 597, the wiring from an instance specified by the instance name 593 to an instance specified by the target instance 596 passes through four layers “M1”, “M2”, “M3”, and

The (b) of FIG. 62 shows the original net list 901 in the state immediately after step S204 in which the attribute attaching unit 105 attaches the net attribute “SignalEM” to the net, and the original net list 901 in this state is to be input to the net list generating unit 109 in step S205. The net attribute “SignalEM” has been attached to the net attribute 591.

The (c) of FIG. 62 shows the new net list 911 generated by the net list generating unit 109. It shows the net structure after the signal EM violation has been solved, by converting via “V1” into double via and performing wiring in layers “M1” and “M2” by applying the structure condition information in the data structure of instance.

### Embodiment 10

10.1 Outline

In the following, another embodiment of the logic circuit synthesis device of the present invention will be described.

In Embodiment 10, the logic circuit synthesis device 1 selects, as a net having a predetermined property, a crosstalk occurrence net. The crosstalk is a phenomenon in which a line suffers an adverse effect from another line that is arranged in parallel with the line. The crosstalk can be solved by making the line shorter than the other parallel line in length.

Also, since Embodiment 10 is different from Embodiment 1 in the data structure of the library, the library is referred to as a library 1007 in Embodiment 10.

Further, since Embodiment 10 is different from Embodiment 1 in the data structure of the net list, the net lists of Embodiment 10 are referred to as an original net list 1001 and a new net list 1011.

With respect to the other functional blocks that are common with Embodiment 1, the reference signs used in Embodiment 1 are attached thereto and description thereof is omitted.

10.2 Data

In the following, the data structure of the library 1007 stored in the storage unit 106 and the data structure of the net list will be described.

10.2.1 Library 1007

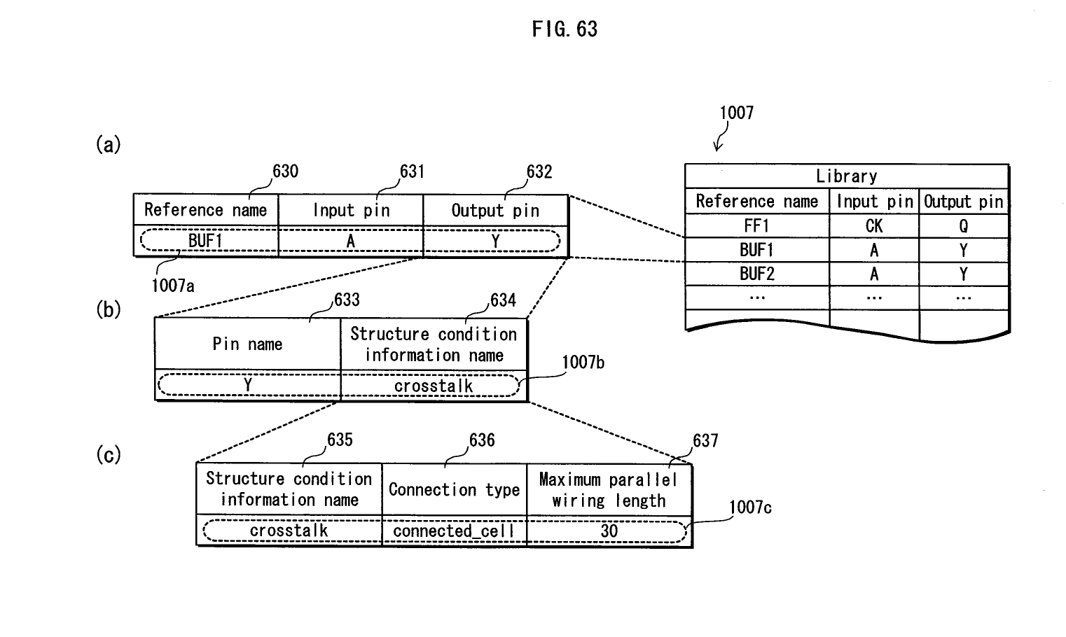

FIG. 63 shows the data structure of one cell contained in the library 1007.

10.2.1.1 Data Structure of Library

As shown in (a) of FIG. 63, one piece of record 1007a of the library 1007 includes a reference name 630, an input pin 631, and an output pin 632. Description of the reference name 630, input pin 631, and output pin 632 is omitted here since they indicate a reference name and the like in the same manner as the reference name 30, the input pin 31, and the output pin 32 in Embodiment 1.

10.2.1.2 Data Structure of Pin

In (b) of FIG. 63, the data structure of pin is shown.

One piece of record 1007b constituting the data of pin includes a pin name 633 and a structure condition information name 634.

Description of the pin name 633 and structure condition information name 634 is omitted here since they are the same as the pin name 33 and the structure condition information name 34 shown in FIG. 3.

In Embodiment 10, the structure condition information name 634 specifies “crosstalk”. The “crosstalk” is a reference name of a net attribute that specifies a crosstalk occurrence net.

10.2.1.3 Data Structure of Structure Condition Information

In (c) of FIG. 63, the data structure of the structure condition information is shown. One piece of record 1007c constituting data of the structure condition information includes a structure condition information name 635, a connection type 636, and a maximum parallel wiring length 637. Especially, the structure differs from Embodiment 1 in that it includes the maximum parallel wiring length 637.

Description of the structure condition information name 635 and connection type 636 is omitted since they are the same as the structure condition information name 35 and connection type 36 shown in FIG. 3, respectively. In Embodiment 10, the structure condition information name 635 specifies “crosstalk”.

The maximum parallel wiring length 637 specifies a restriction on the maximum parallel wiring length between (i) the net to which the cell specified by the reference name 630 is connected and (ii) the net that has an adverse effect of crosstalk to the net (i). In (c) of FIG. 63, the maximum parallel wiring length 637 specifies “30”. This indicates that the parallel wiring length between (i) the net to which “BUF1” specified by the reference name 630 is connected and (ii) the net that has an adverse effect of crosstalk to the net should be 30 or less.

The data type of the maximum parallel wiring length 637 is numeral.

10.2.2 Data Structure of Net List

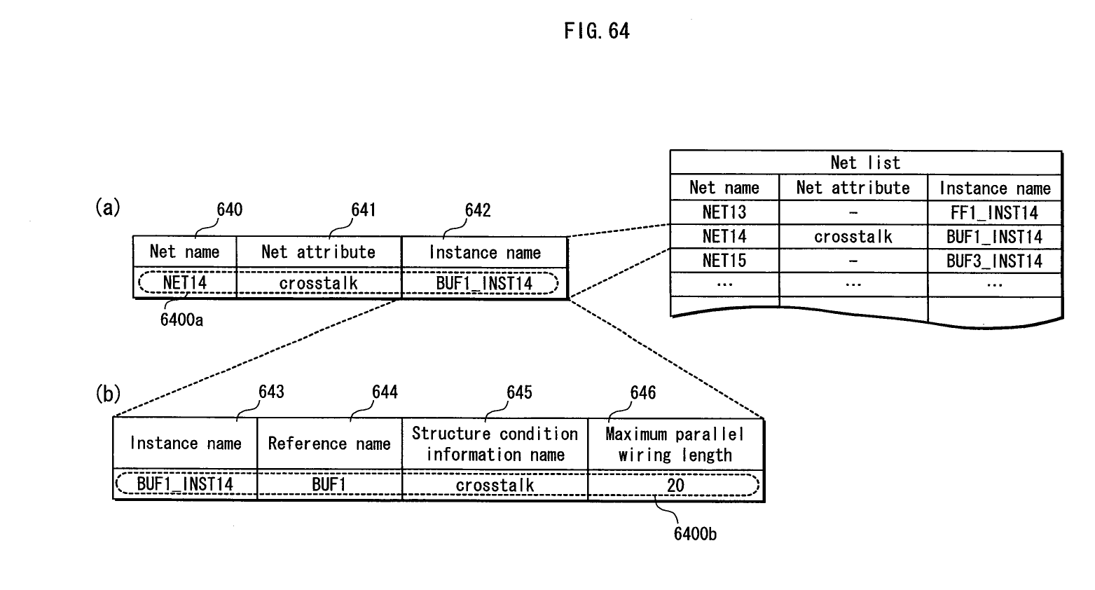

FIG. 64 shows the data structure of one net in the net list of Embodiment 10.

10.2.2.1 Data Structure of Net

The (a) of FIG. 64 shows the data structure of one net in the net list.

As shown in (a) of FIG. 64, one piece of record 6400a of the net includes a net name 640, a net attribute 641, and an instance name 642.

Description of the net name 640, net attribute 641, and instance name 642 is omitted since they are the same as the net name 40, net attribute 41, and instance name 42 shown in FIG. 4.

In Embodiment 10, the net attribute 641 specifies “crosstalk”, which indicates that net attribute “crosstalk” is attached to the net.

10.2.2.2 Data Structure of Instance

The (b) of FIG. 64 shows the data structure of an instance of the net.

As shown in (b) of FIG. 64, one piece of record 6400b of the instance includes an instance name 643, a reference name 644, a structure condition information name 645, and a maximum parallel wiring length 646. Especially, the structure differs from Embodiment 1 in that it includes the maximum parallel wiring length 646. Description of the instance name 643, reference name 644, and structure condition information name 645 is omitted since they are the same as the instance name 43, reference name 44, and structure condition information name 45 shown in (b) of FIG. 4.

The maximum parallel wiring length 646 specifies the maximum parallel wiring length between the net specified by the net name 640 and the other net that arranged in parallel therewith. In FIG. 64, the maximum parallel wiring length 646 specifies “20”. This indicates that the parallel wiring length with the other net is 20 at maximum.

10.3 Details of Net List Generation Process

Next, the step S205 in Embodiment 10 will be described in detail.

In Embodiment 10, the net having a predetermined property is a crosstalk occurrence net. Also, in step S202 shown in FIG. 2, the analyzing unit 104 receives an input of a crosstalk size for the crosstalk in the crosstalk occurrence net being the selection target, analyzes the net list, and extracts the net in which a crosstalk of a size of the received size or more has occurred. In step S203, the analyzing unit 104 selects the detected net. Further, the attribute attaching unit 105 attaches net attribute “crosstalk” to the selected net, in step S204.

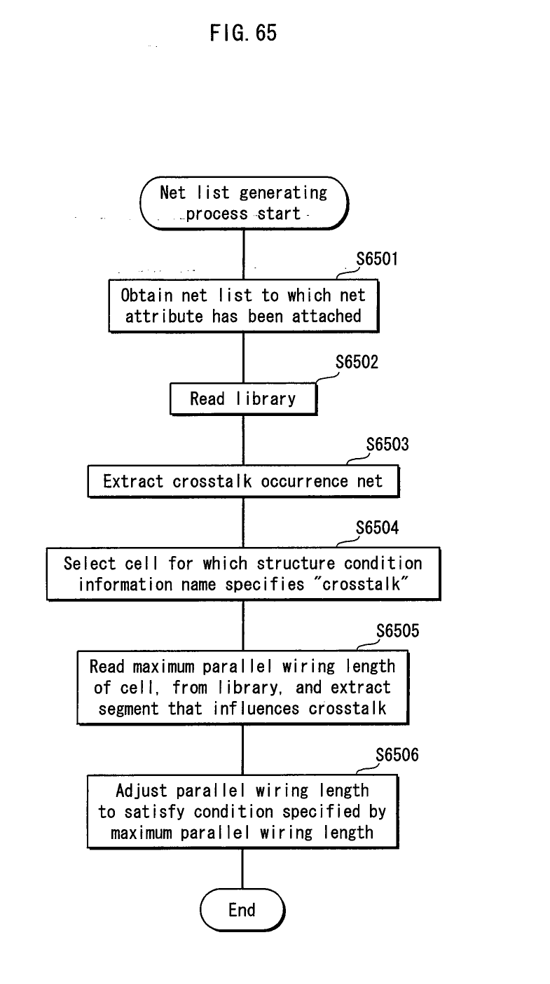

FIG. 65 is a flowchart showing the details of the process of step S205 in Embodiment 10.

As shown in FIG. 65, the net list generating unit 109 obtains the original net list 1001 which was output from the attribute attaching unit 105 and to which the net attribute has been attached (step S6501).

The net list generating unit 109 then reads the library 1007 from the storage unit 106 (step S6502).

The net list generating unit 109 extracts, from the original net list 1001, a net in which net attribute “crosstalk” has been attached to the net attribute 641 (step S6003).

Next, the net list generating unit 109 selects, from the library 1007, a cell for which “crosstalk” is specified by the structure condition information name 634 (step S6504).

Also, when it finds that the structure condition information name 634 specifies “crosstalk” in the library of a cell connected to the start of the net having net attribute “crosstalk”, the net list generating unit 109 reads the maximum parallel wiring length 637 of the cell. The net list generating unit 109 also extracts a segment of a net that has an adverse effect to the net having net attribute “crosstalk” (step S6505). Here, the segment is part of a net.

It then adjusts the parallel wiring length to satisfy the restriction specified by the maximum parallel wiring length 637 (step S6506). More specifically, it adjusts the maximum parallel wiring length between the extracted segment and the net having net attribute “crosstalk” to be 30, which is specified by the maximum parallel wiring length 637, or less.

10.4 Transition of Net Structure

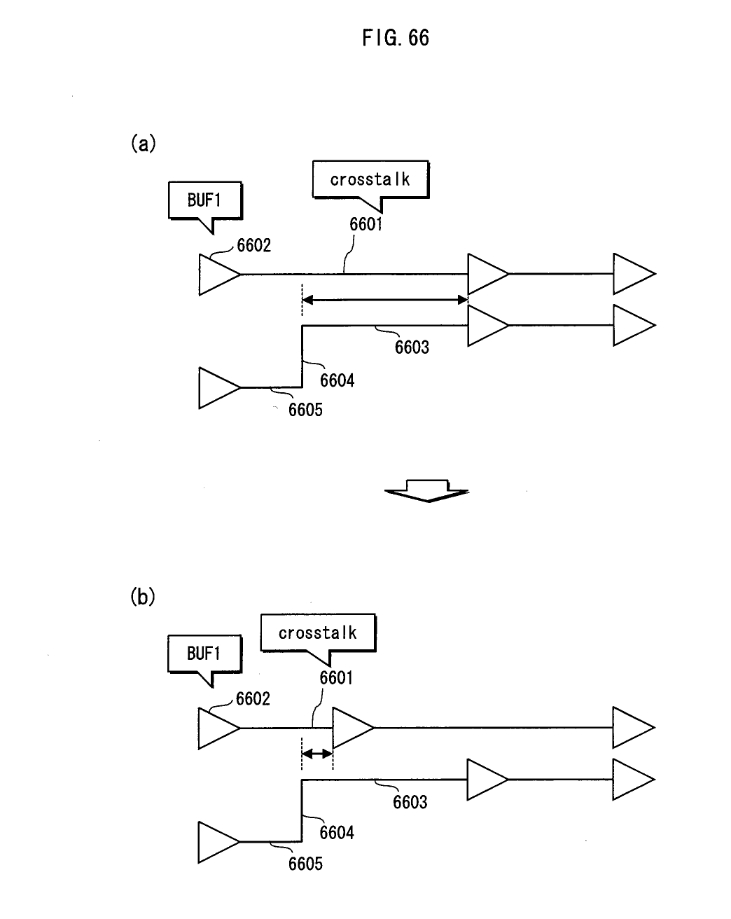

FIG. 66 shows a transition of the net structure.

The (a) of FIG. 66 shows the structure of part of nets in the original net list 1001.

As shown in (a) of FIG. 66, the original net list 1001 includes a crosstalk occurrence net 6601, a buffer 6602, and net segments 6603, 6604, and 6605 as the structure of part of nets in the original net list 1001. The buffer 6602 has a reference name “BUF1”, and stores the structure condition information corresponding to “crosstalk”. In this example, only segment 6603 has an adverse effect of crosstalk to the crosstalk occurrence net 6601, and segments 6604 and 6605 do not have the effect of crosstalk since they are distanced away from the net.

The logic circuit synthesis device 1 performs the processes of steps S202, S203 and S204 to attach the net attribute “crosstalk” to the crosstalk occurrence net 6601 among the nets specified by the original net list 1001. And the logic circuit synthesis device 1 generates the new net list 1011 by performing step S205, which is detailed as steps S6501 through S6506.

The (b) of FIG. 66 shows the structure of part of nets in the new net list 1011.

The (b) of FIG. 66 also shows the net and the like shown in (a) of FIG. 66, as the structure of part of nets in the new net list 1011. However, compared with (a) of FIG. 66, the parallel wiring length between the segment 6603, which has an adverse effect of crosstalk to the crosstalk occurrence net 6601, and the crosstalk occurrence net 6601 has become short.

10.5 Update of Net List

Here will be described how the data held by the net list is updated, while the logic circuit synthesis device 1 of Embodiment 10 performs a process.

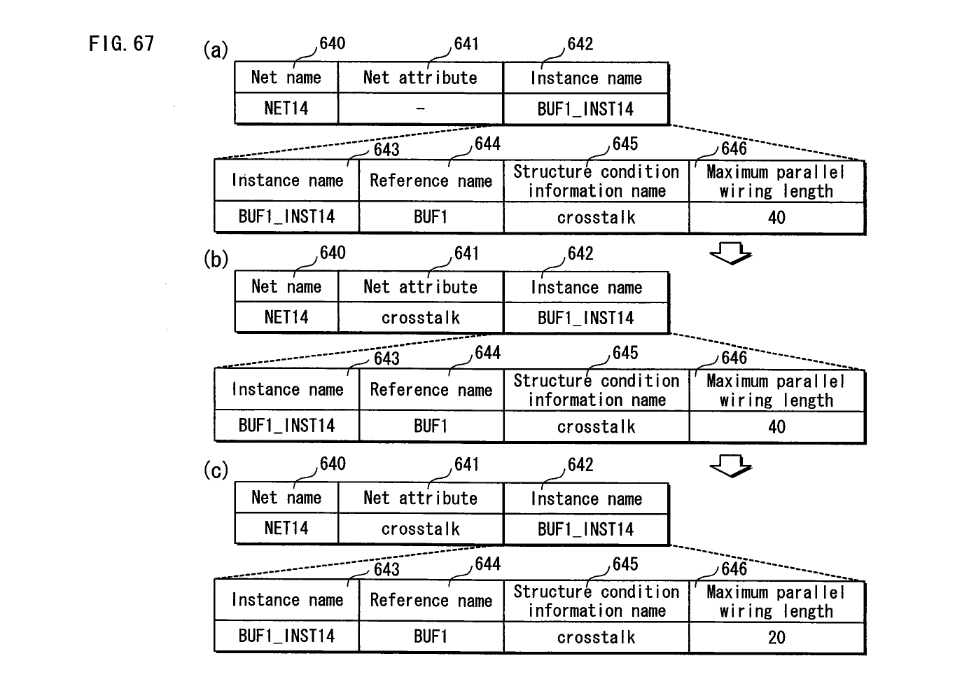

FIG. 67 shows the net list update process.

The (a) of FIG. 67 shows the original net list 1001 in the state immediately after it is obtained by the obtaining unit 102 in step S201. In the original net list 1001 in this state, the net attribute has not been attached yet. Also, the maximum parallel wiring length 646 specifies “40”. Namely, the condition specified by the maximum parallel wiring length 637 in the library for “BUF1” is not satisfied.

The (b) of FIG. 67 shows the original net list 1001 in the state immediately after step S204 in which the attribute attaching unit 105 attaches the net attribute “crosstalk” to the net, and the original net list 1001 in this state is to be input to the net list generating unit 109 in step S205. The net attribute “crosstalk” has been attached to the net attribute 641.

The (c) of FIG. 67 shows the new net list 1011 generated by the net list generating unit 109. The data structure of instance shows the net structure after the maximum parallel wiring length 646 has been set to “20” by applying the structure condition information.

<Supplementary Notes>

Up to now, the logic circuit synthesis device of the present invention has been described through embodiments thereof. However, the present invention is not limited to the embodiments, but may include, for example, the following modifications.

(1) As one example of such modifications, information corresponding to the structure condition information may be attached to a library of the Liberty format. In the Liberty format, a connection class attribute (connection_class) is used to restrict connection targets of cells. The structure condition information may be attached to the connection class attribute. Here, how to describe the library will be explained using the data of the embodiments. For example, in the case of FIG. 3 corresponding to Embodiment 1, the library for “BUF1” is represented as:

Cell(BUF1){

pin(A){

connection_class_constraint(hierarchy){

type : connected_cell ;
related_cell : ” BUF2 ” ;
max_distance : 30 ;

}

}

}

In the above description, “Cell ( )” represents the reference name 30, “connection_class_constraint( )” represents the structure condition information name 34, “type” represents the connection type 36 contained in the data structure of the structure condition information, “related_cell” represents the reference name 37, and “max_distance” represents the maximum distance 38.

Similarly, in the case of Embodiment 2, it is represented as:

Cell(FF1){

pin(Q){

connection_class_constraint(congestion){

type : all_cell ;
related_cell : ” FF2 ” ;
min_distance : 20 ;

}

}

}

Similarly, in the case of Modification 1 to Embodiment 2, with “direction” representing the direction 139, it is represented as:

Cell(FF1){

pin(Q){

connection_class_constraint(congestion){

type : all_cell ;
related_cell : ” FF2 ” ;
min_distance : 20 ;
direction : vertical

}
connection_class_constraint(congestion){

type : all_cell ;
related_cell : ” FF3 ” ;
min_distance : 40 ;
direction : horizon

}

}

}

Similarly, in the case of Embodiment 3, with “min_level” representing the minimum step number 188, it is represented as:

Cell(BUF1){

pin(Y){

connection_class_constraint(glitch){

type : connected_cell ;
related_cell : ” FF1 FF2 FF3 ” ;
min_level : 2 ;

}

}

}

Similarly, in the case of Embodiment 4, with “max_frequency” representing the maximum frequency 237, it is represented as:

Cell(BUF1){

pin(A){

connection_class_constraint(hige_frequency){

type : connected_cell ;
max_frequency : 300 ;

}

}

}
Cell(BUF2){

pin(A){

connection_class_constraint(hige_frequency){

type : connected_cell ;
max_frequency : 600 ;

}

}

}

Similarly, in the case of Embodiment 5, with “number” representing the connection instance number 287, it is represented as:

Cell(REG1){

pin(A){

connection_class_constraint(BUS){

type : connected_cell ;
number : 1 ;

}

}

}

Similarly, in the case of Embodiment 6, it is represented as:

Cell(FF1){

pin(Q){

connection_class_constraint(toggle){

type : all_cell ;
related_cell : ” FF2 FF3” ;
min_distance : 20 ;

}

}

}

Similarly, in the case of Modification 1 to Embodiment 6, with “min_row” representing the minimum row distance 388, it is represented as:

Cell(FF1){

pin(Q){

connection_class_constraint(toggle){

type : all_cell ;
related_cell : ” FF2 FF3” ;
min_row : 1 ;

}

}

}

Similarly, in the case of Modification 2 to Embodiment 6, with “min_strap” representing the minimum strap distance 438, it is represented as:

Cell(FF1){

pin(Q){

connection_class_constraint(toggle){

type : all_cell ;
related_cell : ” FF2 FF3” ;
min_strap : 1 ;

}

}

}

Similarly, in the case of Embodiment 7, with “min_delay” representing the minimum delay 488, it is represented as:

Cell(FF1){

pin(Q){

connection_class_constraint(shift){

type : connected_cell ;
related_cell : ” FF2” ;
min_delay : 1 ;

}

}

}

Similarly, in the case of Embodiment 8, with “position” representing the connection position 537, it is represented as:

Cell(FF1){

pin(D){

connection_class_constraint(observation){

type : connected_cell ;
position : end ;

}

}

}

Similarly, in the case of Embodiment 9, with “layer” representing the wiring permitted layer 587, “double_via” representing the double via layer 588, it is represented as:

Cell(BUF1){

pin(Y){

connection_class_constraint(SignalEM){

type : connected_cell ;
layer : M1 , M2 ;
double_via : V1 ;

}

}

}

Similarly, in the case of Embodiment 10, with “max_parallel_length” representing the maximum parallel wiring length 637, it is represented as:

Cell(BUF1){

pin(Y){

connection_class_constraint(crosstalk){

type : connected_cell ;
max_parallel_length : 30 ;

}

}

}

Further, various library formats other than the Liberty format may be used to attach the structure condition information in the above-described logic synthesis.

(2) The above-described logic circuit synthesis device is specifically a computer system that includes a microprocessor, ROM, RAM, hard disk unit, display unit, keyboard, mouse and the like. A computer program is stored in the RAM or the hard disk unit. The microprocessor operates in accordance with the computer program and causes the logic circuit synthesis device to achieve its functions. Here, the computer program is composed of a plurality of instruction codes for instructing to the computer to achieve predetermined functions.

(3) Part or all of the elements constituting the logic circuit synthesis device may be achieved as a system LSI (Large Scale Integration). The system LSI is an ultra-multi-function LSI that is manufactured as one chip on which a plurality of constituent elements are integrated. The system LSI is specifically a computer system that includes a microprocessor, ROM, RAM and the like. A computer program is stored in the RAM. The microprocessor operates in accordance with the computer program and causes the system LSI to achieve its functions.

(4) Part or all of the elements constituting the logic circuit synthesis device may be achieved as an IC card that is attachable to and detachable from the logic circuit synthesis device, or may be achieved as a single module. The IC card or the module is a computer system that includes a microprocessor, ROM, RAM and the like. The IC card or the module may include the above-described ultra-multi-function LSI. The microprocessor operates in accordance with the computer program and causes the IC card or the module to achieve its functions. The IC card or the module may be tamper-resistant.

(5) The present invention may be methods shown by the above. The present invention may be a computer program that allows a computer to realize the methods, or may be a digital signal that represents the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the digital signal recorded on any of the aforementioned recording mediums.

Also, the present invention may be the computer program or the digital signal transmitted on an electric communication line, a wireless or wired communication line, a network typified by the Internet, a data broadcast or the like.

Furthermore, the present invention may be a computer system that includes a microprocessor and a memory, the memory storing the computer program, and the microprocessor operating according to the computer program.

Furthermore, by transferring the program or the digital signal via the recording medium, or by transferring the program or the digital signal via the network or the like, the program or the digital signal may be executed by another independent computer system.

(6) The present invention may be any combination of the above-described embodiments and modifications.

(7) The logic circuit synthesis device of the present invention automatically synthesizes a logic circuit to satisfy a predetermined restriction depending on the property of the nets to which cells are connected. As such, the present invention is useful in reducing the time period and steps for developing the logic circuit.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A logic circuit synthesis device comprising:
a storage unit storing structure condition information in correspondence with a predetermined property of a net, the structure condition information specifying a condition which should be satisfied by a net structure of the net having the property;
an obtaining unit operable to obtain original net structure information that indicates structures of a plurality of nets;
a selecting unit operable to select a net having the predetermined property, among the plurality of nets whose structures are indicated by the obtained original net structure information; and
a generating unit operable to generate, for the selected net, new net structure information that satisfies the condition specified by the structure condition information stored in the storage unit.

2. The logic circuit synthesis device of claim 1, wherein
the structure condition information stored in the storage unit indicates a condition concerning a wiring length of the net having the property, and
the new net structure information generated by the generating unit satisfies the condition concerning the wiring length.

3. The logic circuit synthesis device of claim 2, wherein
the net having the property is a boundary net that extends over a boundary between blocks,
the structure condition information stored in the storage unit indicates a restriction on a maximum wiring length of the boundary net,
the net selected by the selecting unit is the boundary net, and
the new net structure information generated by the generating unit satisfies the restriction on the maximum wiring length of the selected boundary net.

4. The logic circuit synthesis device of claim 2, wherein
the net having the property is a congested net whose wiring density is higher than a predetermined value,
the structure condition information stored in the storage unit indicates a restriction on a maximum wiring length of the congested net,
the net selected by the selecting unit is the congested net, and
the new net structure information generated by the generating unit satisfies the restriction on the maximum wiring length of the selected congested net.

5. The logic circuit synthesis device of claim 2, wherein
the net having the property is a high toggle net being a net having at least a predetermined toggle rate,
the structure condition information stored in the storage unit indicates a restriction on a minimum wiring length of the high toggle net,
the net selected by the selecting unit is the high toggle net, and
the new net structure information generated by the generating unit satisfies the restriction on the minimum wiring length of the selected high toggle net.

6. The logic circuit synthesis device of claim 1, wherein
the structure condition information stored in the storage unit indicates a condition concerning a wiring direction of the net having the property in a circuit, and
the new net structure information generated by the generating unit satisfies the condition concerning the wiring direction.

7. The logic circuit synthesis device of claim 6, wherein
the net having the property is a congested net whose wiring density is higher than a predetermined value,
the structure condition information stored in the storage unit indicates a restriction on a wiring direction of the congested net,
the net selected by the selecting unit is the congested net, and
the new net structure information generated by the generating unit satisfies the restriction on the wiring direction of the selected congested net.

8. The logic circuit synthesis device of claim 1, wherein
the structure condition information stored in the storage unit indicates a step number restriction being a restriction on a predetermined number of cells that should be arranged between cells constituting the net having the property, and
the new net structure information generated by the generating unit satisfies the step number restriction.

9. The logic circuit synthesis device of claim 8, wherein
the net having the property is a glitch occurrence net in which a glitch with at least a predetermined height has occurred,
the structure condition information stored in the storage unit indicates a step number restriction being a restriction on a predetermined number of cells that should be arranged between cells constituting the glitch occurrence net,
the net selected by the selecting unit is the glitch occurrence net, and
the new net structure information generated by the generating unit satisfies the step number restriction being the restriction on the predetermined number of cells that should be arranged between cells constituting the selected glitch occurrence net.

10. The logic circuit synthesis device of claim 1, wherein
the net having the property is an FF direct connection net in which flip flops are directly connected,
the structure condition information stored in the storage unit indicates a restriction on a delay time between flip flops in the FF direct connection net,
the net selected by the selecting unit is the FF direct connection net, and
the new net structure information generated by the generating unit satisfies the restriction on the delay time between flip flops in the selected FF direct connection net, wherein the generating unit controls a number of buffers to be inserted between the flip flops so that the new net structure information satisfies the restriction on the delay time between the flip flops.

11. The logic circuit synthesis device of claim 1, wherein
the net having the property is a high frequency net through which a high frequency signal passes,
the structure condition information stored in the storage unit is maximum frequency information that indicates a restriction on a maximum frequency of a net to which a predetermined cell can be connected,
the net selected by the selecting unit is the high frequency net, and
the new net structure information generated by the generating unit satisfies the restriction on the maximum frequency of the selected high frequency net to which the predetermined cell can be connected, wherein the generating unit controls the predetermined cell connected to the high frequency net so that the new net structure information satisfies the restriction on the maximum frequency of the selected high frequency net.

12. The logic circuit synthesis device of claim 1, wherein
the structure condition information stored in the storage unit indicates a restriction on a number of connections by a predetermined cell to the net having the property, and
the new net structure information generated by the generating unit satisfies the restriction on the number of connections by the predetermined cell to the net having the property.

13. The logic circuit synthesis device of claim 12, wherein
the net having the property is a bus signal net through which a bus signal passes,
the structure condition information stored in the storage unit indicates a restriction on a number of connections by a terminating resistor to the bus signal net,
the net selected by the selecting unit is the bus signal net, and
the new net structure information generated by the generating unit satisfies the restriction on the number of connections by the terminating resistor to the selected bus signal net.

14. The logic circuit synthesis device of claim 1, wherein
the structure condition information stored in the storage unit indicates a restriction on a position at which a predetermined cell connects to the net having the property, and
the new net structure information generated by the generating unit satisfies the restriction on the position at which the predetermined cell connects to the net having the property.

15. The logic circuit synthesis device of claim 14, wherein
the net having the property is an observation target net which is specified as a target of net observation,
the structure condition information stored in the storage unit indicates a restriction on a position at which a flip flop connects to the observation target net,
the net selected by the selecting unit is the observation target net, and
the new net structure information generated by the generating unit satisfies the restriction on the position at which the flip flop connects to the selected observation target net.

16. The logic circuit synthesis device of claim 1, wherein
the net having the property is a high toggle net being a net having a predetermined toggle rate,
the structure condition information stored in the storage unit indicates a restriction on an arrangement of a first cell and a second cell, the first cell being connected to the high toggle net, the second cell being different from the first cell,
the net selected by the selecting unit is the high toggle net, and
the new net structure information generated by the generating unit satisfies the restriction on the arrangement of the first cell and the second cell with respect to the selected high toggle net.

17. The logic circuit synthesis device of claim 16, wherein
the structure condition information stored in the storage unit indicates a restriction that the first cell and the second cell should be arranged with a predetermined number of rows there between, and
the new net structure information generated by the generating unit satisfies the restriction that the first cell and the second cell should be arranged with a predetermined number of rows there between.

18. The logic circuit synthesis device of claim 16, wherein
the structure condition information stored in the storage unit indicates a restriction that the first cell and the second cell should be arranged with a predetermined number of strap lines there between, and
the new net structure information generated by the generating unit satisfies the restriction that the first cell and the second cell should be arranged with the predetermined number of strap lines there between.

19. The logic circuit synthesis device of claim 1, wherein
the net having the property is a crosstalk occurrence net in which a crosstalk with a predetermined height has occurred,
the structure condition information stored in the storage unit indicates a restriction on a parallel wiring length being a length of a wiring of the crosstalk occurrence net that is arranged in parallel with another wiring,
the net selected by the selecting unit is the crosstalk occurrence net, and
the new net structure information generated by the generating unit satisfies the restriction on the parallel wiring length being the length of the wiring of the selected crosstalk occurrence net that is arranged in parallel with another wiring.

20. A logic circuit synthesis method for causing a logic circuit synthesis device to perform a logic synthesis, the logic circuit synthesis device including a storage unit storing structure condition information in correspondence with a predetermined property of a net, the structure condition information specifying a condition which should be satisfied by a net structure of the net having the property, the logic circuit synthesis method comprising the steps of:
obtaining original net structure information that indicates structures of a plurality of nets;
selecting a net having the predetermined property, among the plurality of nets whose structures are indicated by the obtained original net structure information; and
generating, for the selected net, new net structure information that satisfies the condition specified by the structure condition information stored in the storage unit.

21. A control program for controlling a process for causing a logic circuit synthesis device to perform a logic synthesis, the logic circuit synthesis device including a storage unit storing structure condition information in correspondence with a predetermined property of a net, the structure condition information specifying a condition which should be satisfied by a net structure of the net having the property, the control program comprising the steps of:
obtaining original net structure information that indicates structures of a plurality of nets;
selecting a net having the predetermined property, among the plurality of nets whose structures are indicated by the obtained original net structure information; and
generating, for the selected net, new net structure information that satisfies the condition specified by the structure condition information stored in the storage unit.
